(19) United States
(12) Patent Application Publication
(10) Pub. No.: US 2024/0171267 A1
(43) Pub. Date: May 23, 2024

(54) SYSTEMS AND METHODS FOR SUPPORTING LOCATION BASED MOBILITY FOR 5G SATELLITE ACCESS TO A WIRELESS NETWORK

(71) Applicant: QUALCOMM Incorporated, San Diego, CA (US)

(72) Inventors: Stephen William EDGE, Escondido, CA (US); Luis Fernando Brisson LOPES, Swindon (GB); Amer CATOVIC, San Diego, CA (US); Haris ZISIMOPOULOS, London (GB)

(21) Appl. No.: 18/551,456

(22) PCT Filed: Feb. 23, 2022
(86) PCT No.: PCT/US2022/017572

§ 371 Date: Sep. 20, 2023

(30) Foreign Application Priority Data
May 6, 2021 (GR) 20210100309

(51) Int. Cl. H04B 7/185; H04W 64/00; H04W 84/04

(52) U.S. Cl. CPC H04B 7/18545; H04W 64/00; H04W 84/047

(57) ABSTRACT

A Registration Area (RA) supporting UE satellite access to a serving PLMN may correspond to a geodetic area (e.g. a circle) and may be determined by a network node (e.g. AMF) based on a current geodetic location of the UE. The UE may access a radio cell supported by a satellite for a serving PLMN. The UE may determine whether the radio cell provides coverage for the RA, e.g., based on whether an updated geodetic location of the UE is inside the RA or based on whether a geodetic coverage area of the radio cell covers at least part of the RA. The UE may perform a Registration with the serving PLMN via the radio cell when the radio cell is determined to not provide coverage for the RA. The serving PLMN may page the UE, when idle, using radio cells whose coverage includes at least part of the RA.

### CROSS-REFERENCE TO RELATED APPLICATIONS

This application claims priority to and the benefit of Greek Patent Application No. 20210100309, entitled “SYSTEMS AND METHODS FOR SUPPORTING LOCATION BASED MOBILITY FOR 5G SATELLITE ACCESS TO A WIRELESS NETWORK,” filed May 6, 2021, which is assigned to the assignee hereof and which is expressly incorporated herein by reference in its entirety.

### BACKGROUND

### Field of the Disclosure

Various aspects described herein generally relate to wireless communication systems, and more particularly, to accessing a wireless network using communication satellites.

### Description of Related Technology

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

Standardization is ongoing to combine satellite-based communication systems with terrestrial wireless communications systems, such as 5G New Radio (NR) networks. In such a system, a user equipment (UE) would access a satellite, also referred to as a space vehicle (SV), which would connect to an earth station, also referred to as a ground station or non-terrestrial (NTN) gateway, which in turn would connect to a 5G network (e.g. directly or via a base station). A 5G network could treat the satellite system as another type of Radio Access Technology (RAT) distinct from, but also similar to, terrestrial 5G NR.

Since satellites typically differ from terrestrial base stations in terms of the size of their coverage areas, movement of coverage areas, longer propagation delays and different carrier frequencies, a 5G satellite RAT may need different implementation and support than a 5G terrestrial RAT for providing common services to end users. This can apply to supporting mobility of UEs, wherein UEs are allowed to change location but continue to access a serving network with minimal additional signaling to support the changed location. Techniques to support UE mobility used by terrestrial 5G networks may not be suitable or optimum for support of UE mobility with satellite 5G networks. Accordingly, new solutions to support UE mobility for satellite 5G networks may be needed.

### SUMMARY

User equipment (UE) access to a non-terrestrial network (NTN) via a satellite to a Fifth Generation (5G) public land mobile network (PLMN) is supported using a registration area (RA), that is determined by a network node, such as an Access and Mobility management Function (AMF) based on the current geodetic location of the UE. The RA supporting UE satellite access to the serving PLMN may correspond to a geodetic area (e.g. a circle). The UE may access a radio cell that is supported by a satellite for a serving PLMN. The UE may determine whether the radio cell provides coverage for the RA, e.g., based on whether an updated geodetic location of the UE is inside the RA or based on whether a geodetic coverage area of the radio cell covers at least part of the RA. The UE may perform a Registration with the serving PLMN via the radio cell when the radio cell is determined to not provide coverage for the RA. The serving PLMN may page the UE, when idle, using radio cells whose coverage includes at least part of the RA.

In one implementation, a method performed by a user equipment (UE) for supporting satellite wireless access by the UE to a serving public land mobile network (PLMN), includes receiving from a network node an indication of a registration area (RA), wherein the RA comprises a geodetic area that is determined by the network node based on a current geodetic location of the UE; accessing a radio cell for the serving PLMN, wherein the radio cell is supported by a satellite; determining whether the radio cell provides coverage for the RA; and performing a Registration with the serving PLMN via the radio cell in response to determining that the radio cell does not provide coverage for the RA.

In one implementation, a user equipment (UE) configured for supporting satellite wireless access by the UE to a serving public land mobile network (PLMN), the UE includes a wireless transceiver configured to wirelessly communicate with a communication satellite; at least one memory; at least one processor coupled to the wireless transceiver and the at least one memory, wherein the at least one processor is configured to: receive from a network node an indication of a registration area (RA), wherein the RA comprises a geodetic area that is determined by the network node based on a current geodetic location of the UE; access a radio cell for the serving PLMN, wherein the radio cell is supported by a satellite; determine whether the radio cell provides coverage for the RA; and perform a Registration with the serving PLMN via the radio cell in response to determining that the radio cell does not provide coverage for the RA.

In one implementation, a user equipment (UE) configured for supporting satellite wireless access by the UE to a serving public land mobile network (PLMN), the UE comprising: means for receiving from a network node an indication of a registration area (RA), wherein the RA comprises a geodetic area that is determined by the network node based on a current geodetic location of the UE; means for accessing a radio cell for the serving PLMN, wherein the radio cell is supported by a satellite; means for determining whether the radio cell provides coverage for the RA; and means for performing a Registration with the serving PLMN via the radio cell in response to determining that the radio cell does not provide coverage for the RA.

In one implementation, a non-transitory storage medium including program code stored thereon, the program code is operable to configure at least one processor in a user equipment (UE) for supporting satellite wireless access by the UE to a serving public land mobile network (PLMN), the program code comprising instruction: receive from a network node an indication of a registration area (RA), wherein the RA comprises a geodetic area that is determined by the network node based on a current geodetic location of the UE; access a radio cell for the serving PLMN, wherein the radio cell is supported by a satellite; determine whether the radio cell provides coverage for the RA; and perform a Registration with the serving PLMN via the radio cell in response to determining that the radio cell does not provide coverage for the RA.

In one implementation, a method performed by a network node in a public land mobile network (PLMN) for supporting satellite wireless access by a user equipment (UE) to a serving PLMN, includes obtaining a current geodetic location of the UE; determining a registration area (RA), wherein the RA comprises a geodetic area that is determined based on the current geodetic location of the UE; sending to the UE an indication of the RA.

In one implementation, a network node in a public land mobile network (PLMN) configured for supporting satellite wireless access by a user equipment (UE) to a serving PLMN, the network node comprising: an external interface configured to communicate with entities in a wireless network including the PLMN and one or more UEs; at least one memory; at least one processor coupled to the external interface and the at least one memory, wherein the at least one processor is configured to: obtain a current geodetic location of the UE; determine a registration area (RA), wherein the RA comprises a geodetic area that is determined based on the current geodetic location of the UE; send to the UE an indication of the RA.

In one implementation, a network node in a public land mobile network (PLMN) configured for supporting satellite wireless access by a user equipment (UE) to a serving PLMN, the network node comprising: means for obtaining a current geodetic location of the UE; means for determining a registration area (RA), wherein the RA comprises a geodetic area that is determined based on the current geodetic location of the UE; means for sending to the UE an indication of the RA.

In one implementation, a non-transitory storage medium including program code stored thereon, the program code is operable to configure at least one processor in a network node in a public land mobile network (PLMN) for supporting satellite wireless access by a user equipment (UE) to a serving PLMN, the program code comprising instruction to: obtain a current geodetic location of the UE; determine a registration area (RA), wherein the RA comprises a geodetic area that is determined based on the current geodetic location of the UE; send to the UE an indication of the RA.

### BRIEF DESCRIPTION OF THE DRAWINGS

FIG. 1 shows a diagram of a communication system with a network architecture having transparent space vehicles (SVs) that is capable of supporting satellite access to a wireless network.

FIG. 2 shows a diagram of a communication system with a network architecture having regenerative SVs that is capable of supporting satellite access to a wireless network.

FIG. 3 shows a diagram of a communication system with a network architecture having regenerative SVs and a split NR NodeB (gNB) architecture that is capable of supporting satellite access to a wireless network.

FIG. 4 illustrates an SV generating multiple beams over an area that includes multiple countries.

FIG. 5 illustrates radio cells produced by an SV over an area that includes a number of fixed cells.

FIG. 6 illustrates an assignment of radio cells produced by an SV to fixed tracking areas (TAs).

FIG. 7A shows an example of a registration area that is defined by a network node based on a current geodetic location of a user equipment (UE).

FIG. 7B shows another example of registration area that is defined by a network node based on a current geodetic location of a UE.

FIG. 7C shows another example of registration area that is defined by a network node based on a current geodetic location of a UE.

FIG. 8 shows a signaling flow that illustrates various messages sent between components of a communication system in a procedure for PLMN access by a UE using a registration area that is based on a geodetic location of the UE.

FIG. 9 shows a signaling flow that illustrates various messages sent between components of a communication system in a procedure for paging a UE using a registration area that is based on a geodetic location of the UE.

FIG. 10 is a diagram illustrating an example of a hardware implementation of a UE configured to support UE satellite access using a registration area.

FIG. 11 is a diagram illustrating an example of a hardware implementation of a network node configured to support UE satellite access using a registration area.

FIG. 12 is a flowchart of an example procedure performed by a UE for supporting wireless access by the UE to a serving public land mobile network (PLMN).

FIG. 13 is a flowchart of an example procedure performed by a network node for supporting wireless access by the UE to a serving public land mobile network (PLMN).

Like reference symbols in the various drawings indicate like elements, in accordance with certain example implementations. In addition, multiple instances of an element may be indicated by following a first number for the element with a letter or a hyphen and a second number. For example, multiple instances of an element 102 may be indicated as 102-1, 102-2, 102-3 etc. When referring to such an element using only the first number, any instance of the element is to be understood (e.g. element 102 in the previous example would refer to elements 102-1, 102-2, 102-3).

### DETAILED DESCRIPTION

Satellites, also referred to as space vehicles (SVs) or communication satellites, may be used in communication systems, for example, using gateways and one or more satellites to relay communication signals between the gateways and one or more UEs. A UE, for example, may access a satellite which may be connected to an earth station (ES), which is also referred to as a ground station or Non-Terrestrial Network (NTN) Gateway. The earth station in turn would connect to an element in a 5G Network such as a modified base station (without a terrestrial antenna) or a network node in a 5G Core Network (5GCN). This element would in turn provide access to other elements in the 5G Network and ultimately to entities external to the 5G Network such as Internet web servers and other user devices.

A rationale for 5G (or other wireless technology such as 4G or future 6G) satellite access for UEs may include ubiquitous outdoor coverage for both users and Mobile Network Operators (MNOs). For example, in many countries, including the United States, unavailable or poor cellular coverage is a common problem in some areas. Moreover, cellular access is not always possible even when there is normally good cellular coverage. For example, cellular access may be hampered due to congestion, physical obstacles, a local cellular outage caused by weather (e.g. a hurricane or tornado), or a local power outage. Satellite access to cellular networks could provide a new independent access potentially available everywhere outdoors. Current satellite capable phones for low Earth orbit (LEO) SVs may be of similar size to a cellular smartphone and, thus, mobile NR support with satellite capable phones need not produce a significant increase in the size of phones. Moreover, satellite capable smartphones may help drive handset sales, and may add revenue for carriers. Potential users, for example, may include anyone with limited or no cellular access, anyone wanting a backup to a lack of cellular access, and anyone involved in public safety or who otherwise needs (nearly) 100% reliable mobile communication. Additionally, some users may desire an improved or more reliable E911 service, e.g., for a medical emergency or vehicle trouble in remote areas.

The use of 5G satellite access may provide other benefits. For example, 5G satellite access may reduce Mobile Network Operator (MNO) infrastructure cost. For example, an MNO may use satellite access to reduce terrestrial base stations, such as NR NodeBs, also referred to as gNBs, and backhaul deployment in sparsely populated areas. Further, 5G satellite access may be used to overcome Internet blockage, e.g., in certain countries. Additionally, 5G satellite access may provide diversification to Space Vehicle Operators (SVOs). For example, 5G NR satellite access could provide another revenue stream to SVOs who would otherwise provide fixed Internet access.

Terrestrial networks (TNs) using terrestrial cellular base stations can support relatively small fixed radio cells (e.g. 100 meters to 10 kms from one side to another) which can have accurately known geographic coverage areas. This allows an operator of a TN to subdivide their overall service area into fixed tracking areas (TAs) which are each composed of a number of fixed radio cells. Tracking areas allow an operator to control access by users (e.g. define certain geographic areas which can only be accessed by a subset of users) and to charge users based on their general location. Radio cells allow an operator a fine level of access control and fine level of charging discrimination and can be used for routing purposes and to support wireless emergency alerting (WEA). For example, a request to set up an emergency call sent by a UE to a TN can include the current serving radio cell of the UE which can be used by the TN to route the emergency call to a Public Safety Answering Point (PSAP), which serves the area of the serving radio cell. In addition, when a WEA message needs to be broadcast in a predefined target area to all UEs currently located in the target area, the TN may direct the WEA message to be broadcast only within radio cells whose coverage areas are within or partly within the target area.

5G satellite access for UEs is being defined by the Third Generation Partnership Project (3GPP). A main objective in defining the 5G satellite access is to minimize or avoid new impacts to a 5G Core Network (5GCN). One way to avoid or minimize impact to a 5GCN is to retain support for fixed tracking areas (TAs) and fixed (virtual) cells. The fixed TAs and fixed cells would be defined geographically by Operations and Maintenance (O&M) with the geographic definitions being provided to gNBs and the 5GCN. The gNBs may then determine the fixed TA and fixed cell in which a UE is geographically located and provide the identifiers (IDs) of these to a network node in the 5GCN, e.g., an Access and Mobility Management Function (AMF), when a signaling connection is established for the UE. The AMF may later use the fixed TA and the fixed cell information to send a paging message to the UE via one or more gNBs. Use of fixed TAs and fixed cells can have a benefit of minimizing new 5GCN impacts, but can also have disadvantages such as requiring additional O&M to define and manage the fixed TAs and fixed cells, requiring a mapping (e.g. performed by a gNB) from a UE geographic location to a fixed TA and fixed cell, and reducing accuracy and efficiency in the paging of a UE. It may be desirable to avoid such disadvantages, even if it requires some additional 5GCN impact.

Accordingly, in one implementation, fixed TAs and fixed cells are replaced with a registration area (RA) that includes a geodetic area determined by a network node, such as the AMF, based on a current geodetic location of a UE. Thus, the RA is not necessarily a preconfigured area (e.g. is not composed of tracking areas or fixed cells) and does not have an associated identifier or associated identifiers. The RA, for example, may be a circle or other shape that may be centered on the current location of the UE. The UE may access any satellite radio cell that has coverage of the RA for connection with a serving public land mobile network (PLMN). The UE may determine whether the radio cell provides coverage for the RA based on an updated geodetic location for the UE obtained by the UE, e.g., based on whether the updated geodetic location is inside or outside the RA. The UE may additionally or alternatively determine whether the radio cell provides coverage for the RA based on a current geodetic area of coverage for the radio cell which may be broadcast within the radio cell (e.g. broadcast in a System Information Block 1 (SIB1)), e.g., based on whether the current geodetic area of coverage includes at least part of the RA. When the UE determines that the radio cell does not provide coverage for the RA, the UE may perform a Mobility Registration Update with the serving PLMN and obtain an updated RA based on an updated geodetic location of the UE. The UE, for example, may perform a Registration when the UE exits the RA, or after expiration of a configurable time during which the UE cannot determine its location accurately enough to support determination of whether the UE exited the RA. A network node may page the UE via a radio cell, where the paging message is transmitted in one or more radio cells having radio coverage of at least part of the RA. The UE may further receive one or more forbidden geodetic areas and may refrain from requesting service from the serving PLMN when an updated geodetic location is determined to be within any of the one or more forbidden geodetic areas.

It is noted that the terms “Registration”, “Registration Update”. “NAS Registration” and “Mobility Registration Update” are used synonymously herein to refer to a procedure in which a UE registers its presence, approximate location and identity with a serving PLMN in order to access the serving PLMN subsequently to receive communication and other services. These terms are widely known in the industry, e.g. are defined in 3GPP TSs 23.501 and 23.502.

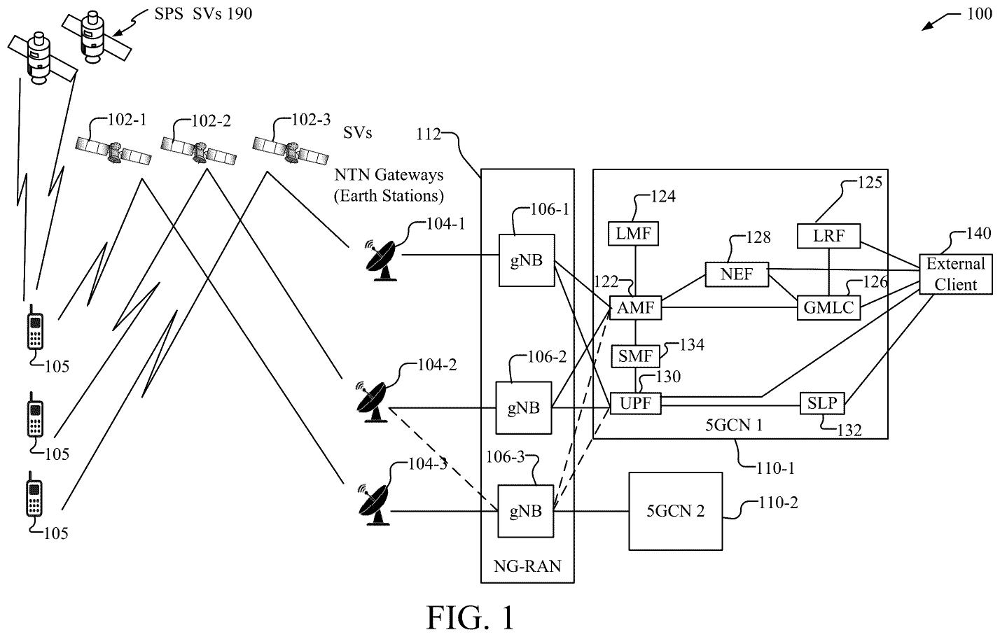

FIG. 1 illustrates an example network architecture 100 capable of supporting satellite access using 5G New Radio (NR) and registration areas (RAs) defined by an network node, such as the AMF 122, based on a current geodetic location of the UE 105, as discussed herein. For example, the RA for a UE 105 may be used to by the UE 105 to determine when Registration is necessary and to enable paging of the UE 105 by the AMF 122. FIG. 1 illustrates a network architecture with transparent space vehicles (SVs) 102. A transparent SV 102 may implement frequency conversion and a radio frequency (RF) amplifier in both uplink (UL) and downlink (DL) directions and may correspond to an analog RF repeater. A transparent SV 102, for example, may receive uplink (UL) signals from all served UEs 105 and may redirect the combined signals DL to an earth station 104 without demodulating or decoding the signals. Similarly, a transparent SV 102 may receive an UL signal from an earth station 104 and redirect the signal DL to served UEs 105 without demodulating or decoding the signal. However, the SV 102 may frequency convert received signals and may amplify and/or filter received signals before transmitting the signals.

The network architecture 100 comprises a number of UEs 105, a number of SVs 102-1 to 102-3 (collectively referred to herein as SVs 102), a number of Non-Terrestrial Network (NTN) gateways 104-1 to 104-3 (collectively referred to herein as NTN gateways 104) (sometimes referred to herein simply as gateways 104, earth stations 104, or ground stations 104), a number of NR NodeBs (gNBs) 106-1 to 106-3 (collectively referred to herein as gNBs 106) capable of communication with UEs 105 via SVs 102 and that are part of a Next Generation (NG) Radio Access Network (RAN) (NG-RAN) 112. It is noted that the term gNB refers in general to a terrestrial gNB which may be enhanced with support for SVs and may, in that case, still be referred to as a gNB (e.g. in 3GPP) or sometimes may be referred to as a satellite NodeB (sNB). The network architecture 100 is illustrated as further including components of a number of Fifth Generation (5G) networks including 5G Core Networks (5GCNs) 110-1 and 110-2 (collectively referred to herein as 5GCNs 110). The 5GCNs 110 may be public land mobile networks (PLMN) that may be located in the same or in different countries. FIG. 1 illustrates various components within 5GCN1 110-1 that may operate with the NG-RAN 112. It should be understood that 5GCN2 110-2 and other 5GCNs may include identical, similar or different components and associated NG-RANs, which are not illustrated in FIG. 1 in order to avoid unnecessary obfuscation. A 5G network may also be referred to as a New Radio (NR) network; NG-RAN 112 may be referred to as a 5G RAN or as an NR RAN; and 5GCN 110 may be referred to as an NG Core network (NGC).

The network architecture 100 may further utilize information from space vehicles (SVs) 190 for Satellite Positioning System (SPS) including Global Navigation Satellite Systems (GNSS) like Global Positioning System (GPS), GLObal NAvigation Satellite System (GLONASS), Galileo or Beidou or some other local or regional SPS, such as Indian Regional Navigation Satellite System (IRNSS), European Geostationary Navigation Overlay Service (EGNOS), or Wide Area Augmentation System (WAAS), all of which are sometimes referred to herein as GNSS. It is noted that SVs 190 act as navigation SVs and are separate and distinct from SVs 102, which act as communication SVs. However, it is not precluded that some of SVs 190 may also act as some of SVs 102 and/or that some of SVs 102 may also act as some of SVs 190. In some implementations, for example, the SVs 102 may be used for both communication and positioning. Additional components of the network architecture 100 are described below. The network architecture 100 may include additional or alternative components.

Permitted connections in the network architecture 100 having the network architecture with transparent SVs illustrated in FIG. 1, allow a gNB 106 to access multiple Earth stations 104 and/or multiple SVs 102. A gNB 106, e.g., illustrated by gNB 106-3, may also be shared by multiple PLMNs (5GCNs 110), which may all be in the same country or possibly in different countries, and an Earth station 104, e.g., illustrated by Earth station 104-2, may be shared by more than one gNB 106.

It should be noted that FIG. 1 provides only a generalized illustration of various components, any or all of which may be utilized as appropriate, and each of which may be duplicated or omitted, as necessary. Specifically, although only three UEs 105 are illustrated, it will be understood that many UEs (e.g., hundreds, thousands, millions, etc.) may utilize the network architecture 100. Similarly, the network architecture 100 may include a larger (or smaller) number of SVs 190, SVs 102, earth stations 104, gNBs 106, NG-RAN 112, 5GCNs 110, external clients 140, and/or other components. The illustrated connections that connect the various components in the network architecture 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, 4G Long Term Evolution (LTE), future 6G, etc.

The UE 105 may comprise and/or be referred to as a device, a mobile device, a wireless device, a mobile terminal, a terminal, a mobile station (MS), a Secure User Plane Location (SUPL) Enabled Terminal (SET), or by some other name. Moreover, UE 105 may correspond to a cellphone, smartphone, laptop, tablet, PDA, tracking device, navigation device, Internet of Things (IoT) device, or some other portable or moveable device. Typically, though not necessarily, the UE 105 may support wireless communication using one or more Radio Access Technologies (RATs) such as using Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G New Radio (NR) (e.g., using the NG-RAN 112 and 5GCN 140), etc. The UE 105 may also support wireless communication using a Wireless Local Area Network (WLAN) which may connect to other networks (e.g. the Internet) using a Digital Subscriber Line (DSL) or packet cable for example. The UE 105 further supports wireless communications using space vehicles, such as SVs 102. The use of one or more of these RATs may allow the UE 105 to communicate with an external client 140 (e.g. via a User Plane Function (UPF) 130 or via a Gateway Mobile Location Center (GMLC) 126).

The UE 105 may include a single entity or may include multiple entities such as in a personal area network where a user may employ audio, video and/or data I/O devices and/or body sensors and a separate wireline or wireless modem.

The UE 105 may support position determination, e.g., using signals and information from space vehicles 190 in an SPS, such as GPS, GLONASS, Galileo or Beidou or some other local or regional SPS such as IRNSS, EGNOS or WAAS, all of which may be generally referred to herein as GNSS. Position measurements using SPS can be based on measurements of propagation delay times of SPS signals broadcast from a number of orbiting satellites to a SPS receiver in the UE 105. Once the SPS receiver has measured the signal propagation delays for each satellite, the range to each satellite can be determined and precise navigation information including 3-dimensional position, velocity, and time of day of the SPS receiver can then be determined using the measured ranges and the known locations of the satellites. Positioning methods which may be supported using SVs 190 may include Assisted GNSS (A-GNSS), Real Time Kinematic (RTK), Precise Point Positioning (PPP) and Differential GNSS (DGNSS). Information and signals from SVs 102 may also be used to support positioning. The UE 105 may further support positioning using terrestrial positioning methods, such as Downlink Time Difference of Arrival (DL-TDOA), Enhanced Cell ID (ECID), Round Trip signal propagation Time (RTT), multi-cell RTT (also referred to a Multi RTT), angle of arrival (AOA), angle of departure (AOD), time of arrival (TOA), receive-time transmission-time difference (Rx-Tx) and/or other positioning methods.

An estimate of a location of the UE 105 may be referred to as a geodetic location, location, location estimate, location fix, fix, position, position estimate or position fix, and may be geodetic, thus providing location coordinates for the UE 105 (e.g., latitude and longitude) which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.) A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term “location” may comprise any of these variants unless indicated otherwise.

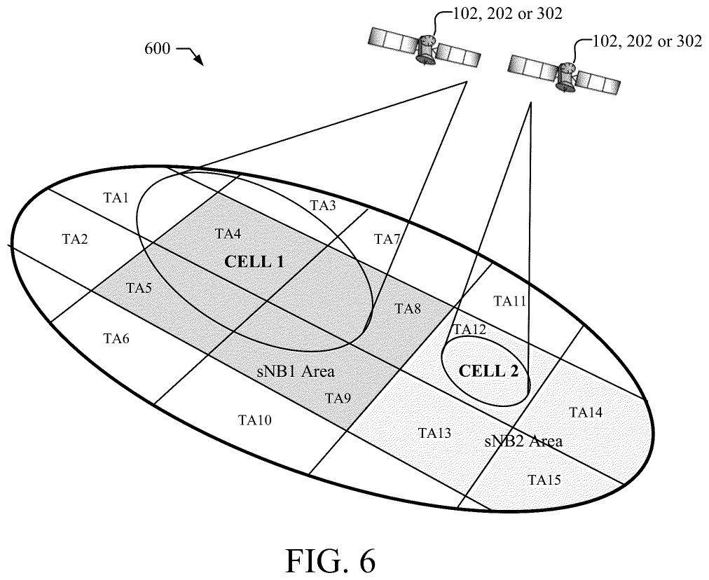

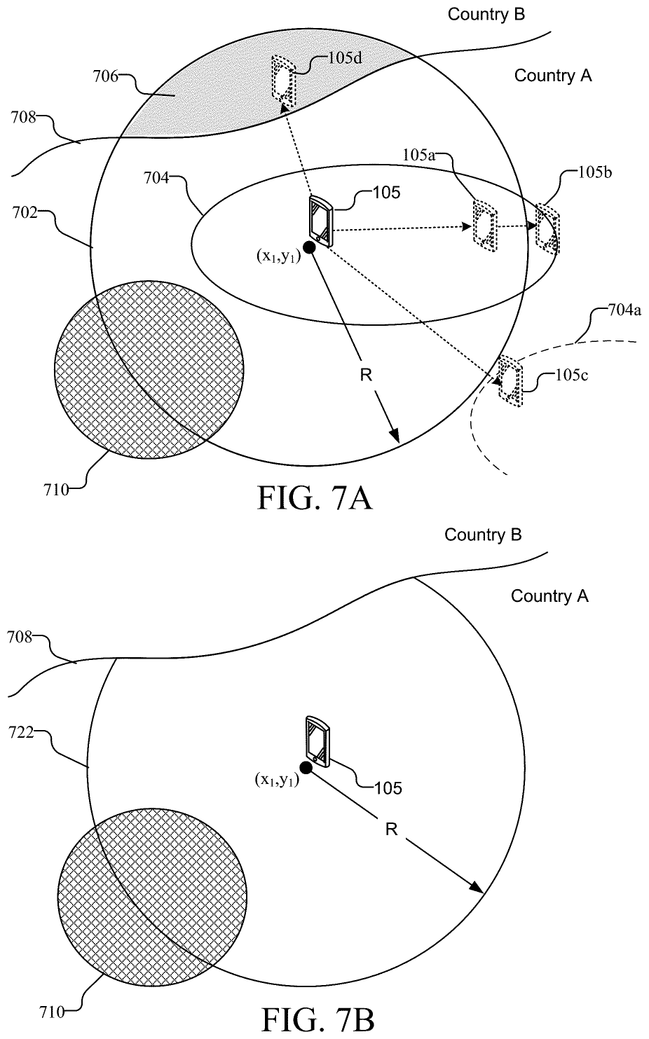

The use of the term “geodetic location” is applied when referring to a location defined using coordinates (or an area or volume) within a coordinate system covering part or all of the earth's surface (e.g. latitude/longitude or a local X/Y or X/Y/Z coordinate system). A geodetic location may include coordinates (e.g. latitude, longitude and optionally altitude) for a point on, above or below the surface of the Earth and may further include an uncertainty area or volume within which a UE is expected to be located with some level of confidence (e.g. 67% or 95%). In some implementations, a geodetic location may be represented or indicated by the identity of a fixed cell (e.g. by a cell identity), where the geodetic location corresponds to a fixed geodetic area (e.g. a circle, ellipse or polygon) defined (e.g. by O&M) for the fixed cell, as described later for FIGS. 5 and 6. In these implementations, the fixed cell identity may only be used within a network (e.g. may be transferred from a gNB 106/202/307 to an AMF 122) and may not necessarily be sent to a UE 105, since a UE 105 may typically not know the geodetic area definition for a fixed cell.

The UEs 105 are configured to communicate with 5GCNs 110 via the SVs 102, earth stations 104, and gNBs 106. As illustrated by NG-RAN 112, the NG-RANs associated with the 5GCNs 110 may include one or more gNBs 106. The NG-RAN 112 may further include a number of terrestrial base stations, e.g., gNBs (not shown) that are not capable of communication with UEs via SVs 102. Pairs of terrestrial and/or satellite base stations, e.g., gNBs and gNB 106-1 in NG-RAN 112 may be connected to one another using terrestrial links—e.g. directly or indirectly via other gNBs or gNBs 106 and may communicate using an Xn interface. Access to the 5G network is provided to UEs 105 via wireless communication between each UE 105 and a serving gNB 106, via an SV 102 and an earth station 104. The gNBs 106 may provide wireless communications access to the 5GCN 110 on behalf of each UE 105 using 5G NR. 5G NR radio access may also be referred to as NR radio access or as 5G radio access and may be as defined by the Third Generation Partnership Project (3GPP).

Base stations (BSs) in the NG-RAN 112 shown in FIG. 1 may also or instead include a next generation evolved Node B, also referred to as an ng-eNB (not shown in FIG. 1). An ng-eNB may be connected to one or more gNBs 106 and/or gNBs in NG-RAN 112—e.g. directly or indirectly via other gNBs 106, gNBs and/or other ng-eNBs. An ng-eNB may provide LTE wireless access and/or evolved LTE (eLTE) wireless access to a UE 105.

A gNB 106 may be referred to by other names such as a gNB or a “satellite node”, “satellite gNB”, or “satellite access node.” The gNBs 106 are not be the same as terrestrial gNBs, but may be based on a terrestrial gNB with additional capability. For example, a gNB 106 may terminate the radio interface and associated radio interface protocols to UEs 105 and may transmit DL signals to UEs 105 and receive UL signals from UEs 105 via SVs 102 and earth stations (ESs) 104. A gNB 106 may also support signaling connections and voice and data bearers to UEs 105 and may support handover of UEs 105 between different radio cells for the same SV 102, between different earth stations 104 for the same SV 102, between different SVs 102 and/or between different gNBs 106. GNBs 106 may be configured to manage moving radio beams (for LEO SVs) and associated mobility of UEs 105. The gNBs 106 may assist in the handover (or transfer) of SVs 102 between different Earth stations 104, different gNBs 106, and between different countries. The gNBs 106 may hide or obscure specific aspects of connected SVs 102 from the 5GCN 110, e.g. by interfacing to a 5GCN 110 in the same way or in a similar way to a terrestrial gNB, and may avoid a 5GCN 110 from having to maintain configuration information for SVs 102 or perform mobility management directly related to SVs 102.

The gNBs 106 may further assist in sharing of SVs 102 over multiple countries. The gNBs 106 may communicate with one or more earth stations 104, e.g., as illustrated by gNB 106-3 communicating with earth stations 104-2 and 104-3. The gNBs 106 may be separate from earth stations 104. The gNBs 106 may include or may be combined with one or more earth stations 104 (not shown in FIG. 1), e.g., using a split architecture. For example, with a split architecture, a gNB 106 may include a Central Unit and an earth station 104 may act as Distributed Unit (DU). A gNB 106 may typically be fixed on the ground with transparent SV operation. In one implementation, one gNB 106 may be physically combined with, or physically connected to, one earth station 104 to reduce complexity and cost.

The earth stations 104 may be shared by more than one gNB 106 and may communicate with UE 105 via the SVs 102. An earth station 104 may be dedicated to just one SVO and to one associated constellation of SV 102 and hence may be owned and managed by the SVO. Earth stations 104 may be included within a gNB 106, e.g., as a gNB-DU within a gNB 106, which may occur when the same SVO or the same MNO owns both the gNB 106 and the included earth stations 104. Earth stations 104 may communicate with SVs 102 using control and user plane protocols that may be proprietary to an SVO. The control and user plane protocols between earth stations 104 and SVs 102 may: (i) establish and release Earth Station 104 to SV 102 communication links, including authentication and ciphering; (ii) update SV software and firmware; (iii) perform SV Operations and Maintenance (O&M); (iv) control radio beams (e.g., direction, power, on/off status) and mapping between radio beams and earth station uplink (UL) and downlink (DL) payload; and (v) assist with handoff of an SV 102 or radio cell to another Earth station 104.

As noted, while FIG. 1 depicts nodes configured to communicate according to 5G NR communication protocols for an NG-RAN 112, nodes configured to communicate according to other communication protocols may be used, such as, for example, an LTE protocol for an Evolved Universal Mobile Telecommunications System (UMTS) Terrestrial Radio Access Network (E-UTRAN), future 6G protocols, or an IEEE 802.11x protocol for a WLAN. For example, in a 4G Evolved Packet System (EPS) providing LTE wireless access to UE 105, a RAN may comprise an E-UTRAN, which may comprise base stations comprising evolved Node Bs (eNBs) supporting LTE wireless access. A core network for EPS may comprise an Evolved Packet Core (EPC). An EPS may then comprise an E-UTRAN plus EPC, where the E-UTRAN corresponds to NG-RAN 112 and the EPC corresponds to 5GCN 110 in FIG. 1. The methods and techniques described herein for support of a RAN location server function may be applicable to such other networks.

The gNBs 106 in the NG-RAN 112 may communicate with an Access and Mobility Management Function (AMF) 122 in a 5GCN 110, which, for positioning functionality, may communicate with a Location Management Function (LMF) 124. For example, the gNBs 106 may provide an N2 interface to the AMF 122. An N2 interface between a gNB 106 and a 5GCN 110 may be the same as, or similar to, an N2 interface supported between a gNB and a 5GCN 110 for terrestrial NR access by a UE 105 and may use the Next Generation Application Protocol (NGAP) defined in 3GPP Technical Specification (TS) 38.413 between a gNB 106 and the AMF 122. The AMF 122 may support mobility of the UE 105, including radio cell change and handover and may participate in supporting a signaling connection to the UE 105 and possibly data and voice bearers for the UE 105. The LMF 124 may support positioning of the UE 105 when UE accesses the NG-RAN 112 and may support position procedures/methods such as A-GNSS, DL-TDOA, RTK, PPP, DGNSS, ECID, AOA, AOD, multi-cell RTT and/or other positioning procedures including positioning procedures based on communication signals from one or more SVs 102. The LMF 124 may also process location services requests for the UE 105, e.g., received from the AMF 122 or from a Gateway Mobile Location Center (GMLC) 126. The LMF 124 may be connected to AMF 122 and/or to GMLC 126. In some embodiments, a node/system that implements the LMF 124 may additionally or alternatively implement other types of location-support modules, such as an Enhanced Serving Mobile Location Center (E-SMLC). It is noted that in some embodiments, at least part of the positioning functionality (including derivation of a UE 105's location) may be performed at the UE 105 (e.g., using signal measurements obtained by UE 105 for signals transmitted by SVs 102, SVs 190, gNBs and assistance data provided to the UE 105, e.g. by LMF 124).

The GMLC 126 may support a location request for the UE 105 received from an external client 140 and may forward such a location request to the AMF 122 for forwarding by the AMF 122 to the LMF 124. A location response from the LMF 124 (e.g. containing a location estimate for the UE 105) may be similarly returned to the GMLC 126 via the AMF 122, and the GMLC 126 may then return the location response (e.g., containing the location estimate) to the external client 140. The GMLC 126 is shown connected to only the AMF 122 in FIG. 1 though in some implementations may be connected to both the AMF 122 and the LMF 124 and may support direct communication between the GMLC 126 and LMF 124 or indirection communications, e.g. via the AMF 122.

A Network Exposure Function (NEF) 128 may be included in 5GCN 110, e.g., connected to the GMLC 126 and the AMF 122. In some implementations, the NEF 128 may be connected to communicate directly with the external client 140. The NEF 128 may support secure exposure of capabilities and events concerning 5GCN 110 and UE 105 to an external client 140 and may enable secure provision of information from external client 140 to 5GCN 110.

A User Plane Function (UPF) 130 may support voice and data bearers for UE 105 and may enable UE 105 voice and data access to other networks such as the Internet. The UPF 130 may be connected to gNBs 106 and gNBs. UPF 130 functions may include: external Protocol Data Unit (PDU) session point of interconnect to a Data Network, packet (e.g. Internet Protocol (IP)) routing and forwarding, packet inspection and user plane part of policy rule enforcement, Quality of Service (QoS) handling for user plane, downlink packet buffering and downlink data notification triggering. UPF 130 may be connected to a Secure User Plane Location (SUPL) Location Platform (SLP) 132 to enable support of positioning of UE 105 using SUPL as defined by the Open Mobile Alliance (OMA). SLP 132 may be further connected to or accessible from external client 140.

As illustrated, a Session Management Function (SMF) 134 connects to the AMF 122 and the UPF 130. The SMF 134 may have the capability to control both a local and a central UPF within a PDU session. SMF 134 may manage the establishment, modification, and release of PDU sessions for UE 105, perform IP address allocation and management for UE 105, act as a Dynamic Host Configuration Protocol (DHCP) server for UE 105, and select and control a UPF 130 on behalf of UE 105.

The external client 140 may be connected to the core network 110 via the GMLC 126 and/or the SLP 132, and in some implementations, the NEF 128. The external client 140 may optionally be connected to the core network 110 and/or to a location server, which may be, e.g., an SLP, that is external to 5GCN 110, via the Internet. The external client 140 may be connected to the UPF 130 directly or through the Internet. The external client 140 may be a server, a web server, or a user device, such as a personal computer, a UE, etc.

A Location Retrieval Function (LRF) 125 may be connected to the GMLC 126, as illustrated, and in some implementations, to the SLP 132, as defined in 3GPP Technical Specifications (TSs) 23.273 and 23.167. LRF 125 may perform the same or similar functions to GMLC 126, with respect to receiving and responding to a location request from an external client 140 that corresponds to a Public Safety Answering Point (PSAP) supporting an emergency call from UE 105. One or more of the UPF 130, GMLC 126, LRF 125, and SLP 132 may be connected to the external client 140, e.g., through another network, such as the Internet.

The AMF 122 may normally support network access and registration by UEs 105, mobility of UEs 105, including radio cell change and handover and may participate in supporting a signaling connection to a UE 105 and possibly data and voice bearers for a UE 105. One role of an AMF 122 may be to determine an RA for a UE, based on a current geodetic location of the UE and to provide an indication of the RA to the UE, e.g., during a Registration process. The AMF 122 may page the UE 105, e.g., by sending a paging message via one or more radio cells that have radio coverage in at least part of the RA.

UEs 105 may obtain location measurements for signals transmitted by SVs 190 and/or by base stations and access points such as eNBs, ng-eNBs, gNBs, and/or SVs 102 which may enable a UE 105 to determine a current geodetic location for UE 105 or to obtain a current geodetic location for UE 105 from a location server in 5GCN 110, e.g., LMF 124. For example, UE 105 may transfer location measurements to the location server to compute and return the location estimate. UEs 105 (or the LMF 124) may obtain a geodetic location estimate for UE 105 using position methods such as GPS, Assisted GPS (A-GPS), Assisted GNSS (A-GNSS), DL-TDOA, Enhanced Cell ID (ECID), multi-cell RTT, Wireless Local Area Network (WLAN) positioning (e.g. using signals transmitted by IEEE 802.11 WiFi access points), sensors (e.g. inertial sensors) in UE 105, or some (hybrid) combination of these. A UE 105 may use the geodetic location for the UE 105 to determine whether a currently accessed radio cell provides coverage for the RA, e.g., based on whether the geodetic location is inside or outside the RA.

Support of transparent SVs 102 with the network architecture shown in FIG. 1 may impact the communication system as follows. The 5GCN 110 may treat a satellite RAT as a new type of RAT with longer delay, reduced bandwidth, and/or higher error rate. Consequently, while there may be some impact to Protocol Data Unit (PDU) session establishment and mobility management (MM) and connection management (CM) procedures, impacts to an AMF 122 (or LMF 124) may be small—e.g. such as providing an indication of the RA to a UE 105 during Registration. There may be no impact to the SVs 102. The SVs 102 may be shared with other services (e.g. satellite TV, fixed Internet access) with 5G NR mobile access for UEs 105 added in a transparent manner. This may enable legacy SVs 102 to be used and may avoid the need to deploy a new type of SV 102. Further, the gNBs 106 may be fixed and may be configured to support one or more countries and one or more PLMNs in the one or more countries.

In some implementations, the radio beam coverage of an SV 102 may be large, e.g., up to or greater than 1000 kms across, and may provide access to more than one country. An earth station 104 may be shared by multiple gNBs 106 (e.g., earth station 104-2 may be shared by gNBs 106-2 and 106-3), and a gNB 106 may be shared by multiple core networks in separate PLMNs located in the same country or in different countries (e.g., gNB 106-3 may be shared by 5GCN 1 110-1 and 5GCN 2 110-1, which may be in different PLMNs in the same country or in different countries).

An RA, as described above, may not be preconfigured and may not require a standard definition. The RA, for example, may be a circle or other shape that is centered on or otherwise associated with a current geodetic location of a UE 105. The RA may be the interior of a circle or other shape. The RA, for example, may be defined by a radius of a circle centered on a geodetic location of a UE 105. The RA may be based on an extended geodetic area that includes a portion covering all or part of a home country for a serving PLMN and another portion covering one or more other countries, e.g., where the RA may include the first portion of the extended geodetic area and exclude the second portion of the extended geodetic area. Because an RA can be determined based on a current geodetic location of a UE 105, the RA may not be preconfigured by an AMF 122 and, accordingly, may not have an associated identifier or identifiers.

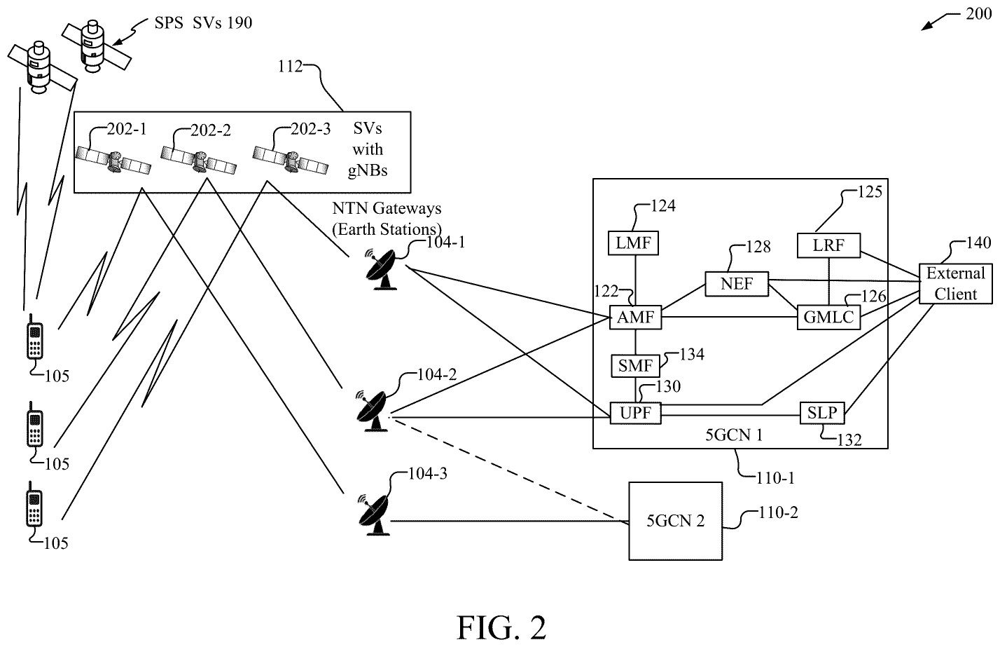

FIG. 2 shows a diagram of a network architecture 200 capable of supporting satellite access using 5G New Radio (NR) and RAs defined by an network node, such as the AMF 122, based on a current geodetic location of a UE 105, as discussed herein. The network architecture shown in FIG. 2 is similar to that shown in FIG. 1, like designated elements being similar or the same. FIG. 2, however, illustrates a network architecture with regenerative SVs 202-1, 202-2, and 202-3 (collectively SVs 202), as opposed to transparent SVs 102 shown in FIG. 1. A regenerative SV 202, unlike a transparent SV 102, includes an on-board gNB 202 (e.g. includes the functional capability of a gNB 106), and is sometimes referred to herein as an SV/gNB 202. The NG-RAN 112 is illustrated as including the SV/gNBs 202. Reference to a gNB 202 is used herein when referring to SV/gNB 202 functions related to communication with UEs 105 and 5GCNs 110, whereas reference to an SV 202 is used when referring to SV/gNB 202 functions related to communication with earth stations 104 and with UEs 105 at a physical radio frequency level. However, there may be no precise delimitation of an SV 202 versus a gNB 202.

An onboard gNB 202 may perform many of the same functions as a gNB 106 as described previously. For example, a gNB 202 may terminate the radio interface and associated radio interface protocols to UEs 105 and may transmit DL signals to UEs 105 and receive UL signals from UEs 105, which may include encoding and modulation of transmitted signals and demodulation and decoding of received signals. A gNB 202 may also support signaling connections and voice and data bearers to UEs 105 and may support handover of UEs 105 between different radio cells for the same gNB 202 and between different gNBs 202. The gNBs 202 may assist in the handover (or transfer) of SVs 202 between different Earth stations 104, different 5GCNs 110, and between different countries. The gNBs 202 may hide or obscure specific aspects of SVs 202 from the 5GCN 110, e.g. by interfacing to a 5GCN 110 in the same way or in a similar way to a gNB or gNB 106. The gNBs 202 may further assist in sharing of SVs 202 over multiple countries. The gNBs 202 may communicate with one or more earth stations 104 and with one or more 5GCNs 110 via the earth stations 104. In some implementations, gNBs 202 may communicate directly with other gNBs 202 using Inter-Satellite Links (ISLs) (not shown in FIG. 2), which may support an Xn interface between any pair of gNBs 202.

With LEO SVs, an SV/gNB may need to manage moving radio cells with coverage in different countries at different times. Earth stations 104 may be connected directly to a 5GCN 110, as illustrated. For example, as illustrated, earth station 104-1 may be connected to AMF 122 and UPF 130 of 5GCN 1 110-1, while earth station 104-2 may be similarly connected to 5GCN 1 110-1 and 5GNC 2 110-2, and earth station 104-3 is connected to 5GCN 2 110-2. The earth stations 104 may be shared by multiple 5GCNs 110, for example, if Earth stations 104 are limited. For example, in some implementations (illustrated with dotted lines), earth station 104-2 may be connected to both 5GCN 1 110-1 and 5GCN 2 110-2. The 5GCN 110 may need to be aware of SV 202 coverage areas in order to page UEs 105 and to manage handover. Thus, as can be seen, the network architecture with regenerative SVs may have more impact and complexity with respect to both gNBs 202 and 5GCNs 110 than the network architecture with transparent SVs 102 shown in FIG. 1.

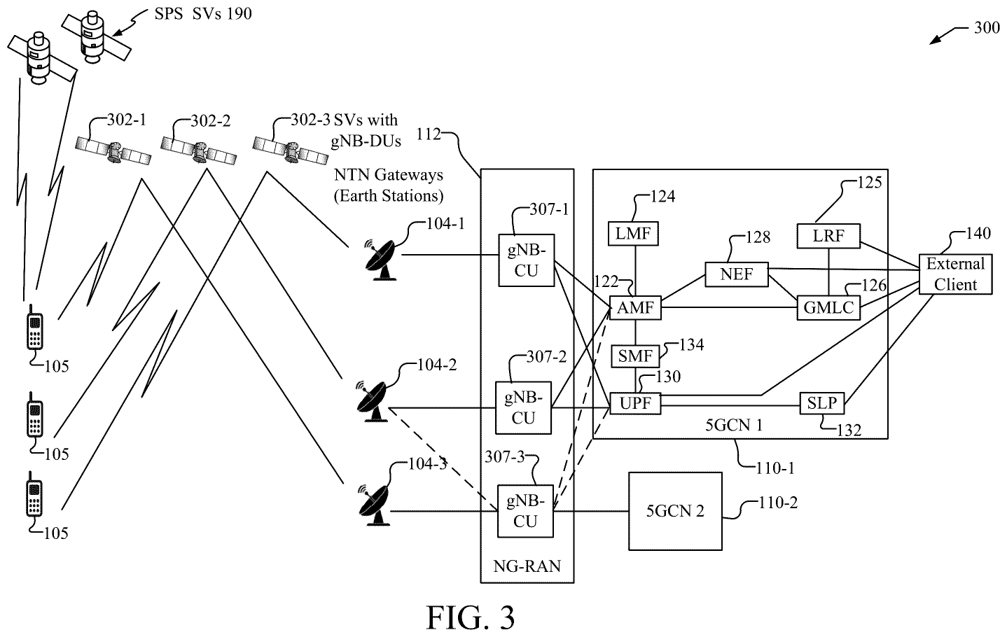

FIG. 3 shows a diagram of a network architecture 300 capable of supporting satellite access using 5G New Radio (NR) and RAs defined by an network node, such as the AMF 122, based on a current geodetic location of the UE 105, as discussed herein. The network architecture shown in FIG. 3 is similar to that shown in FIGS. 1 and 2, like designated elements being similar or the same. FIG. 3, however, illustrates a network architecture with regenerative SVs 302-1, 302-2, and 302-3 (collectively referred to as SVs 302), as opposed to transparent SVs 102 shown in FIG. 1, and with a split architecture for the gNBs. The gNBs 307 include a central unit and may sometimes be referred as gNB-CU 307, and a regenerative SV 302, unlike a transparent SV 102, includes an on-board gNB Distributed Unit (gNB-DU) 302, and is sometimes referred to herein as an SV/gNB-DU 302. Reference to a gNB-DU 302 is used herein when referring to SV/gNB 302 functions related to communication with UEs 105 and gNB-CUs 307, whereas reference to an SV 302 is used when referring to SV/gNB-DU 302 functions related to communication with earth stations 104 and with UEs 105 at a physical radio frequency level. However, there may be no precise delimitation of an SV 302 versus a gNB-DU 302.

Each gNB-DU 302 communicates with one ground based gNB-CU 307 via one or more earth stations 104. One gNB-CU 307 together with the one or more gNB-DUs 302 which are in communication with the gNB-CU 307 performs functions, and may use internal communication protocols, which are similar to or the same as a terrestrial gNB with a split architecture as described in 3GPP TS 38.401. Here a gNB-DU 302 corresponds to and performs functions similar to or the same as a gNB Distributed Unit (gNB-DU) defined in TS 38.401, while a gNB-CU 307 corresponds to and performs functions similar to or the same as a gNB Central Unit (gNB-CU) defined in TS 38.401. For example, a gNB-DU 302 and a gNB-CU 307 may communicate with one another using an F1 Application Protocol (F1AP) as defined in 3GPP TS 38.473 and together may perform some or all of the same functions as a gNB 106 or gNB 202 as described previously. To simplify references to different types of gNB in the description below, a gNB-DU 302 may sometimes be referred to a gNB 302 (without the “DU” label), and a gNB-CU 307 may sometimes be referred to a gNB 307 (without the “CU” label).

A gNB-DU 302 may terminate the radio interface and associated lower level radio interface protocols to UEs 105 and may transmit DL signals to UEs 105 and receive UL signals from UEs 105, which may include encoding and modulation of transmitted signals and demodulation and decoding of received signals. A gNB-DU 302 may support and terminate Radio Link Control (RLC), Medium Access Control (MAC) and Physical (PHY) protocol layers for the NR Radio Frequency (RF) interface to UEs 105, as defined in 3GPP TSs 38.201, 38.202, 38.211, 38.212, 38.213, 38.214, 38.215, 38.321 and 38.322. The operation of a gNB-DU 302 is partly controlled by the associated gNB-CU 307. One gNB-DU 307 may support one or more NR radio cells for UEs 105. A gNB-CU 307 may support and terminate a Radio Resource Control (RRC) protocol, Packet Data Convergence Protocol (PDCP) and Service Data Protocol (SDAP) for the NR RF interface to UEs 105, as defined in 3GPP TSs 38.331, 38.323, and 37.324, respectively. A gNB-CU 307 may also be split into separate control plane (gNB-CU-CP) and user plane (gNB-CU-UP) portions, where a gNB-CU-CP communicates with one or more AMFs 122 in one more 5GCNs 110 using the NGAP protocol and where a gNB-CU-UP communicates with one or more UPFs 130 in one more 5GCNs 110 using a General Packet Radio System (GPRS) tunneling protocol (GTP) user plane protocol (GTP-U) as defined in 3GPP TS 29.281. A gNB-DU 302 and gNB-CU 307 may communicate over an F1 interface to (a) support control plane signaling for a UE 105 using Internet Protocol (IP), Stream Control Transmission Protocol (SCTP) and F1 Application Protocol (F1AP) protocols, and (b) to support user plane data transfer for a UE 105 using IP, User Datagram Protocol (UDP), PDCP, SDAP, GTP-U and NR User Plane Protocol (NRUPP) protocols.

A gNB-CU 307 may communicate with one or more other gNB-CUs 307 and/or with one more other gNBs using terrestrial links to support an Xn interface between any pair of gNB-CUs 302 and/or between any gNB-CU 307 and any gNB.

A gNB-DU 302 together with a gNB-CU 307 may: (i) support signaling connections and voice and data bearers to UEs 105; (ii) support handover of UEs 105 between different radio cells for the same gNB-DU 302 and between different gNB-DUs 302; and (iii) assist in the handover (or transfer) of SVs 302 between different Earth stations 104, different 5GCNs 110, and between different countries. A gNB-CU 307 may hide or obscure specific aspects of SVs 302 from a 5GCN 110, e.g. by interfacing to a 5GCN 110 in the same way or in a similar way to a gNB. The gNB-CUs 307 may further assist in sharing of SVs 302 over multiple countries.

In network architecture 300, the gNB-DUs 302 that communicate with and are accessible from any gNB-CU 307 will change over time with LEO SVs 302. With the split gNB architecture, a 5GCN 110 may connect to fixed gNB-CUs 307 which do not change over time and which may reduce difficulty with paging of a UE 105. For example, a 5GCN 110 may not need to know which SV/gNB-DUs 302 are needed for paging a UE 105. The network architecture with regenerative SVs 302 with a split gNB architecture may thereby reduce 5GCN 110 impact at the expense of additional impact to a gNB-CU 307.

There are several SVOs currently operating and several additional SVOs that are preparing to begin operations that may be capable of supporting satellite access using 5G NR or some other wireless access type such as CDMA. Various SVOs may employ different numbers of LEO SVs and Earth gateways and may use different technologies. For example, currently operating SVOs include SVOs using transparent (“bent pipe”) LEO SVs with CDMA, and regenerative LEO SVs capable of ISL. New SVOs have been recently announced with plans for large constellations of LEO SVs to support fixed Internet access. These various SVOs are widely known to the industry.

While supporting satellite access to a wireless network, an SV 102/202/302 may transmit radio beams (also referred to just as “beams”) over multiple countries. For example, a beam transmitted by an SV 102/202/302 may overlap two or more countries. Sharing a beam over two or more countries, however, may raise complications. For example, if a beam is shared by two or more countries, earth stations 104 and gNBs 106/202/302/307 in one country may need to support UE 105 access from other countries.

A first solution to complications raised by beam sharing amongst multiple countries may be to assign one beam to one country. The assignment of a beam to a single country additionally implies assigning each radio cell to one country. This solution may not preclude or prevent beam and radio cell coverage of additional countries, but can restrict UE access to a beam and associated radio cell to just UEs 105 in the country to which the beam and associated radio cell are assigned. A second solution for beam sharing over multiple countries could be to allow a 5GCN 110 in one country to support UEs 105 located in other countries where regulatory approval for this was obtained from the other countries. A third solution could be to share a gNB 106/202/307 among 5GCNs 110 located in different countries (e.g. as could be the case for gNB 106-3, gNB 202-2 and gNB 307-3 shown in FIGS. 1-3), and to verify that each UE 105 accessing the gNB 106/202/307 is registered in and connected to a 5GCN 110 that is in the same country as the UE 105 or permitted to serve the country in which the UE 105 is located.

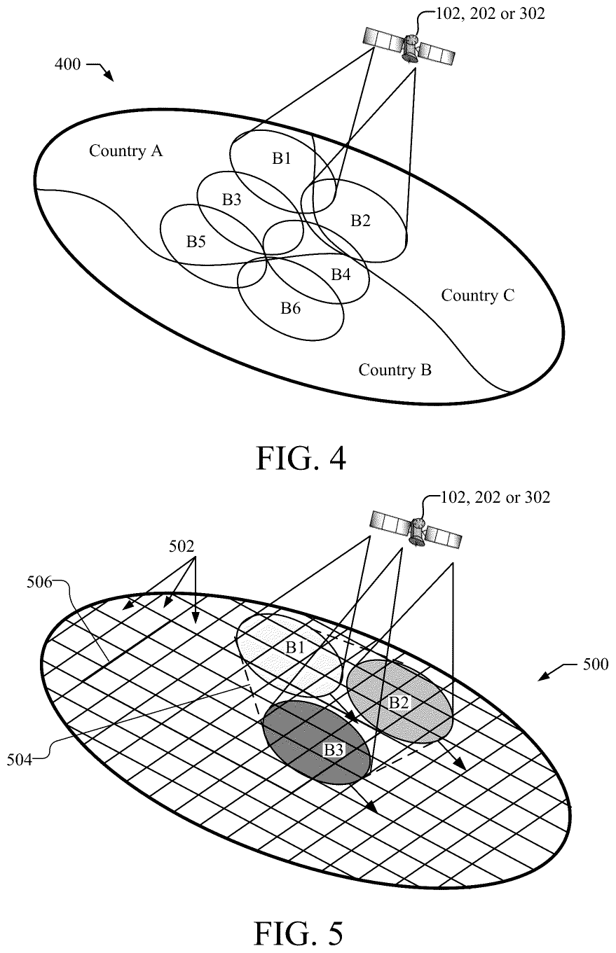

FIG. 4, by way of example, illustrates an SV 102, 202, 302 generating multiple beams identified as beams B1, B2, B3, B4, B5, and B6 over an area 400 that includes portions of multiple countries, e.g., country A, country B, and country C. With the assignment of each beam to just one country as for the first solution above, beams B1, B3, B5 can be assigned to country A, beams B4 and B6 can be assigned to country B, and beam B2 can be assigned to country C. Alternatively, in the case of the second and third solutions, beams B1 and B2 might be allowed to support UEs 105 in countries A and C, beams B4 and B5 might be allowed to support UEs 105 in countries A and B, while beams B3 and B6 may be, respectively, restricted to country A and country B.

In one implementation, an individual beam may be assigned to a single country by controlling or steering the beam. While a Non-Geostationary Earth Orbiting (NGEO) SV has a moving coverage area, a relative beam direction may be moved via a controllable antenna array to stay. or mostly stay, within one country, which is sometimes referred to as a “steerable beam”. For example, beam coverage may move slowly within one country and then hop to a new country, e.g., after an SV 102, 202, 302 has transferred to a new earth station 104 or new gNB 106 or 307.

FIG. 5 illustrates radio cells produced by an SV 102, 202, 302 over an area 500, where fixed cells 502 and fixed tracking areas 506 are used. A radio cell may comprise a single beam or multiple beams, e.g., all beams in a radio cell may use the same frequency or a radio cell may comprise one beam for each frequency in a set of different frequencies. For example, beams B1, B2 and B3 in FIG. 5 may support three separate radio cells (one beam per radio cell) or may collectively support a single radio cell (e.g., radio cell 504 shown with dotted lines). Preferably, a radio cell covers a contiguous area.

Radio beams and radio cells produced by an SV 102, 202, 302 may not align with cells used by terrestrial wireless networks, e.g., 5GCN 110 terrestrial cells or LTE terrestrial cells. For example, in an urban area, a radio beam or radio cell produced by an SV 102, 202. 302 may overlap with many 5GCN terrestrial cells. When supporting satellite access to a wireless network, radio beams and radio cells produced by an SV 102, 202, 302 may be hidden from a 5GCN 110.

As illustrated in FIG. 5, the area 500 includes a number of Earth fixed cells 502, as well as fixed tracking areas (TAs) such as TA 506. Fixed cells 502 are not “real cells,” e.g., used for terrestrial NR and LTE access, and may be referred to as “virtual cells”, “fixed cells”, or “geographic cells.” A fixed cell, such as each of fixed cells 502, can have a fixed geodetic coverage area (or possibly a fixed geodetic coverage volume), which may be defined by a PLMN operator. For example, the coverage area of a fixed cell or a fixed TA may comprise the interior of a circle, ellipse, rectangle, hexagon or other polygon. The coverage area can be fixed relative to the surface of the Earth and does not change with time, unlike the coverage area of a radio cell which typically changes with time for a LEO or medium earth orbit (MEO) SV. A fixed cell 502 may be treated by a 5GCN 110 the same as a real cell that supports terrestrial NR access. A fixed cell 502 may further have an area that is typical for a real cell that supports terrestrial NR access—e.g. a fixed cell may be in the region of 100 meters to a few kilometers from one side to another. Groups of fixed cells 502 may define a fixed TA 506, which may be treated by a 5GCN the same as, or similarly to, TAs that are defined for terrestrial NR access. Fixed cells and fixed TAs used for 5G satellite wireless access may be used by a 5GCN 110 to support mobility management and regulatory services for UEs 105 with minimal new impact.

With regenerative SVs 202 with a non-split architecture as in network architectures 200, each radio cell may remain with the same SV 202 and may have a moving coverage area supporting different 5GCNs 110 at different times.

With transparent SVs 102 and regenerative SVs 302 for a split architecture as in network architectures 100 and 300, each radio cell may be assigned to and controlled by one gNB 106 or 307 on behalf of one or more PLMNs in one country. For a GEO SV 102/302, the assignment to a gNB 106/307 may be permanent or temporary. For example, the assignment may change on a daily basis to allow for peak traffic occurrence at different times in different parts of the SV 102/302 radio footprint and/or may change over a longer period to accommodate changing regional traffic demands. For a non-geostationary (NGEO) SV 102/302, the assignment might last for a short time, e.g., only 5-15 minutes. A non-permanent radio cell may then be transferred to a new gNB 106/307 as necessary (e.g. when access to the NGEO SV 102/302 is transferred to the new gNB 106/307). Each gNB 106/307, for example, may have a fixed geographic coverage area, e.g., comprising a plurality of fixed cells 502 and fixed TAs. A radio cell for a first NGEO SV 102/302 may be transferred from a first gNB 106/307 to a second gNB 106/307 when (or after) moving into the fixed coverage area of the second gNB 106/307. Prior to this transfer, UEs 105 accessing the radio cell in a connected state may be moved to a new radio cell for the first gNB 106/307 or could be handed off to the second gNB 106/307 as part of transferring the radio cell. An SV 102/302 may be accessed from only one gNB 106/307 or from multiple gNBs 106/307, possibly in different countries. In one implementation, an SV 102/302 may be assigned to multiple gNBs 106/307 by partitioning radio cells produced by the SV 102/302 among the different gNBs 106/307. Radio cells may then be transferred to new gNBs 106/307 (and to new countries) as the SV 102/302 moves or as traffic demands change. Such an implementation would be a form of a soft handoff in which SV 102/302 transfer from one gNB 106/307 to another gNB 106/307 occurs in increments of radio cells and not all at once.

FIG. 6 shows an example of assignment of radio cells, e.g., cell 1 and cell 2, produced by one or more SVs 102, 202, 302 over an area 600. As illustrated, the area 600 includes a number of fixed TAs, e.g., TA1-TA15, wherein TA4, TA5, TA8, and TA9 are assigned to a gNB1 (which may be a gNB 106, gNB 202 or a gNB 307), and TA12, TA13, TA14, and TA15 are assigned to a gNB2 (which may be another gNB 106, 202 or 307). In one implementation, a radio cell may be considered to support a fixed TA if the radio cell is wholly within the TA (e.g., Cell 2 within TA 12); if the TA is wholly within the radio cell (e.g., TA4 within Cell 1); or if the overlap of the area of a radio cell and a TA exceeds a predetermined threshold fraction of the total area of the radio cell or the total area of the TA (e.g., cell 1 overlap with TA1, TA3, TA5, TA8 and/or TA9). An SV 102, 202, 302 may broadcast, e.g., in a System Information Block type 1 (SIB1) or SIB type 2 (SIB2), the identities (IDs) of supported PLMNs (e.g., where a PLMN ID comprises a Mobile Country Code (MCC) and Mobile Network Code (MNC)) and, for each supported PLMN, the IDs of supported TAs (e.g. where the ID of a TA comprises a Tracking Area Code (TAC)). For an NGEO SV, the supported PLMNs and TAs may change as radio cell coverage areas change. A gNB 106/202/307 may determine PLMN and TA support (and thus the PLMN IDs and TACs which are broadcast in a SIB for each radio cell) from known ephemeris data for each SV 102/202/302 and a known directionality and angular range for component radio beams for each radio cell (e.g. Cell 1 and Cell 2). A gNB 106/202/307 may then update SIB broadcasting.

Thus, as illustrated in FIG. 6, an SV 102/202/302 may broadcast for cell 1 a SIB that includes TACs for TA4 and possibly TA1, TA3, TA5, TA8 and/or TA9. Similarly, the SV 102/202/302 or another SV 102/202/302 may broadcast for Cell 2 a SIB that includes a TAC for TA12 only. The Cell 1 may be assigned to gNB1 (which has coverage of TA4, TA5, TA8, and TA9) and Cell 2 may be assigned to gNB2 (which has coverage of TA12, TA13, TA14, and TA15). Cell 1 and Cell 2 may be transferred from gNB1 to gNB2 or from gNB2 to gNB1 if the cell coverage area moves from one gNB area to another.

The coverage area for a fixed TA may be defined in a manner that is simple, precise, flexible and requires minimal signaling for conveyance to a UE 105, a gNB 106/202/307, or an entity in a 5GCN 110. A fixed TA area may be small enough to allow efficient paging by comprising an area supported by just a few radio cells (e.g. less than 20) and may also be large enough to avoid excessive UE registration (e.g. may extend at least several kilometers in any direction). The shape of a fixed TA area may be arbitrary, e.g., the shape may be defined by a PLMN operator, or may have one or more restrictions. For example, one restriction for the shape of the fixed TA area may be that a fixed TA along the border of a country precisely aligns with the border to avoid serving UEs 105 in another country. Additionally, a fixed TA may be restricted to align with an area of interest, e.g., a PSAP serving area, the area of a large campus, etc. Additionally, a fixed TA may be restricted so that parts of the fixed TA align with a physical obstacle, such as the bank of a river or lake.

The coverage area for fixed cells may likewise be defined in a manner that is simple, precise, flexible and requires minimal signaling for conveyance to a UE 105 or gNB 106/202/307. A fixed cell coverage area may allow for simple and precise association with a fixed TA, e.g., one fixed cell may belong unambiguously to one TA.

Fixed cells may be used by a wireless core network, such as a 5GCN 110, for support of regulatory services such as emergency (EM) call routing based on a current fixed serving cell for a UE 105, use of a fixed cell to approximate a UE 105 location, use of a fixed cell association to direct a Wireless Emergency Alerting (WEA) alert over a small defined area to a recipient UE 105, or use of a fixed cell as an approximate location or a trigger event for Lawful Interception (LI) for a UE 105. Such usage of fixed cells implies that fixed cells should be capable of being defined with a size and shape similar to that of cells that are defined and used for terrestrial wireless access, including allowing for very small (e.g., pico) cells and large (e.g., rural) cells.

In one implementation, fixed cells and/or fixed TAs may be defined using a regular array of grid points in which each grid point defines one fixed cell or one fixed TA as an area surrounding the grid point containing all locations that are closer to that grid point than to any other grid point.

FIGS. 4-6 illustrate how a radio cell may have a coverage area which spans two or more countries and can be associated with (e.g. mapped to) fixed cells and fixed TAs. As discussed above, use of fixed TAs and fixed cells may have a benefit of minimizing impacts to a 5GCN 110 due to emulating TAs and cells already supported by a 5GCN 110 for terrestrial 5G cellular access by UE 105s. However, support of fixed TAs and fixed cells for 5G satellite access by UEs 105 may require impacts for: (i) defining the fixed TAs and fixed cells using Operations and Maintenance (O&M); (ii) transferring definitions of fixed TAs and fixed cells to gNBs 106/202/307/302; (iii) mapping a geodetic location of a UE 105 to a fixed cell and fixed TA (e.g. at a gNB 106/202/307); and/or (iv) determining which fixed TAs are covered by a radio cell at any time and including and broadcasting the corresponding TACs in a radio cell SIB. In addition, it may be more difficult to support mobility management for UEs 105 using fixed TAs and fixed cells for 5G satellite access than to support mobility management for UEs 105 with terrestrial cellular 5G access, if UEs 105 are not aware of the definitions of the fixed cells and fixed TAs (unlike with 5G terrestrial cellular access, where UEs 105 can always be aware of cells and TAs due to radio cell correspondence with fixed cells). It may therefore be desirable to avoid such disadvantages, even if it requires some additional 5GCN impact.

Accordingly, as discussed herein, fixed TAs and fixed cells may be replaced with an RA that is determined by a network node, e.g., the AMF 122, based on the current geodetic location of a UE 105.

For example, for Non-Access Stratum (NAS) Registration, a Next Generation (NG) Application Protocol (NGAP) User Location Information (ULI) parameter or NAS Registration Request (RR) message or both may include a current geodetic location for a UE 105. The current geodetic location for the UE 105 may be obtained by the UE 105 and included in a NAS RR message or may be obtained by a gNB 106/202/307 and included in an NGAP ULI parameter, which may be provided to an AMF 122 when the UE 105 performs a Mobility Registration Update.

A Mobility Registration Update for a UE 105 may no longer be triggered by a change of TA for the UE 105, but instead, a serving AMF 122 can provide the UE 105 with an RA defined as a geodetic region (or geodetic area) whenever the UE 105 performs a Registration. In one implementation, the RA may be defined as a configurable distance D from a UE 105 geodetic location at the time of the Registration which may minimize Operations and Maintenance, AMF 122 and UE 105 impacts. Thus, the RA may be a circle around the UE geodetic location with radius D.

The UE 105 may perform a new Mobility Registration Update whenever the UE 105 detects that the UE 105 as moved out of the RA. The AMF 122 may then provide a new RA to the UE based on a new geodetic location of the UE at the time of the new Mobility Registration Update. The UE 105 may also perform a Registration at the expiration of a configurable threshold time period T1 during which the UE 105 cannot determine an updated geodetic location with sufficient accuracy to determine whether the UE 105 is inside or outside the RA. The threshold time period T1, for example, may be 3-15 minutes. In some implementations, the threshold time period T1 may vary based on factors such as the size of the RA, the last known geodetic location for the UE 105, and the velocity of the UE 105. The UE 105 may further perform Registration at the expiration of a periodic time period T2 since the last Registration.

To support paging of a UE 105 some time after a UE 105 has entered an IDLE state, an NGAP Paging message sent by an AMF 122 to a gNB 106/202/307 to request paging of the UE 105 could include (e.g. in an NGAP Assistance Data for Paging parameter) location history information for the UE 105 (e.g. a recent history of locations for the UE 105) instead of a TA and cell related history. For example, the location history information could be obtained by a previous serving gNB 106/202/307 for the UE 105 and provided to the AMF 122 (in an NGAP UE Context Release Complete) just before, when or just after the UE 105 enters the IDLE state. An AMF 122 may also or instead include in an NGAP Paging message for a UE 122 a last known geodetic location for the UE 105 and/or the most recent RA for the UE 105, defined as a geodetic region (e.g. a circle, ellipse or polygon). The NGAP Paging message may be sent by the AMF 122 to one or more gNBs 106/202/307. Each gNB 106/202/307 may then send an RRC Paging message for the UE 105 in all radio cells controlled by the gNB 106/202/307 which have some radio coverage of: one or more locations in the location history for the UE 105; the last known geodetic location for the UE 105; and/or the most recent RA for the UE 105.

A UE 105 which has determined to be inside the current RA for the UE 105 may access any radio cell with coverage of the current UE geodetic location, which may simplify radio cell selection for the UE 105. Additionally or alternatively, to ensure the UE 105 accesses a radio cell with coverage of the RA as seen by a gNB 106/202/307, a radio cell may indicate a current geodetic area of coverage of the radio cell (e.g., as a circle, ellipse or polygon). The UE 105 may then only access a radio cell if and while the indicated current geodetic area of coverage for the radio cell overlaps with the RA.

In addition, forbidden areas for a UE 105 may be supported by defining geodetic areas where UE 105 service is not allowed. The forbidden geographic definition(s) may be sent to the UE 105 by the AMF 122 and stored in a forbidden list in the UE 105. When the UE 105 determines that it has entered a forbidden geodetic area, the UE 105 may refrain from requesting service from the serving PLMN.

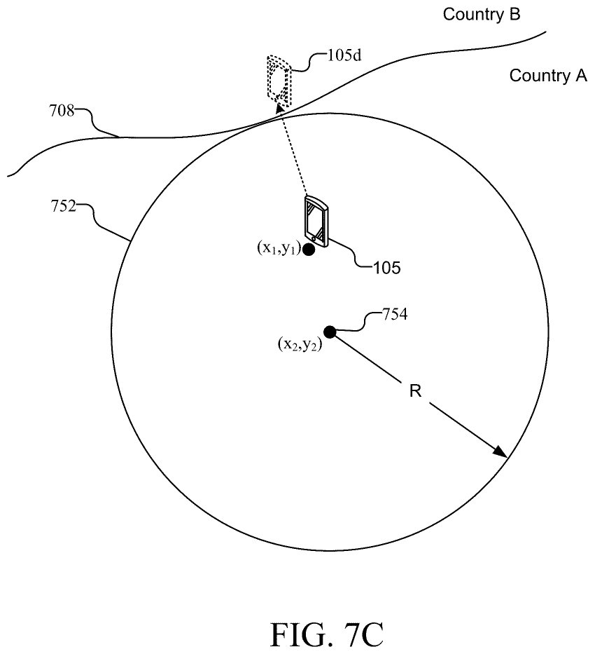

FIG. 7A shows an example of an RA 702 that is defined based on a current geodetic location (x₁,y₁) of the UE 105. The geodetic location of the UE 105 may be obtained by the UE 105, for example, based on location measurements from one or more communication satellites 102/202/302, one or more Global Navigation Satellite System (GNSS) satellites 190, one or more terrestrial base stations (e.g. gNBs), use of inertial sensors, or a combination thereof. The UE 105 may determine the geodetic location based on the location measurements or may provide the location measurements to an entity in a 5GCN, e.g., the LMF 124, or an entity in an NG-RAN (e.g. a gNB 106/202/307) which may determine a current geodetic location of the UE 105. The current geodetic location of the UE 105 is provided to a network node, such as AMF 122, e.g., during Registration of the UE, and the network node may determine the RA 702 based on the current geodetic location of the UE 105. As illustrated, the RA 702 in this example is the interior of a circle that is centered on the geodetic location (x₁,y₁) of the UE 105, with a radius R that defines the geodetic area of the RA 702. The size of the RA 702, as defined by the radius R in the present example, may be determined by the AMF 122 based on various parameters, such as a density of radio cells, a type of environment for the geodetic location (x₁,y₁) of the UE 105 (e.g. dense urban, urban suburban or rural), proximity to undesired areas for coverage, such as other countries or forbidden areas, etc. For example, a smaller RA and smaller value of R (e.g. 10 to 50 kilometers) may be used for an urban or dense urban environment (e.g. because the UE 105 is less likely to move by a large distance), when there is a high density of radio cells (e.g. because a larger value of R might cause paging for the UE 105 in a much larger number of radio cells), or when the UE is close to an undesired areas for coverage (e.g. to avoid the RA from including part of the undesired area for coverage). A larger RA (e.g. 100 to 1000 kilometers) may be used when these conditions are not present. The RA 702 may have other geometric shapes if desired (e.g. may be an ellipse, square, rectangle or other type of polygon).

The UE 105 may access a radio cell that provides coverage that includes at least a portion of the geodetic area of the RA 702. The UE 105, for example, may receive from SV 102, 202, 302 an indication of a current geodetic area of coverage for a radio cell 704 (also referred to as just a geodetic area of coverage for the radio cell 704), which may be broadcast, e.g., in a System Information Block type 1 (SIB1) or SIB type 2 (SIB2). The radio cell 704 may further indicate (e.g. in a SIB1) the IDs of supported PLMNs (e.g., where a PLMN ID comprises a Mobile Country Code (MCC) and Mobile Network Code (MNC)). For an NGEO SV 102/202/302 (e.g. a LEO or EO SV), the supported PLMNs and the geodetic area of coverage for the radio cell 704 may change as the SV 102/202/302 moves with respect to the Earth. A gNB 106/202/307 may determine the supported PLMNs and the geodetic area of coverage for the radio cell 704, which may be broadcast in a SIB for the radio cell 704. The determination by the gNB 106/202/307 may be based on known ephemeris data for the SV 102/202/302 and a known directionality and angular range for component radio beams of the radio cell 704. The UE 105 may determine whether the current geodetic area of coverage for the radio cell 704 includes at least part of the RA 702, and if so, may camp on the radio cell 704 or access the serving PLMN via the radio cell. In some implementations, a geodetic area of coverage for the radio cell 704 may not be included and, instead, a UE 105 may access the radio cell 704 so long as the UE 105 determines that a geodetic location of the UE 105 is inside the RA 702.

Over time and/or after movement of the UE 105 and/or movement of the radio cell 704, the UE 105 may determine whether the radio cell 704 continues to provide coverage for the RA 702. For example, the UE 105 may update its geodetic location and determine whether the updated geodetic location is inside or outside the RA 702. If the updated geodetic location is inside the RA 702, e.g., as illustrated by the position of UE 105a, the radio cell 704 (if still accessible by the UE 105) is determined to provide coverage for the RA 702. On the other hand, if the updated geodetic location is outside the RA 702, e.g., as illustrated by the position of UE 105b, the radio cell 704 (if still accessible by the UE 105) is determined to possibly not provide coverage for the RA 702, and the UE 105 may perform a Registration Update with the serving PLMN via the radio cell 704, during which a new RA based on the updated geodetic location is provided to the UE 105. The new RA may allow the UE 105 to access the radio cell 704 at its current geodetic location 105b.

In an implementation where a current geodetic area of coverage for the radio cell 704 is included (e.g. in a SIB1), the UE 105 may not need to update its geodetic location but may instead continue to determine whether the geodetic area of coverage for the radio cell 704 includes at least part of the RA 702. For example, when UE 105 is at the position 105a which is inside the RA 702, the UE 105 may verify that the geodetic area of coverage for the radio cell 704 still includes part of the RA 702. Conversely, when UE 105 is at the position 105b which is outside the RA 702, the UE 105 may verify that the geodetic area of coverage for the radio cell 704 still includes part of the RA 702 (Case A) or no longer includes part of the RA 702 (Case B). For Case A, the UE 105 can continue to access the radio cell 704 even though the UE 105 is no longer inside the RA 702. For case B, the UE 105 may need to perform a Registration Update in order to receive a new RA that may allow the UE 105 to access the radio cell 704 (or require the UE 105 to search for a different radio cell).

FIG. 7A illustrates movement of the UE 105 outside the RA 702 via position 105a and then position 105b. However UE 105 could remain within the RA 702 (e.g. might be stationary at the geodetic location (x₁,y₁)) and the coverage of the radio cell 704 might move outside the RA 702. In that case, UE 105 may simply loose access to radio cell 704 and need to find another radio cell. Alternatively, UE 105 may continue to access radio cell 704 but determine that a geodetic area of coverage for the radio cell 704 no longer includes any part of the RA 702 (e.g. as when UE 105 moves to position UE 105c and radio cell 704 coverage area moves to 704a). In that case, the UE 105 may perform a Registration Update in order to receive a new RA that may allow the UE 105 to access the radio cell 704 or UE 105 may search for a new radio cell with a geodetic area of coverage that includes part of the RA 702.

In some implementations, an indication of a geodetic area of coverage for a radio cell 704 may comprise a definition of a static geodetic area such as a definition of a circle, ellipse or a polygon. In that case, a gNB 106/202/307 may need to periodically update the indication of the geodetic area of coverage for the radio cell 704 as the coverage area moves over the surface of the Earth (e.g. due to orbital motion of the associated SV 102/202/302) in order to include an indication of the most recent geodetic area of coverage for the radio cell 704. Additionally, a UE 105 may need to periodically receive the indication of the geodetic area of coverage for the radio cell 704 (e.g. in a SIB1 broadcast in the radio cell by a gNB 106/202/307) in order to verify whether the most recent geodetic area of coverage for the radio cell 704 still includes at least part of the RA 702. These actions by a gNB 106/202/307 and UE 105 may consume processing and signaling resources which may not be preferred.

Accordingly, in another implementation, an indication of a geodetic area of coverage for a radio cell 704 (e.g. broadcast by a gNB 106/202/307 in a SIB1 or SIB2 for the radio cell 704) may indicate current, future and possibly past geodetic areas of coverage for the radio cell 704. For example, a gNB 106/202/307 may have ephemeris (e.g. orbital) information for a satellite 102/202/302 that is supporting a radio cell 704 and information on past, current and future beam transmission(s) for the radio cell 704 at the satellite 102/202/302, which may include downward angles of transmission and angular width and spread of transmission. Such information may, for example, be provided to the gNB 106/202/307 using O&M. The gNB 106/202/307 may then be able to calculate the current and future geodetic areas of coverage for the radio cell 704. The gNB 106/202/703 may then include indications of a current and a number of future geodetic areas of coverage of the radio cell 704 in a SIB (e.g. SIB1 or SIB2) broadcast in the radio cell 704 by the gNB 106/202/307. These indications may be included in a variety of forms—e.g. by including a list of separate definitions of each geodetic area of coverage with a timestamp or time range for each geodetic area of coverage, or by including one geodetic area of coverage and an associated time stamp and an indication of a change, or a set of changes, to this geodetic area of coverage. An indication of a change may include an indication of: (i) a change of location (e.g. a change of latitude and longitude for some known or defined location point in the geodetic area of coverage such as the center of a circle, ellipse or regular polygon); (ii) an indication of a change in a shape and/or size of a geodetic area of coverage (e.g. an indication of an amount of expansion or contraction to the size of the geodetic area of coverage or an indication of a change in a size and shape of an ellipse via a change to a length of a semi-minor axis, change to a length of a semi-major axis, or a change of eccentricity); (iii) an indication of a rate of change of location (e.g. a “velocity” of a coverage area); and/or (iv) an indication of a rate of change to a shape and/or size of the geodetic area of coverage (e.g. a rate of expansion or contraction). A gNB 106/202/307 may then include these indications of the current and future geodetic areas of coverage of the radio cell 704 and may not need to update these indications except over longer periods (e.g. once every 5-15 minutes) which may simplify signaling and reduce processing time. Similarly, a UE 105 can receive the indications of the current and future geodetic areas of coverage of the radio cell 704 once only and use these indications to determine a current geodetic area of coverage of the radio cell 704 and predict future geodetic areas of coverage of the radio cell 704 without needing to receive the indication of the geodetic area of coverage of the radio cell 704 a second time (or at least for some long period like 5-15 minutes) while the UE 105 is accessing the radio cell 704.

In another implementation, a gNB 106/202/307 may broadcast an indication of a geodetic area of coverage of a radio cell 704 (e.g. in a SIB1 or SIB2), where the indication comprises ephemeris information for a satellite 102/202/302 that is supporting the radio cell 704 and information on directional transmission of the radio cell 704 from the satellite 102/302/302, which may include past, current and future beam transmission(s) for the radio cell 704 at the satellite 102/202/302, which may further include downward angles of transmission and angular width and spread of transmission. A UE 105 may then calculate a geodetic area of coverage of the radio cell 704 at a current time and for future times.

A Registration Update with a serving PLMN may have additional or alternative triggers. The UE 105, for example, may fail to update its geodetic location or may obtain an updated geodetic location that is too imprecise to determine whether the geodetic location is inside or outside the RA 702. If the UE 105 attempts but fails to update its geodetic location or to determine whether the geodetic location is inside or outside the RA 702 for a period of time that exceeds a threshold time period, the UE 105 may perform a Registration Update with the serving PLMN. The duration of the threshold time period, for example, may be based on a size of the RA 702 (e.g. may be based on the radius R or on an area of the RA 702), a last known geodetic location for the UE 105, a velocity of the UE 105, or a combination thereof. For example, if the RA 702 is very large, or the last know geodetic location of the UE 105 is near the center of the RA 702, or the UE 105 is moving slowly, the threshold time period may be longer than if the RA 702 is small, or the last know geodetic location of the UE 105 is near the edge of the RA 702, or the UE 105 is moving rapidly.

Additionally, Registration may be required periodically, e.g., where the UE 105 is triggered to Register after the expiration of a periodic time since the previous Registration.

As illustrated in FIG. 7A, the RA 702 may extend over a border with a different country. For example, the current geodetic location (x₁,y₁) of the UE 105 may be within country A, but the RA 702 defined as a circle with a radius R and centered on the geodetic location (x₁,y₁) may extend into country B. Thus, a portion 706 of the RA 702 may be in a different country. In some implementations, the UE 105 may be aware of the location of the border 708 between country A and country B, and when the updated geodetic location for the UE 105 indicates that the UE 105 is in a different country, e.g., country B as illustrated by the position of UE 105d, the UE 105 may perform a Registration with a new serving PLMN via the radio cell, even if the UE 105 is still inside the RA 702. During the Registration, a new RA based on the updated geodetic location may be provided to the UE 105, along with an appropriate serving PLMN for the country B.

In addition, the UE 105 may receive from the serving PLMN, an indication of one or more forbidden geodetic areas, illustrated as area 710. The forbidden geodetic area 710 is illustrated as a circle, but may have other geometric shapes and sizes, which may be defined using coordinates of vertices, distances from a center point, etc. The forbidden geodetic area 710 is an area where access to the serving PLMN is forbidden. Accordingly, when an updated geodetic location of the UE 105 indicates that the UE 105 is UE 105 within any of the one or more forbidden geodetic areas, e.g., forbidden geodetic area 710, the UE 105 will refrain from requesting service from the serving PLMN.

FIG. 7B shows another example of an RA 722, that is similar to the RA 702 shown in FIG. 7A. As illustrated in FIG. 7B, however, the RA 722 may be defined based on a current geodetic location (x₁,y₁) of the UE 105 and may be further defined based on geodetic areas that are to be excluded (or included) in the RA 722. Thus, the RA 722 may be based on an extended geodetic area, such as a full circle that includes a first portion covering all or part of a home country (e.g., country A) for the serving PLMN and a second portion covering one or more other countries (country B), where the RA 722 includes the first portion of the extended geodetic area and excludes the second portion of the extended geodetic area. For example, the extended geodetic area may be a full circle, as illustrated in FIG. 7A, that includes a first portion covering all or part of a home country (e.g., country A) for the serving PLMN and a second portion 706 covering one or more other countries (country B), and as illustrated in FIG. 7B, the RA 722 may be defined to include the first portion of the extended geodetic area and exclude the second portion of the extended geodetic area. The perimeter of the RA 722 that varies from the circle, e.g., along the border 708, may be defined as a sequence of geodetic locations (e.g. defined by location coordinates or using grid points from an array of grid points), e.g. along the border, or may be defined by existing configuration information for an international border in a UE 105.

FIG. 7C shows another example of an RA 752, that is similar to the RA 702 shown in FIG. 7A. As illustrated in FIG. 7C, however, the RA 752 is defined generally for the current geodetic location (x₁,y₁) of the UE 105 but is not centered on the current geodetic location (x₁,y₁) of the UE 105. As illustrated in FIG. 7C, the RA 752 is a circle with radius R that is centered on a second geodetic location (x₂,y₂) 754. The selection of the second geodetic location (x₂,y₂) and radius R may be based on the current geodetic location (x₁,y₁) of the UE 105 and other factors. For example, as illustrated in FIG. 7C, the second geodetic location (x₂,y₂) and radius R produces an RA 752 that includes the UE 105 and is completely inside country A, i.e., country B is excluded from RA 752. Accordingly, with use of RA 752, the UE 105 need not be aware of the location of the border 708 between country A and country B so long as the UE 105 is inside the RA 752. If UE 105 moves outside the RA 752, UE 105 can Register with a new serving PLMN if the UE 105 is aware of being located in a different country, e.g., country B, based on an updated geodetic location for the UE 105 indicating that the UE 105 is in the country B, e.g., as illustrated by the position of UE 105d. Alternatively, if UE 105 moves into country B (e.g. to the position 105d), UE 105 may access a radio cell which indicates support of serving PLMNs for country B but not for country A, in which case UE 105 can Register with a serving PLMN for country B without needing to determine an updated geodetic location for UE 105.

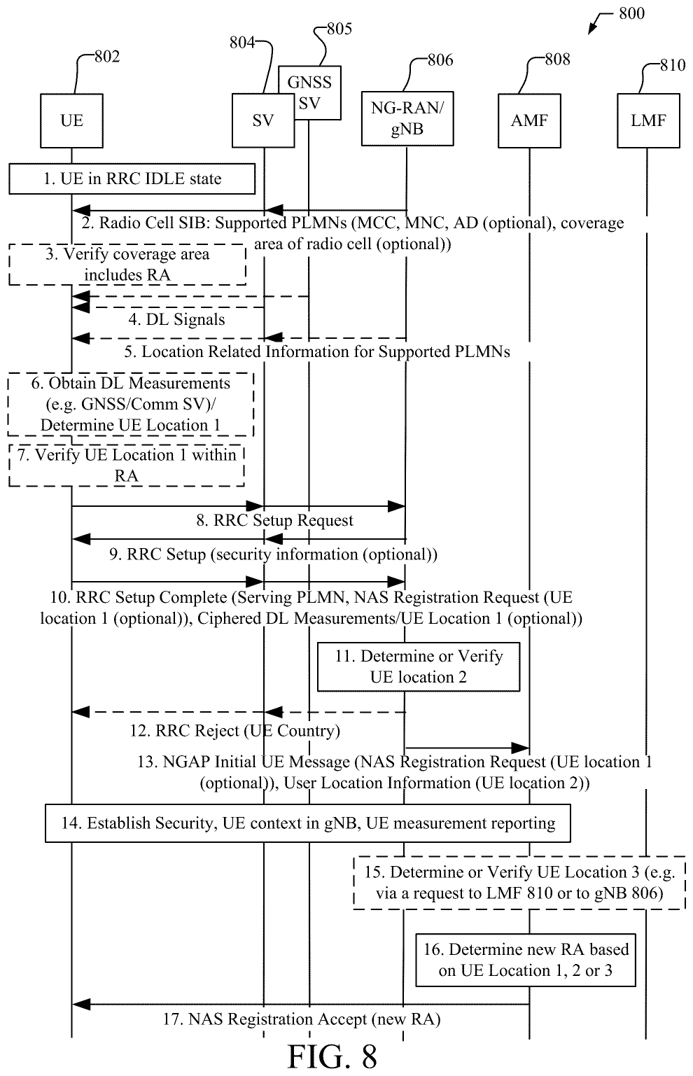

FIG. 8 shows a signaling flow 800 that illustrates various messages sent between components of a communication system in a procedure for PLMN access by a UE using an RA that is based on a geodetic location of the UE. The message flow 800 may be performed by entities in the network architectures 100, 200, or 300, in which the UE 802 corresponds to UE 105, SV 804 corresponds to SV 102, 202 or 302, GNSS SV 805 corresponds to SV 190, gNB 806 corresponds to gNB 106/202/307, AMF 808 corresponds to AMF 122, and LMF 810 corresponds to LMF 124. It should be understood that any one positioning technique or any combination of positioning techniques, may be used to obtain a geodetic location of the UE 105. It should be understood that the gNB 806 or an element of the gNB 806 may be included within the SV 804. For example, with an SV 202, a gNB 202 would be completely included within the SV 202 as described for FIG. 2. Alternatively, with an SV 302, an gNB 307 (also referred to as an gNB-CU 307) would be terrestrial and physically separate from the SV 302, but the SV 302 would include an gNB-DU 302 as described for FIG. 3.

At stage 1 in FIG. 8, the UE 802 is in an RRC IDLE state. The UE 802 may have already Registered with a serving PLMN and received an RA, as discussed at stage 17, and selected a radio cell to access the serving PLMN. Alternatively, the UE 802 may not have yet Registered with the serving PLMN, and thus, has not yet received an RA, or selected a radio cell to access the serving PLMN.

At stage 2, the gNB 806 periodically broadcasts (via an SV 804) indications of one or more supported PLMNs in each radio cell that is received by the UE 802. The UE 802 may detect radio cells from one or more radio beams transmitted by one or more SVs, including the SV 804. The gNB 806 may control SV 804 to broadcast radio cell system information blocks (SIBs) in one or more radio cells of the gNB 806. The SIBs may indicate one or more PLMNs (referred to as supported PLMNs) supported by the gNB 806 in each radio cell for the gNB 806. The supported PLMNs may each be identified (or indicated) in a SIB by a mobile country code (MCC) and a mobile network code (MNC), where the MCC indicates a country for each identified PLMN (i.e. a country to which each identified PLMN belongs), and where the MNC indicates a particular network (PLMN) associated with the MCC. The gNB 806 may optionally broadcast assistance data (AD) in each radio cell (e.g. may broadcast assistance data in a SIB or posSIB), such as assistance data that can be used by a UE 802 to help determine a geodetic location of the UE 802. The gNB 806 may optionally include a current geodetic area of coverage for the radio cell, e.g. such as the geodetic area of coverage 704 illustrated in FIG. 7A. The SIBs may include security information described below for stage 9 such as public key(s) and an indication of ciphering algorithm(s). If the UE 802 is not registered in any PLMN or is no longer able to access or no longer allowed to access a previous serving PLMN, the UE 802 may select a new serving PLMN from one of the supported PLMNs indicated in a radio cell at stage 2 and may perform a Registration in this serving PLMN via the radio cell as discussed at stages 8-17.

At stage 3, if the UE 802 is already accessing a radio cell for a serving PLMN and has Registered with the serving PLMN and received an RA, e.g., as discussed at stage 17, where the RA was based on a previously obtained geodetic location of the UE 802, the UE 802 may verify that the geodetic area of coverage of the radio cell that the UE 802 is accessing (if provided in stage 2) includes at least a portion of the RA, e.g., as discussed in FIG. 7A. If the geodetic area of coverage of the radio cell includes at least part of the RA, the UE 802 may determine that the radio cell provides coverage for the RA and re-Registration may not be required. On the other hand, if the geodetic area of coverage of the radio cell does not include at least part of the RA, the UE 802 may determine that the radio cell that it is accessing no longer provides coverage for the RA and a re-Registration may be performed via the radio cell, as discussed at stages 8-17. If the current geodetic area of coverage includes at least part of the RA, the UE 802 may camp on the radio cell or access the serving PLMN via the radio cell, but may not perform a Registration with the serving PLMN.

At stage 4, which is optional, the UE 802 may receive DL signals (e.g. DL PRS signals) from a plurality of satellites, which may include one or more of the communication SVs 804 and/or may receive DL signals from GNSS SVs 805.

At stage 5, which is optional, the UE 802 may receive location related information for the supported PLMNs broadcast (e.g. in one or more SIBs) in the one or more radio cells from the gNB 806 via the SV 804, such as information identifying a country or countries (e.g. information defining a border or borders of one or more countries).

At stage 6, which is optional, the UE 802 may obtain DL measurements from the DL signals received from the plurality of satellites at stage 4. The DL measurements, for example, may be GNSS measurements (e.g. GNSS pseudorange measurements) from one or more GNSS SVs 805 and/or measurements of characteristics of the DL signals from one or more communication SVs 804, such as a Reference Signal Received Power (RSRP), Reference Signal Received Quality (RSRQ), Rx-Tx, RTT, AOA. The UE 802 may further measure a Differential AOA (DAOA) or a Reference Signal Time Difference (RSTD) for DL signals received from one or more pairs of SVs 804. In some embodiments, the UE 802 may further determine a geodetic location of the UE 802 (referred to herein as a “first location” of the UE 802) based on the DL measurements and possibly based in addition on any assistance data received at stage 2.

At stage 7, if the UE 802 is already Registered with a serving PLMN and has already received an RA, e.g., as discussed at stage 17, where the RA was based on a previously obtained geodetic location of the UE 802, the UE 802 may verify that the first location of the UE 802 is inside the RA, e.g., as discussed in FIG. 7A. If the first location of the UE 802 is inside the RA, the UE 802 may determine that a radio cell that it is accessing provides coverage for the RA and re-Registration may not be required. On the other hand, if the first location of the UE 802 is outside the RA, the UE 802 may determine that a radio cell that it is accessing may no longer provide coverage for the RA and that re-Registration should be performed via the radio cell, as discussed at stages 8-17. If the first location of the UE 802 is inside the RA, but the UE 802 determines that the first location is also in a different country than is associated with the serving PLMN with which the UE 802 is Registered (e.g. based on any information provided at stage 5 if stage 5 occurs), the UE 802 may determine that a Registration is necessary with a new serving PLMN that supports the country in which the UE 802 is now located and may perform Registration in the new serving PLMN via a radio cell that supports the new serving PLMN as discussed at stages 8-17. This latter case may occur when an RA overlaps with another country as illustrated by the RA 702 in FIG. 7A when the area 706 in another country is not indicated by the serving PLMN.

Additionally, if the UE 802 has either failed to obtain an updated geodetic location (e.g. at stage 6) or has obtained an updated geodetic location (e.g. at stage 6) that has an accuracy that is insufficient to determine whether the updated geodetic location is inside or outside the RA (e.g., at stage 7) for a time period that exceeds a predetermined threshold time period, the UE 802 may determine that re-Registration should be performed via a radio cell that supports the serving PLMN, as discussed at stages 8-17. The threshold time period may be determined, for example, based on a size of the RA, a last known geodetic location for the UE 802, a velocity of the UE 802, or any combination thereof. Additionally, if the UE 802 determines a periodic time period since a last Registration with a serving PLMN has expired, the UE 802 may determine that re-Registration should be performed with the serving PLMN via a radio cell that supports the serving PLMN, as discussed at stages 8-17. The UE 802 may further determine whether its current geodetic location is within any of one or more forbidden geodetic areas (e.g. if received as discussed for stage 17 for a previous Registration), and if so, the UE 802 may refrain from requesting service from the serving PLMN.

Stages 8-17 are performed when, as discussed previously, UE 802 determines to perform a Registration in a serving PLMN (e.g. an existing serving PLMN for UE 802 or a new serving PLMN) via a radio cell that supports the serving PLMN (e.g. as indicated to the UE 802 at stage 2).

At stage 8, UE 802 may send an RRC Setup Request message to the gNB 806 that supports the radio cell via the SV 804 (e.g. after having performed a random access procedure to obtain initial access to the radio cell from the gNB 806).

At stage 9, the gNB 806 may return an RRC Setup message to the UE 802. The gNB 806 may optionally include security information in the RRC Setup message (e.g. if not provided at stage 2) that includes a public ciphering key and an indication of a ciphering algorithm.

At stage 10, UE 802 sends an RRC Setup Complete message to the gNB 806 and may include an indication (e.g. MCC and MNC) of the serving PLMN and a NAS Registration Request message. The UE 802 may also include in the RRC Setup Complete message any DL location measurements or the first location of the UE 802 if obtained at stage 6. The DL location measurements or the first location of UE 802 may be included as an RRC parameters or RRC parameters and in a confidential (or concealed) form by ciphering the DL location measurements or the first location of UE 802 using a public ciphering key and ciphering algorithm indicated at stage 2 or stage 9. The determination and encoding of the confidential location measurements or the first location of UE 802 may reuse some of the functionality used to support a Subscription Concealed Identifier (SUCI) as described in 3GPP Technical Specification (TS) 23.003. The ciphering of the DL location measurements or the first location of UE 802 may be needed because the RRC Setup Complete message and any included RRC parameters (except for the NAS Registration Request message) may not otherwise be ciphered as the UE 802 is not yet in an RRC Connected state.

In one implementation, UE 802 may include the first location of UE 802 (e.g. if obtained at stage 6) not directly as an RRC parameter in the RRC Setup Complete message but instead in the NAS Registration Request message. In this implementation, the NAS Registration Request message is typically ciphered at the NAS level if the UE was previously registered with the serving PLMN which can avoid the need for any additional ciphering of the first location of UE 802.

At stage 11, the gNB 806, or an embedded or attached Location Management Component (LMC), may determine or verify a geodetic location for the UE 802, referred to as the “second location” of the UE 802, e.g. using any DL location measurements or the first location of the UE 802 received at stage 10. The second location may be the same as or slightly different than the first location when both locations are present. The gNB 806 (or LMC), for example, may decipher the DL location measurements or the UE 802 location sent at stage 10 based on a ciphering key and ciphering algorithm indicated at stage 2 or stage 9. For example, the gNB 806 (or LMC) may use a private ciphering key that corresponds to a public ciphering key sent at stage 2 or stage 9, to decipher the ciphered DL location measurements or ciphered UE 802 location based on a public key-private key ciphering algorithm (e.g. the RCA algorithm) indicated at stage 2 or stage 9.

The gNB 806 may use any DL location measurements that the UE 802 sent at stage 10, which may include GNSS measurements and/or characteristics of received signals, e.g., RSRP, RSRQ, Rx-Tx, AOA, RTT, RSTD, or DAOA, measured by the UE 802 at stage 6 to determine the second location of the UE 802, e.g., using A-GNSS, ECID, RTT, TDOA, AOA, or other positioning techniques. The country in which the UE 802 is located may also be determined based on the second location of the UE 802. The gNB 806 (or LMC) may determine the second location and country of the UE 802 using other techniques. In some implementations, measured characteristics of the serving radio cell, e.g. RSRP, RSRQ, Rx-Tx, AOA or some combination thereof, measured by the UE 802 at stage 6, may be used to refine the second location of the UE 802. In some implementations, the determination of the second location be performed by a Location Management Component (LMC) which may be part of, attached to, or reachable from gNB 806. In some implementations, gNB 806 and/or SV 804 may obtain uplink (UL) measurements of signals transmitted by UE 802 (e.g. signals transmitted by UE 802 as part of stage 8 or 10), such as UL measurements of RSRP, RSRQ, Rx-Tx and/or AOA which may be used to determine or help determine the second location of UE 802 at stage 11. In some implementations, gNB 806 may use knowledge of a geodetic coverage area for the radio cell used by the UE 802 at stages 8-10 or a geodetic coverage area of a radio beam for the radio cell used by the UE 802 to determine or help determine the second location of UE 802 at stage 11. The gNB 806 may map the second location to a country and verify the country is supported by the gNB 806 and by the serving PLMN indicated at stage 10.

In some implementations, the second location of the UE 802 may be mapped by gNB 806 to a fixed cell, e.g. a fixed cell as described for FIGS. 5 and 6, by determining a fixed cell in which the second location is totally or, if the second location has an uncertainty area or volume, at least partially included. An identity (e.g. a cell ID or cell global ID) for the fixed cell may then be used as the second location and may be treated by AMF 808 as indicating that the UE 802 is located somewhere within the fixed geographic area or volume of the fixed cell.

At stage 12, if a country determined at stage 11 is not supported by the gNB 806 or by the serving PLMN, the gNB 806 may return an RRC Reject message to UE 802. The RRC Reject message may indicate the country (e.g. using an MCC) that the UE 802 is located in as determined at stage 11 or may simply indicate that the UE 802 is not located in a country for the serving PLMN. If an RRC Reject message is received, the UE 802 may restart the procedure at stage 8 to register in a new serving PLMN that supports the country in which the UE 802 is located.

At stage 13, if the UE 802 is in a correct country or may be in the correct country, the gNB 806 sends a Next Generation (NG) Application Protocol (NGAP) message (e.g. an NGAP Initial UE message) to an entity in the selected PLMN, e.g., AMF 808. In some implementations, the NGAP message may include an indication that the gNB 806 has verified the UE 802 location and/or country. The NGAP message may include user location information, which can include the second location for UE 802 if determined at stage 11. The NGAP message further includes the NAS Registration Request message received at stage 10, which, as discussed earlier, can include the first location of UE 802.

At stage 14, AMF 808 may instigate authentication of UE 802 and establish a security association with UE 802 at the NAS level. AMF 808 may also establish context information for UE 802 in gNB 806 (e.g. AMF 808 may send an NGAP Initial Context Setup Request to gNB 806 to establish context information for UE 802 including a security context). GNB 806 may then activate security with the UE 802 at an RRC level. GNB 806 may also configure measurements in the UE 802 (e.g., measurements of RSRP and RSRQ for the currently used radio cell and other radio cells supported by other SVs 102/202/302, not shown in FIG. 8) which are periodically reported back to gNB 806 by UE 802 and can be used to support handover as well as to help determine a more accurate geodetic location of UE 802.

At stage 15, which may be optional, the AMF 808 may determine or verify the current geodetic location for the UE 802, referred to as the “third location” of the UE 802, using any of the first location of the UE 802 and/or the second location of the UE 802 if received at stage 13. In some implementations (and not shown in FIG. 8), the AMF 808 may send a request to LMF 810 for the third location of UE 802. LMF 810 may then determine the third location (e.g. by requesting UL location measurements of UE 802 from gNB 806 and/or DL location measurements from UE 802); and LMF 810 may then determine the third location of UE 802 and return this to AMF 810. In some implementations, the AMF 808 may also or instead send a request to gNB 806 (not shown in FIG. 8) for a geodetic location of UE 802 that may be more accurate than the second location of UE 802, if included at stage 13. GNB 806 may then determine the third location (e.g. as described in stage 14) and return this to AMF 808 (not shown in FIG. 8). The third location may be the same as or slightly different than the first location and/or the second location when either or both of these are present. The first location, the second location and the third location, or any combination thereof, may be sent to or obtained by the AMF 808. If the NGAP message received at stage 13 indicates that the UE 802 location and/or country are fully verified by the gNB 806, the AMF 808 may not determine the third location at stage 15. However, if the NGAP message received at stage 13 indicates that the UE 802 location and/or country are not fully verified by the gNB 806, the AMF 808 may typically determine the third location at stage 15.

At stage 16, the AMF may determine a new RA for UE 802 based on a current geodetic location for UE 802, e.g., based on the first location if received at stage 13, the second location if received at stage 13, or the third location if determined at stage 15. The RA may be determined by the AMF 808, e.g., as illustrated in FIG. 7A, 7B, or 7C. For example, the RA may not be preconfigured but may be defined based on a distance from the current geodetic location of UE 802, e.g., based on the current geodetic location, or based on another location that places the current geodetic location of UE 802 within the RA. For example, the RA may be a circle centered on the current geodetic location of UE 802 or centered on another location. The RA may be based on an extended geodetic area that includes a first portion covering all or part of a home country for the serving PLMN and a second portion covering one or more other countries, where the RA includes the first portion of the extended geodetic area and excludes the second portion of the extended geodetic area. The indication of the RA provided to the UE 802 (as described below for stage 17) may exclude the second portion, or the UE 802 may determine the RA based on information configured in the UE 802 concerning the border of the home country.

At stage 17, the AMF 808 returns a NAS Registration Accept message to UE 802 via gNB 806 and SV 804. The NAS Registration Accept message includes the RA for the UE 802 as determined by the AMF 808 at stage 16. If the UE 802 has already registered with the serving PLMN and received an RA previously, the RA received in stage 17 is a second RA that replaces the previous RA. The AMF 808 may also include an indication of one or more forbidden geodetic areas (e.g. defined as polygons, circles or ellipses) in the NAS Registration Accept at stage 17, in which UE 802 is not allowed to request or receive service from the serving PLMN.

In a variant of the signaling flow 800 in FIG. 8, the UE 802 may start out in an RRC CONNECTED state at stage 1. In that case, some of stages 2-17 may be skipped or modified as follows. Stage 2 may be skipped; stages 3-7 may be performed as described previously; the UE 802 may determine whether to perform a Registration as described previously for stages 3-7. If UE 802 determines to perform a Registration, stages 8 and 9 may be skipped and UE 802 may send a NAS Registration Request message to gNB 806 at stage 10 by including this message in an RRC UL Information Transfer message (rather than in an RRC Setup Complete message), where the RRC UL Information Transfer message may optionally include the first location. Stage 11 may optionally be performed as described above. Stage 12 may typically be omitted. GNB 806 may send the NAS Registration Request message to AMF 808 at stage 13 in an NGAP Uplink NAS Transport message and may further include in the NGAP UL NAS Transport message user location information which may include the second location of UE 802 if obtained by gNB 806 at stage 11. Stage 14 may be skipped (as the UE 802 is already in a CONNECTED state). Stages 15-17 may be performed as described previously.

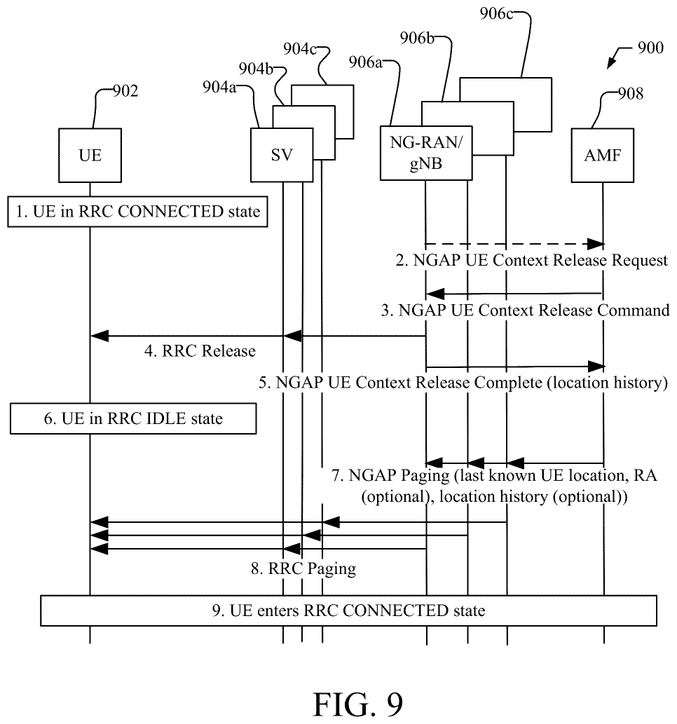

FIG. 9 shows a signaling flow 900 that illustrates various messages sent between components of a communication system in a procedure for paging a UE using geodetic location information of the UE (e.g. an RA). The message flow 900 may be performed by entities in the network architectures 100, 200, or 300, in which the UE 902 corresponds to UE 105, SVs 904a, 904b, 904c (sometimes collectively referred to as SVs 904) each correspond to an SV 102, 202 or 302, gNBs 906a, 906b, 906c (sometimes collectively referred to as gNBs 906) each correspond to a gNB 106/202/307, and AMF 908 corresponds to AMF 122. It should be understood that the gNBs 906 or an element of the gNBs 906 may be included within the SVs 904. For example, with an SV 202, a gNB 202 would be completely included within the SV 202 as described for FIG. 2. Alternatively, with an SV 302, a gNB 307 (also referred to as an gNB-CU 307) would be terrestrial and physically separate from the SV 302, but the SV 302 would include an gNB-DU 302 as described for FIG. 3.

At stage 1 in FIG. 9, the UE 902 is assumed to be in an RRC and CM (Connection Management) CONNECTED state and has a signaling connection to the gNB 906a via the SV 904a and a signaling connection to the AMF 908 via the gNB 906a. For example, if the UE 902 corresponds to the UE 802 in FIG. 8, the UE 902 could have performed the registration procedure described for FIG. 8, after which the UE 902 (corresponding to UE 802 in FIG. 8) would be in the RRC and CM CONNECTED state.

At stage 2, the gNB 906a may optionally determine to release the signaling connection for the UE 902. For example, the gNB 906a may determine that the UE 902 has been idle, with no UL or DL signaling or data having been sent by the UE 902 or to the UE 902 for some threshold interval (e.g. 10 seconds), and that signaling resources for UE 902 no longer need to be reserved. The gNB 906a may then send an NGAP Context Release Request message to AMF 908 requesting AMF 908 to release the signaling connection to UE 902.

At stage 3 and in response to stage 2, if stage 2 occurs, or for other reasons if stage 2 does not occur (e.g. if AMF 908 determines that UE 902 no longer has any Protocol Data Unit (PDU) sessions for sending and receiving data and voice), AMF 908 sends an NGAP UE Context Release Command to gNB 906a requesting gNB 906a to release the signaling connection to UE 902.

At stage 4, gNB 906a sends an RRC Release message to UE 902 to release the signaling connection for UE 902.

At stage 5, gNB 906a returns an NGAP UE Context Release Complete message to AMF 908. GNB 906a may include in this message location history information for the UE 902. For example, the location history information may include one or more recent geodetic locations for UE 902, as obtained by gNB 906a and/or by previous serving gNBs 906 for UE 902 and forwarded to gNB 906a when UE 902 was handed over to gNB 906a. A geodetic location may be obtained, for example, as described for stage 11 and/or stage 14 of FIG. 8. For each geodetic location of UE 902 included at stage 5, gNB 906a may further include a time of applicability and/or a time period (e.g. start time and end time) during which UE 902 was at this geodetic location. For example, if gNB 906a or a previous serving gNB 906 for UE 902 determines a current geodetic location for UE 902 periodically while UE 902 us in an RRC and CM CONNECTED state, the gNB 906a or previous gNB 906 may combine geodetic locations that are very close to one another (e.g. within 100 meters or within 1 kilometer of one another) and treat the separate geodetic locations as being the same geodetic location. The gNB 906a or previous gNB 906 may then record the overall time period during which the UE 902 was at this same geodetic location. This may reduce the number of separate geodetic locations which need to be stored by gNB 906a or by a previous serving gNB 906 and included at stage 5. GNB 906a may also obtain a current geodetic location for UE 902 (e.g. as described for stage 11 or stage 14 of FIG. 8) or may retrieve a most recent previous geodetic location for UE 902 stored at gNB 906a and may include the geodetic location in the NGAP UE Context Release Command message. AMF 908 may then store the location history information and/or geodetic location as received at stage 5.

At stage 6, UE 902 is in an RRC IDLE state as a consequence of stages 2-5.

At stage 7, AMF 908 may need to establish a new signaling connection to UE 902. For example, the new signaling connection may be needed in order to establish an incoming voice call or incoming data session to UE 902, or to send incoming data to UE 902, or to determine a location for UE 902 at the request of an external client (e.g. external client 140). In order to establish the new signaling connection to UE 902, AMF 908, sends an NGAP Paging message to one or more gNBs 906. The gNBs 906 may include the last serving gNB 906a and/or other gNBs 906. The NGAP Paging message sent to each gNB 906 may include geodetic location information for the UE 902. The geodetic location information may include: (i) a last known geodetic location for the UE 902 (e.g. as received by the AMF 908 at stage 5); (ii) the most recent RA for the UE 902 (e.g. sent to UE 902 as described for stage 17 of FIG. 8); and/or (iii) location history information for UE 902 (e.g. as obtained at stage 5). However, when NGAP Paging messages are sent to more than one gNB 906, the geodetic information included in each NGAP Paging message for each gNB 906 may optionally include only geodetic location information applicable to a coverage area of the gNB 906 to which the NGAP Paging message is sent.

At stage 8, each of the one or more gNBs 906 broadcasts an RRC Paging message, via associated SVs 904, in one or more radio cells controlled by the each gNB 906 that have radio coverage of at least some geodetic location indicated in the geodetic information received at stage 7. For example, a gNB 906 may broadcast an RRC Paging message in a radio cell controlled by the gNB 906 if a last known geodetic location for the UE 902 included at stage 7 is in a coverage area of the radio cell, or if the most recent RA included at stage 7 overlaps with at least part of the current coverage area of the radio cell, or if the location history information for UE 902 included at stage 7 includes a geodetic location that is within or partly within the current coverage area of the radio cell.

In some implementations, paging may be optimized to minimize the number of radio cells in which an RRC Paging message is broadcast subject to a high likelihood that the UE 902 will be accessing one of these radio cells and thereby receive the RRC Paging message. As an example of optimization, a gNB 906 may only broadcast an RRC Paging message in a radio cell at stage 8 if the radio cell coverage area includes a recent geodetic location of the UE 902 (e.g. a geodetic location of the UE 802 that is less than one hour old or that is more recent than any other geodetic location of the UE 902) or includes a geodetic location of the UE 902 in which the UE 902 was located for a longer duration than other geodetic locations for the UE 902.

In some implementations, paging may be optimized to maximize the probability that UE 902 will receive the RRC Paging message. For example, the one or more gNBs 906 may broadcast the RRC Paging message at stage 8, via associated SVs 904, in all radio cells controlled by the one or more gNBs 906 that have radio coverage of at least some of the RA. If UE 902 only accesses radio cells which have radio coverage of at least some of the RA as discussed for FIGS. 7A-7C and stages 3 and 7 of FIG. 8, then UE 902 may normally receive the RRC Paging message with these implementations.

At stage 9, UE 902 may receive one of the RRC Paging messages broadcast at stage 8 and may request the establishment of an RRC Connection with a gNB 906 and AMF 908—e.g. by performing stages similar to or the same as stages 8-10 in FIG. 8. AMF 908 may then establish an incoming voice call or data session to UE 902 or enable transfer of incoming data etc.

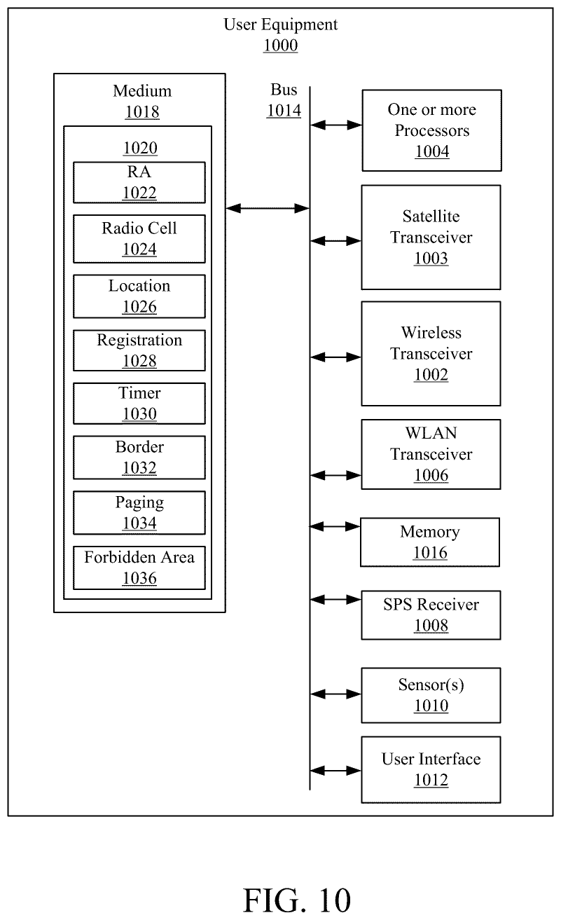

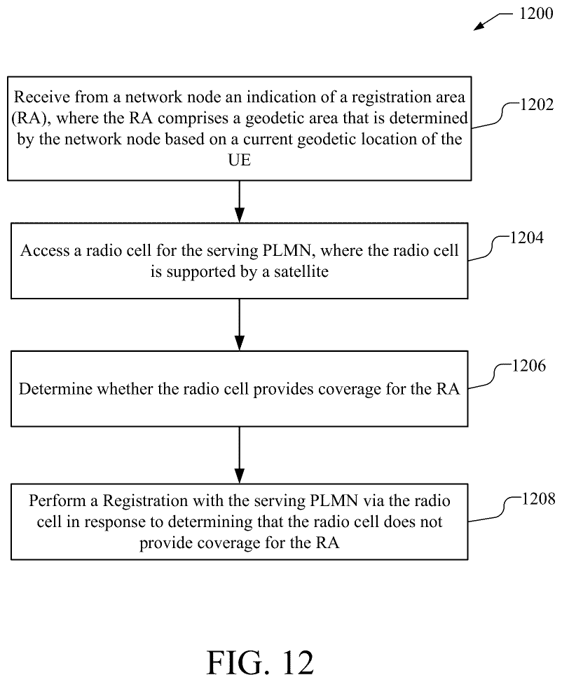

FIG. 10 is a diagram illustrating an example of a hardware implementation of UE 1000, such as UE 105 shown in FIGS. 1, 2, and 3, UE 802 shown in FIG. 8, and UE 902 shown in FIG. 9. The UE 1000 may be configured to perform the signal flows in FIGS. 8 and 9 and the procedure described later in FIG. 12. The UE 1000 may include, e.g., hardware components such as a satellite transceiver 1003 to wirelessly communicate with an SV 102/202/302 via a wireless antenna (not shown in FIG. 10), e.g., as shown in FIGS. 1, 2, and 3. The UE 1000 may further include wireless transceiver 1002 to wirelessly communicate with terrestrial base stations in an NG-RAN 112 via a wireless antenna (not shown in FIG. 10), e.g., base stations such as a gNB or an ng-eNB. The UE 1000 may also include additional transceivers, such a wireless local area network (WLAN) transceiver 1006, as well as an SPS receiver 1008 for receiving and measuring signals from SPS SVs 190 (shown in FIGS. 1, 2, and 3) via a wireless antenna (not shown in FIG. 10). In some implementations, the UE 1000 may receive data from a satellite, e.g., via satellite transceiver 1003, and may respond to a terrestrial base station, e.g., via wireless transceiver 1002, or via WLAN transceiver 1006. Thus, UE 1000 may include one or more transmitters, one or more receivers or both, and these may be integrated, discrete, or a combination of both. The UE 1000 may further include one or more sensors 1010, such as cameras, accelerometers, gyroscopes, electronic compass, magnetometer, barometer, etc. The UE 1000 may further include a user interface 1012 that may include e.g., a display, a keypad or other input device, such as virtual keypad on the display, through which a user may interface with the UE 1000. The UE 1000 further includes one or more processors 1004, memory 1016, and non-transitory computer readable medium 1018, which may be coupled together with bus 1014. The one or more processors 1004 and other components of the UE 1000 may similarly be coupled together with bus 1014, a separate bus, or may be directly connected together or coupled using a combination of the foregoing.

The one or more processors 1004 may be implemented using a combination of hardware, firmware, and software. For example, the one or more processors 1004 may be configured to perform the functions discussed herein by implementing one or more instructions or program code 1020 on a non-transitory computer readable medium, such as medium 1018 and/or memory 1016. In some embodiments, the one or more processors 1004 may represent one or more circuits configurable to perform at least a portion of a data signal computing procedure or process related to the operation of UE 1000.

The medium 1018 and/or memory 1016 may store instructions or program code 1020 that contain executable code or software instructions that when executed by the one or more processors 1004 cause the one or more processors 1004 to operate as a special purpose computer programmed to perform the techniques disclosed herein (e.g. such as the signal flows of FIGS. 8 and 9 and the process flow 1200 of FIG. 12). As illustrated in UE 1000, the medium 1018 and/or memory 1016 may include one or more components or modules that may be implemented by the one or more processors 1004 to perform the methodologies described herein. While the components or modules are illustrated as software in medium 1018 that is executable by the one or more processors 1004, it should be understood that the components or modules may be stored in memory 1016 or may be dedicated hardware either in the one or more processors 1004 or off the processors.

A number of software modules and data tables may reside in the medium 1018 and/or memory 1016 and be utilized by the one or more processors 1004 in order to manage both communications and the functionality described herein. It should be appreciated that the organization of the contents of the medium 1018 and/or memory 1016 as shown in UE 1000 is merely exemplary, and as such the functionality of the modules and/or data structures may be combined, separated, and/or be structured in different ways depending upon the implementation of the UE 1000. While the components or modules are illustrated as software in medium 1018 and/or memory 1016 that is executable by the one or more processors 1004, it should be understood that the components or modules may be firmware or dedicated hardware either in the one or more processors 1004 or off the processors.

As illustrated, the program code 1020 stored on medium 1018 and/or memory 1016 may include an RA module 1022 that when implemented by the one or more processors 1004 configures the one or more processors 1004 to receive an indication of RA from a network node, such as an AMF, via the satellite transceiver 1003. The one or more processors 1004 may be configured to determine whether a radio cell provides coverage of the radio cell, e.g., by determining whether a geodetic location of the UE obtained while the UE is accessing the radio cell is inside or outside the RA, e.g., where if the location of the UE is outside the RA, the radio cell is determined to not provide coverage of the RA and Registration with the serving PLMN may be performed. The one or more processors 1004 may be configured to determine whether a radio cell provides coverage of the radio cell, e.g., by determining if the geodetic area of coverage of the radio cell, e.g., received in a radio cell SIB, includes at least part of the RA, where the radio cell is determined to not provide coverage of the RA if the geodetic area of coverage of the radio cell does not include at least part of the RA and Registration with the serving PLMN may be performed. The one or more processors 1004 may be configured to receive a distance from the UE location or from another location to define the RA or to receive an indication of the extended geodetic area where the RA is determined based on the indication of the extended geodetic area and information configured in the UE concerning a border of the home country. The one or more processors 1004 may be configured to replace an initial RA with new RAs received from the network node.

The program code 1020 stored on medium 1018 and/or memory 1016 may include a radio cell module 1024 that when implemented by the one or more processors 1004 configures the one or more processors 1004 to receive information related to satellite radio cells, select a radio cell, camp on the radio cell or access a serving PLMN via the radio cell, via the satellite transceiver 1003. For example, the one or more processors 1004 may be configured to receive an indication of a geodetic area of coverage for the radio cell, e.g., in a radio cell SIB, via the satellite transceiver 1003. The indication of the geodetic area of coverage for the radio cell, for example, may include an indication of a current geodetic area of coverage for the radio cell, one or more indications of future geodetic areas of coverage for the radio cell or any combination thereof. The indication of the future geodetic area of coverage for the radio cell, for example, may include an indication of a change in location of the geodetic area of coverage of the radio cell, an indication of a change in shape of the geodetic area of coverage of the radio cell, an indication of a change in a size of the geodetic area of coverage of the radio cell, an indication of a rate of change in the location of the geodetic area of coverage for the radio cell, an indication of a rate of change in the shape of the geodetic area of coverage for the radio cell, an indication of a rate of change in a size of the geodetic area of coverage of the radio cell, or any combination thereof. The indication of the future geodetic area of coverage for the radio cell may include an indication of an orbital motion of the satellite and an indication of directional transmission of the radio cell from the satellite.

As illustrated, the program code 1020 stored on medium 1018 and/or memory 1016 may include a location module 1026 that when implemented by the one or more processors 1004 configures the one or more processors 1004 to obtain geodetic locations for the UE and to update the geodetic location over time. For example, the one or more processors 1004 may be configured to generate measurements of DL signals received from a plurality of satellites, e.g., via the SPS receiver 1008 and/or the satellite transceiver 1003. By way of example, the measurements may be or may include measurements of GNSS pseudorange, RSRP, RSRQ, Rx-Tx, AoA from one or more SVs, and RSTD or DAOA from one or more pairs of SVs, or sensor measurements, e.g., for dead reckoning. The location module 1026 may further configure the one or more processors 1004 to perform GNSS measurements via SPS receiver 1008, for A-GNSS positioning. The one or more processors 1004 may be configured to determine the geodetic location from the location measurements or may send the location measurements to a network node, which may determine the geodetic location.

As illustrated, the program code 1020 stored on medium 1018 and/or memory 1016 may include a registration module 1028 that when implemented by the one or more processors 1004 configures the one or more processors 1004 to perform a registration with the serving PLMN via the satellite transceiver 1003. The one or more processors 1004, for example, may be configured to perform registration if the radio cell is determined to not provide coverage for the RA or after an expiration of a timer, e.g., failing to obtain the additional updated geodetic location or failing to determine whether the additional updated geodetic location is inside or outside the RA for a predetermined threshold time period, or exceeding a predetermined amount of time since the last registration. The one or more processors 1004 may be configured to send, via the satellite transceiver 1003, a Registration Request message to a serving base station, and to receive, via the satellite transceiver 1003, a Registration Accept message from a network node that includes an indication of the RA. The one or more processors 1004 may be configured to include current location information for the UE in the Registration Request message.

As illustrated, the program code 1020 stored on medium 1018 and/or memory 1016 may include a timer module 1030 that when implemented by the one or more processors 1004 configures the one or more processors 1004 to monitor the time period since the last registration or to monitor the time period to during which the UE fails to obtain the additional updated geodetic location or fails to determine whether the additional updated geodetic location is inside or outside the RA and to initiate registration after exceeding a threshold time period. For example, the duration of the threshold time period may be based on at least one of a size of the RA, a last known geodetic location for the UE and a velocity of the UE, or any combination thereof.

As illustrated, the program code 1020 stored on medium 1018 and/or memory 1016 may include a border module 1032 that when implemented by the one or more processors 1004 configures the one or more processors 1004 to monitor information configured in the UE concerning a border of the home country, e.g., stored in memory 1016, and to use the border of the home country to assist in determining the RA.

As illustrated, the program code 1020 stored on medium 1018 and/or memory 1016 may include a paging module 1034 that when implemented by the one or more processors 1004 configures the one or more processors 1004 to receive paging messages from the serving PLMN via the satellite transceiver 1003.

As illustrated, the program code 1020 stored on medium 1018 and/or memory 1016 may include a forbidden area module 1036 that when implemented by the one or more processors 1004 configures the one or more processors 1004 to receive an indication of one or more forbidden geodetic areas from the serving PLMN via the satellite transceiver 1003. The one or more processors 1004 may be configured to determine whether the location of the UE is within any of the one or more forbidden geodetic areas and to refrain from requesting service from the serving PLMN when the updated geodetic location is determined to be within any of the one or more forbidden geodetic areas.

The methodologies described herein may be implemented by various means depending upon the application. For example, these methodologies may be implemented in hardware, firmware, software, or any combination thereof. For a hardware implementation, the one or more processors 1004 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For an implementation of UE 1000 involving firmware and/or software, the methodologies may be implemented with modules (e.g., procedures, functions, and so on) that perform the separate functions described herein. Any machine-readable medium tangibly embodying instructions may be used in implementing the methodologies described herein. For example, software codes may be stored in a medium 1018 or memory 1016 and executed by one or more processors 1004, causing the one or more processors 1004 to operate as a special purpose computer programmed to perform the techniques disclosed herein. Memory may be implemented within the one or processors 1004 or external to the one or more processors 1004. As used herein the term “memory” refers to any type of long term, short term, volatile, nonvolatile, or other memory and is not to be limited to any particular type of memory or number of memories, or type of media upon which memory is stored.

If implemented in firmware and/or software, the functions performed by UE 1000 may be stored as one or more instructions or code on a non-transitory computer-readable storage medium such as medium 1018 or memory 1016. Examples of storage media include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable storage medium, instructions and/or data for UE 1000 may be provided as signals on transmission media included in a communication apparatus. For example, a communication apparatus comprising part or all of UE 1000 may include a transceiver having signals indicative of instructions and data. The instructions and data are stored on non-transitory computer readable medium 1018 or memory 1016, and are configured to cause the one or more processors 1004 to operate as a special purpose computer programmed to perform the techniques disclosed herein. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

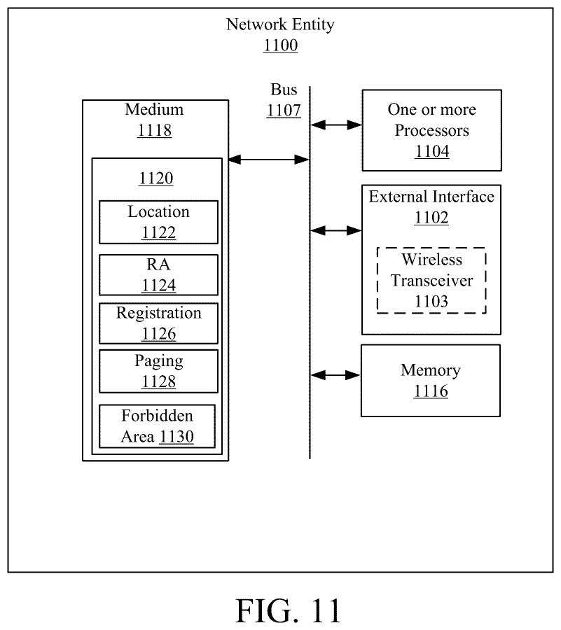

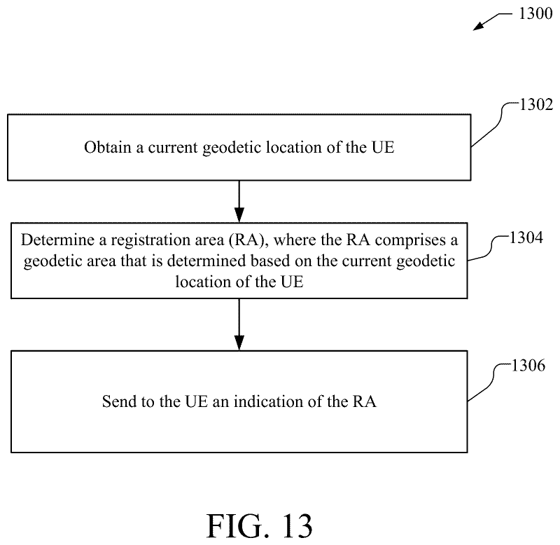

FIG. 11 is a diagram illustrating an example of a hardware implementation of a network entity 1100 that may be configured to perform the signal flows of FIGS. 8 and 9 and/or the procedure 1300 described later in FIG. 13. The network entity 1100 may be an entity in a PLMN, such as the AMF 122 shown in FIGS. 1, 2, and 3, the AMF 808 shown in FIG. 8, the AMF 902 shown in FIG. 9, or may be a base station, e.g., in an NG-RAN, such as a gNB 106, 202 or 307 in FIGS. 1 to 3). The network entity 1100 includes, e.g., hardware components such as an external interface 1102 configured to communicate with other network components in the PLMN, e.g., if the network entity 1100 is a core network entity, such as an AMF. In some implementations, e.g., if the network entity 1100 is a base station, the external interface 1102 may be configured to communicate with network components in the PLMN and as illustrated with broken lines may additionally include a wireless transceiver 1103 and one or more antennas (not shown) to wirelessly communicate with satellites and/or UEs, as discussed in FIGS. 1 to 3. The network entity 1100 includes one or more processors 1104, memory 1116, and non-transitory computer readable medium 1118, which may be coupled together with bus 1107.

The one or more processors 1104 may be implemented using a combination of hardware, firmware, and software. For example, the one or more processors 1104 may be configured to perform the functions discussed herein by implementing one or more instructions or program code 1120 on a non-transitory computer readable medium, such as medium 1118 and/or memory 1116. In some embodiments, the one or more processors 1104 may represent one or more circuits configurable to perform at least a portion of a data signal computing procedure or process related to the operation of network entity 1100.

The medium 1118 and/or memory 1116 may store instructions or program code 1120 that contain executable code or software instructions that when executed by the one or more processors 1104 cause the one or more processors 1104 to operate as a special purpose computer programmed to perform the techniques disclosed herein (e.g. such as the signal flows of FIGS. 8 and 9 and the process flow 1300 of FIG. 13). As illustrated in network entity 1100, the medium 1118 and/or memory 1116 may include one or more components or modules that may be implemented by the one or more processors 1104 to perform the methodologies described herein. While the components or modules are illustrated as software in medium 1118 that is executable by the one or more processors 1104, it should be understood that the components or modules may be stored in memory 1116 or may be dedicated hardware either in the one or more processors 1104 or off the processors.

A number of software modules and data tables may reside in the medium 1118 and/or memory 1116 and be utilized by the one or more processors 1104 in order to manage both communications and the functionality described herein. It should be appreciated that the organization of the contents of the medium 1118 and/or memory 1116 as shown in network entity 1100 is merely exemplary, and as such the functionality of the modules and/or data structures may be combined, separated, and/or be structured in different ways depending upon the implementation of the network entity 1100. While the components or modules are illustrated as software in medium 1118 and/or memory 1116 that is executable by the one or more processors 1104, it should be understood that the components or modules may be firmware or dedicated hardware either in the one or more processors 1104 or off the processors.

As illustrated, the program code 1120 stored on medium 1118 and/or memory 1116 may include a location module 1122 that when implemented by the one or more processors 1104 configures the one or more processors 1104 to obtain a current geodetic location of the UE, via the external interface 1102. For example, the one or more processors 1104 may be configured to receive the geodetic location of the UE from the UE or gNB, via the external interface 1102. The one or more processors 1104 may be configured to receive the location information, such as location measurements from the UE, via the external interface 1102, and to provide the location measurements to a network entity, such as an LMF, that returns the geodetic location of the UE, via the external interface 1102.

The program code 1120 stored on medium 1118 and/or memory 1116 may include an RA module 1124 that when implemented by the one or more processors 1104 configures the one or more processors 1104 to determine the RA based on the geodetic area of the UE and to provide an indication of the RA to the UE, via the external interface 1102. The one or more processors 1104, for example, may determine the RA based on a geometric shape, such as a circle, that is centered on the geodetic location of the UE or centered on another location but that includes the geodetic location of the UE. The size of the RA, for example, may be based on a radius of the circle. The one or more processors 1104 may be configured to determine the RA as an extended geodetic area with a first portion that includes all or part of a home country for the serving PLMN and a second portion that cover one or more other countries, and the RA may include the first portion of the extended geodetic area and excludes the second portion of the extended geodetic area. The one or more processors 1104 may be configured to send an indication of the extended geodetic area to the UE, via the external interface 1102, wherein the RA is determined at the UE based on the indication of the extended geodetic area and information configured in the UE concerning a border of the home country, or may send an indication of the extended geodetic area that excludes the second portion.

The program code 1120 stored on medium 1118 and/or memory 1116 may include a registration module 1126 that when implemented by the one or more processors 1104 configures the one or more processors 1104 to perform a Registration for the UE with the serving PLMN via the radio cell, via the external interface 1102, e.g., when the UE determines the radio cell does not provide coverage for the RA. For example, the one or more processors 1104 may be configured to receive a Registration Request message for the UE forwarded by a serving base station, via the external interface 1102, and to send a Registration Accept message to the UE via the serving base station, via the external interface 1102, where the Registration Accept message comprises the indication of the RA. The Registration Request message, for example, may include the current location of the UE.

The program code 1120 stored on medium 1118 and/or memory 1116 may include a paging module 1128 that when implemented by the one or more processors 1104 configures the one or more processors 1104 to send a Paging message for the UE to a base station, via the external interface 1102, based on the location of the UE and/or based on the RA. The paging message, for example, may be sent via all radio cells with coverage of at least part of the RA. The Paging message may include geodetic location information for the UE, where the base station may send a second Paging message to the UE via a satellite in at least one radio cell based on the radio cell having coverage for one or more locations indicated in the geodetic location information. The one or more processors 1104 may be further configured to receive an indication, e.g., from a serving base station, via the external interface 1102, that the UE has entered an Idle state, where the indication may include at least one of the last known geodetic location for the UE and the location history information for the UE.

The program code 1120 stored on medium 1118 and/or memory 1116 may include a forbidden area module 1130 that when implemented by the one or more processors 1104 configures the one or more processors 1104 to send an indication of one or more forbidden geodetic areas to the UE e.g., in a Registration Accept message, via the external interfaced 1102, wherein the UE refrains from requesting service from the serving PLMN when an updated geodetic location obtained by the UE is determined to be within any of the one or more forbidden geodetic areas.

The methodologies described herein may be implemented by various means depending upon the application. For example, these methodologies may be implemented in hardware, firmware, software, or any combination thereof. For a hardware implementation, the one or more processors 1104 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For an implementation of network entity 1100 involving firmware and/or software, the methodologies may be implemented with modules (e.g., procedures, functions, and so on) that perform the separate functions described herein. Any machine-readable medium tangibly embodying instructions may be used in implementing the methodologies described herein. For example, software codes may be stored in a medium 1118 or memory 1116 and executed by one or more processors 1104, causing the one or more processors 1104 to operate as a special purpose computer programmed to perform the techniques disclosed herein. Memory may be implemented within the one or processors 1104 or external to the one or more processors 1104. As used herein the term “memory” refers to any type of long term, short term, volatile, nonvolatile, or other memory and is not to be limited to any particular type of memory or number of memories, or type of media upon which memory is stored.

If implemented in firmware and/or software, the functions performed by network entity 1100 may be stored as one or more instructions or code on a non-transitory computer-readable storage medium such as medium 1118 or memory 1116. Examples of storage media include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable storage medium, instructions and/or data for network entity 1100 may be provided as signals on transmission media included in a communication apparatus. For example, a communication apparatus comprising part or all of network entity 1100 may include a transceiver having signals indicative of instructions and data. The instructions and data are stored on non-transitory computer readable media, e.g., medium 1118 or memory 1116, and are configured to cause the one or more processors 1104 to operate as a special purpose computer programmed to perform the techniques disclosed herein. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

FIG. 12 shows a flowchart of an example procedure 1200 for supporting satellite wireless access by a user equipment (e.g. a UE 105, UE 802, or UE 902) to a serving public land mobile network (PLMN), performed by the UE.

As illustrated, at block 1202, the UE receives from a network node an indication of a registration area (RA), where the RA comprises a geodetic area that is determined by the network node based on a current geodetic location of the UE, e.g., as discussed in FIGS. 7A, 7B, and 7C, and at stages 16 and 17 of FIG. 8. The serving PLMN for example, may be a Fifth Generation (5G) PLMN, and the network node may be an Access and Mobility management Function (AMF), such as AMF 122, 808 or 908. The indication of the RA, for example, may indicate a geodetic area of the RA, which may be defined based on a distance from a UE location or from another location, or may be defined based on coordinates of points that define the perimeter of the RA. A means for receiving from a network node an indication of a registration area (RA), wherein the RA comprises a geodetic area that is determined by the network node based on a current geodetic location of the UE may be, e.g., the satellite transceiver 1003 and one or more processors 1004 with dedicated hardware or implementing executable code or software instructions in memory 1016 and/or medium 1018, such as the RA module 1022 in UE 1000.

At block 1204, the UE accesses a radio cell for the serving PLMN, where the radio cell is supported by a satellite (e.g. an SV 102/202/302), e.g., as discussed in FIG. 7A, and at stages 1 to 7 of FIG. 8. A means for accessing a radio cell for the serving PLMN, wherein the radio cell is supported by a satellite may be, e.g., the satellite transceiver 1003 and one or more processors 1004 with dedicated hardware or implementing executable code or software instructions in memory 1016 and/or medium 1018, such as the radio cell access module 1024 in UE 1000.

At block 1206, the UE determines whether the radio cell provides coverage for the RA, e.g., as discussed in FIG. 7A, and at stages 3 and 7 of FIG. 8. A means for determining whether the radio cell provides coverage for the RA may be, e.g., one or more of the satellite transceiver 1003, the wireless transceiver 1002, WLAN transceiver 1006, SPS receiver 1008, the sensors 1010, and the one or more processors 1004 with dedicated hardware or implementing executable code or software instructions in memory 1016 and/or medium 1018, such as the location module 12026 and RA module 1022 in UE 1000.

At block 1208, the UE performs a Registration with the serving PLMN via the radio cell in response to determining that the radio cell does not provide coverage for the RA, e.g., as discussed in FIG. 7A, and at stages 8 to 17 of FIG. 8. A means for performing a Registration with the serving PLMN via the radio cell in response to determining that the radio cell does not provide coverage for the RA may be, e.g., the satellite transceiver 1003 and one or more processors 1004 with dedicated hardware or implementing executable code or software instructions in memory 1016 and/or medium 1018, such as the Registration module 1028 in UE 1000.

In one implementation, the UE may determine whether the radio cell provides coverage for the RA by obtaining an updated geodetic location for the UE, e.g., as discussed at stage 6 of FIG. 8, and determining whether the updated geodetic location is inside or outside the RA, e.g., as discussed in FIG. 7A and at stage 7 of FIG. 8. The UE may determine that the radio cell provides coverage for the RA if the updated geodetic location is inside the RA, and determine that the radio cell does not (or may not) provide coverage for the RA if the updated geodetic location is outside the RA, e.g., as discussed in FIG. 7A and at stage 7 of FIG. 8. A means for obtaining an updated geodetic location for the UE may be, e.g., one or more of the satellite transceiver 1003, the wireless transceiver 1002, WLAN transceiver 1006, SPS receiver 1008, the sensors 1010, and the one or more processors 1004 with dedicated hardware or implementing executable code or software instructions in memory 1016 and/or medium 1018, such as the location module 1026 in UE 1000. A means for determining whether the updated geodetic location is inside or outside the RA, and means for determining that the radio cell provides coverage for the RA if the updated geodetic location is inside the RA, and means for determining that the radio cell does not provide coverage for the RA if the updated geodetic location is outside the RA may be, e.g., the one or more processors 1004 with dedicated hardware or implementing executable code or software instructions in memory 1016 and/or medium 1018, such as the RA module 1022 in UE 1000.

In one implementation, the UE may attempt to obtain additional updated geodetic locations for the UE over a time period and for each additional updated geodetic location, the UE may either fail to obtain the additional updated geodetic location or fail to determine whether the additional updated geodetic location is inside or outside the RA, e.g., as discussed in FIG. 7A and at stages 6 and 7 of FIG. 8. The UE may perform the Registration with the serving PLMN when the time period exceeds a threshold time period, e.g., as discussed in FIG. 7A and at stages 6 and 7 of FIG. 8. The duration of the threshold time period, for example, may be based on at least one of a size of the RA, a last known geodetic location for the UE and a velocity of the UE, or any combination thereof. A means for attempting to obtain additional updated geodetic locations for the UE over a time period, and for each additional updated geodetic location, either failing to obtain the additional updated geodetic location or failing to determine whether the additional updated geodetic location is inside or outside the RA may be, e.g., one or more of the satellite transceiver 1003, the wireless transceiver 1002, WLAN transceiver 1006, SPS receiver 1008, the sensors 1010, and the one or more processors 1004 with dedicated hardware or implementing executable code or software instructions in memory 1016 and/or medium 1018, such as the location module 1026 in UE 1000. A means for performing the Registration with the serving PLMN when the time period exceeds a threshold time period may be, e.g., the satellite transceiver 1003 and one or more processors 1004 with dedicated hardware or implementing executable code or software instructions in memory 1016 and/or medium 1018, such as the Registration module 1028 and a timer module 1030 in UE 1000.

The UE may obtain the updated geodetic location of the UE by obtaining location measurements for downlink signals received from one or more communication satellites (e.g. SVs 102/202/302), one or more Global Navigation Satellite System (GNSS) satellites (e.g. SVs 190), one or more terrestrial base stations (e.g. gNBs) or a combination thereof, e.g., as discussed in FIG. 7A and stages 4 and 6 of FIG. 8. The UE may determine the updated geodetic location based on the location measurements, e.g., as discussed in FIG. 7A and stages 4 and 6 of FIG. 8. For example, the location measurements may be or may include measurements of GNSS pseudorange, RSRP, RSRQ, Rx-Tx, RTT, AOA, DAOA, RSTD, or other types of location measurements, and the geodetic location may be determined based on the location measurements and any assistance data received, e.g., at stage 2. A means for obtaining location measurements for downlink signals received from one or more communication satellites, one or more Global Navigation Satellite System (GNSS) satellites, one or more terrestrial base stations or a combination thereof may be, e.g., one or more of the satellite transceiver 1003, the wireless transceiver 1002, WLAN transceiver 1006, SPS receiver 1008, and the one or more processors 1004 with dedicated hardware or implementing executable code or software instructions in memory 1016 and/or medium 1018, such as the location module 1026 in UE 1000. A means for determining the updated geodetic location based on the location measurements may be, e.g., the one or more processors 1004 with dedicated hardware or implementing executable code or software instructions in memory 1016 and/or medium 1018, such as the location module 1026 in UE 1000.

In one implementation, the UE may determine whether the radio cell provides coverage for the RA by receiving an indication of a geodetic area of coverage for the radio cell, e.g., as discussed in FIG. 7A and at stage 2 of FIG. 8, and determining whether the geodetic area of coverage includes at least part of the RA, e.g., as discussed in FIG. 7A and at stage 3 of FIG. 8. The UE may determine that the radio cell provides coverage for the RA if the geodetic area of coverage includes the at least part of the RA and may determine that the radio cell does not provide coverage for the RA if the geodetic area of coverage does not include the at least part of the RA, e.g., as discussed in FIG. 7A and at stage 3 of FIG. 8. A means for receiving an indication of a current geodetic area of coverage for the radio cell may be, e.g., the satellite transceiver 1003 and one or more processors 1004 with dedicated hardware or implementing executable code or software instructions in memory 1016 and/or medium 1018, such as the radio cell access module 1024 in UE 1000. A means for determining whether the current geodetic area of coverage includes at least part of the RA, and means for determining that the radio cell provides coverage for the RA if the current geodetic area of coverage includes the at least part of the RA, and means for determining that the radio cell does not provide coverage for the RA if the current geodetic area of coverage does not include the at least part of the RA may be, e.g., the one or more processors 1004 with dedicated hardware or implementing executable code or software instructions in memory 1016 and/or medium 1018, such as the RA module 1022 in UE 1000.

The indication of the geodetic area of coverage for the radio cell may include an indication of a current geodetic area of coverage for the radio cell, one or more indications of future geodetic areas of coverage for the radio cell or a combination of these, e.g. as discussed for FIG. 7A. An indication of a future geodetic area of coverage for the radio cell may include an indication of a change in a location of the geodetic area of coverage of the radio cell, an indication of a change in a shape of the geodetic area of coverage of the radio cell, an indication of a change in a size of the geodetic area of coverage of the radio cell, an indication of a rate of change in the location of the geodetic area of coverage for the radio cell, an indication of a rate of change in the shape of the geodetic area of coverage for the radio cell, an indication of a rate of change in a size of the geodetic area of coverage of the radio cell, or some combination of these, e.g. as described for FIG. 7A. An indication of a future geodetic area of coverage for the radio cell may also or instead include an indication of an orbital motion of the satellite and an indication of directional transmission of the radio cell from the satellite, e.g. as described for FIG. 7A.

The RA, for example, may not be a preconfigured area and may not have an associated identifier. As discussed in FIG. 7A, the RA may be an interior of a circle centered on the current geodetic location of the UE. For example, the RA may be defined by a radius of the circle. In one implementation, the RA may be based on an extended geodetic area that includes a first portion covering all or part of a home country for the serving PLMN and a second portion covering one or more other countries, where the RA includes the first portion of the extended geodetic area and excludes the second portion of the extended geodetic area, e.g., as discussed in FIG. 7A. In some implementations, the UE may receive an indication of the extended geodetic area from the network node, e.g., as discussed in FIG. 7A and at stages 16 and 17 of FIG. 8, and may determine the RA based on the indication of the extended geodetic area and information configured in (or otherwise available to) the UE concerning a border of the home country, e.g., as discussed in FIG. 7A and at stages 16 and 17 of FIG. 8. A means for receiving an indication of the extended geodetic area from the network node may be, e.g., the satellite transceiver 1003 and one or more processors 1004 with dedicated hardware or implementing executable code or software instructions in memory 1016 and/or medium 1018, such as the RA module 1022 in UE 1000. A means for determining the RA based on the indication of the extended geodetic area and information configured in the UE concerning a border of the home country may be, e.g., the satellite transceiver 1003 and one or more processors 1004 with dedicated hardware or implementing executable code or software instructions in memory 1016 and/or medium 1018, such as the RA module 1022 and a border module 1032 in UE 1000.

In one implementation, the UE sends a Registration Request message to a serving base station (e.g. a gNB 106/202/307), where the serving base station forwards the Registration Request message to the network node, e.g., as discussed at stages 10 and 13 of FIG. 8. The UE may receive a Registration Accept message from the network node via the serving base station, where the Registration Accept message comprises the indication of the RA, e.g., as discussed at stages 16 and 17 of FIG. 8. For example, the UE further may obtain current location information for the UE, e.g., as discussed at stages 4 and 6 of FIG. 8 and may include the current location information with the Registration Request message sent to the serving base station for the UE, where the current geodetic location is determined by the serving PLMN based in part on the current location information, e.g., as discussed at stage 15 of FIG. 8. In some implementations, the current location information, for example, may include the current geodetic location, e.g., as discussed at stages 6 and 15 of FIG. 8. In some implementations, the current geodetic location may be determined by the serving base station or by the network node, e.g., as discussed at stages 11 and 15 of FIG. 8. A means for sending a Registration Request message to a serving base station, wherein the serving base station forwards the Registration Request message to the network node may be, e.g., the satellite transceiver 1003 and one or more processors 1004 with dedicated hardware or implementing executable code or software instructions in memory 1016 and/or medium 1018, such as the Registration module 1028 in UE 1000. A means for receiving a Registration Accept message from the network node via the serving base station, wherein the Registration Accept message comprises the indication of the RA may be, e.g., the satellite transceiver 1003 and one or more processors 1004 with dedicated hardware or implementing executable code or software instructions in memory 1016 and/or medium 1018, such as the Registration module 1028 in UE 1000. A means for obtaining current location information for the UE may be, e.g., one or more of the satellite transceiver 1003, the wireless transceiver 1002, WLAN transceiver 1006, SPS receiver 1008, and the one or more processors 1004 with dedicated hardware or implementing executable code or software instructions in memory 1016 and/or medium 1018, such as the location module 1026 in UE 1000. A means for including the current location information with the Registration Request message sent to the serving base station for the UE, wherein the current geodetic location is determined by the serving PLMN based in part on the current location information may be, e.g., the satellite transceiver 1003 and one or more processors 1004 with dedicated hardware or implementing executable code or software instructions in memory 1016 and/or medium 1018, such as the Registration module 1028 in UE 1000.

In some implementations, the UE may receive an indication of a second RA as part of performing the Registration with the serving PLMN, where the second RA comprises a second geodetic area that is determined by the network node based on an updated geodetic location of the UE, e.g., as discussed at stage 16 of FIG. 8. The UE may replace the RA with the second RA, e.g., as discussed at stage 17 of FIG. 8. A means for receiving an indication of a second RA as part of performing the Registration with the serving PLMN, wherein the second RA comprises a second geodetic area that is determined by the network node based on an updated geodetic location of the UE may be, e.g., the satellite transceiver 1003 and one or more processors 1004 with dedicated hardware or implementing executable code or software instructions in memory 1016 and/or medium 1018, such as the RA module 1022 in UE 1000. A means for replacing the RA with the second RA may be, e.g., the one or more processors 1004 with dedicated hardware or implementing executable code or software instructions in memory 1016 and/or medium 1018, such as the RA module 1022 in UE 1000.

In one implementation, the UE may further receive a paging message from the serving PLMN via the radio cell, where the paging message is transmitted by the serving PLMN in the radio cell based on the radio cell having radio coverage of at least part of the RA, e.g., as discussed at stage 8 of FIG. 9. A means for receiving a paging message from the serving PLMN via the radio cell, wherein the paging message is transmitted by the serving PLMN in the radio cell based on the radio cell having radio coverage of at least part of the RA may be, e.g., the satellite transceiver 1003 and one or more processors 1004 with dedicated hardware or implementing executable code or software instructions in memory 1016 and/or medium 1018, such as the paging module 1034 in UE 1000.

In one implementation, the UE may receive an indication of a current geodetic area of coverage for the radio cell, e.g., as discussed at stage 7A and stage 2 of FIG. 8. The UE may determine whether the current geodetic area of coverage includes at least part of the RA, e.g., as discussed at stage 7A and stage 3 of FIG. 8. The UE may camp on the radio cell or access the serving PLMN via the radio cell when the current geodetic area of coverage is determined to include at least part of the RA, e.g., as discussed at stage 7A and stage 3 of FIG. 8. A means for receiving an indication of a current geodetic area of coverage for the radio cell may be, e.g., the satellite transceiver 1003 and one or more processors 1004 with dedicated hardware or implementing executable code or software instructions in memory 1016 and/or medium 1018, such as the radio cell access module 1024 in UE 1000. A means for determining whether the current geodetic area of coverage includes at least part of the RA may be, e.g., the one or more processors 1004 with dedicated hardware or implementing executable code or software instructions in memory 1016 and/or medium 1018, such as the RA module 1022 in UE 1000. A means for camping on the radio cell or accessing the serving PLMN via the radio cell when the current geodetic area of coverage is determined to include at least part of the RA may be, e.g., the satellite transceiver 1003 and one or more processors 1004 with dedicated hardware or implementing executable code or software instructions in memory 1016 and/or medium 1018, such as the radio cell access module 1024 in UE 1000.

In one implementation, the UE may receive from the serving PLMN an indication of one or more forbidden geodetic areas, e.g., as discussed in FIG. 7A and at stages 7 and 17 of FIG. 8. The forbidden geodetic area may be defined as a polygon, circle or ellipse, or defined using coordinates of vertices, distances from a center point, etc. The UE may determine whether an updated geodetic location of the UE is within any of the one or more forbidden geodetic areas, e.g., as discussed at stages 7 of FIG. 8. The UE may refrain from requesting service from the serving PLMN when the updated geodetic location is determined to be within any of the one or more forbidden geodetic areas, e.g., as discussed at stage 7 of FIG. 8. A means for receiving from the serving PLMN an indication of one or more forbidden geodetic areas may be, e.g., the satellite transceiver 1003 and one or more processors 1004 with dedicated hardware or implementing executable code or software instructions in memory 1016 and/or medium 1018, such as the forbidden area module 1036 in UE 1000. A means for determining whether an updated geodetic location of the UE is within any of the one or more forbidden geodetic areas may be, e.g., the wireless transceiver 1002, WLAN transceiver 1006, SPS receiver 1008, the sensors 1010, and the one or more processors 1004 with dedicated hardware or implementing executable code or software instructions in memory 1016 and/or medium 1018, such as the location module 1026 and the forbidden area module 1036 in UE 1000. A means for refraining from requesting service from the serving PLMN when the updated geodetic location is determined to be within any of the one or more forbidden geodetic areas may be, e.g., the one or more processors 1004 with dedicated hardware or implementing executable code or software instructions in memory 1016 and/or medium 1018, such as the forbidden area module 1036 in UE 1000.

FIG. 13 shows a flowchart of an example procedure 1300 for supporting satellite wireless access by a user equipment (e.g. a UE 105, UE 802, or UE 902) to a serving public land mobile network (PLMN), performed by a network node in the PLMN. The serving PLMN for example, may be a Fifth Generation (5G) PLMN, and the network node may be an Access and Mobility management Function (AMF), such as AMF 122, 808 or 908.

As illustrated, at block 1302, the network node obtains a current geodetic location of the UE, e.g., as discussed in FIG. 7A and at stage 15 of FIG. 8. A means for obtaining a current geodetic location of the UE may be, e.g., the external interface 1102 and one or more processors 1104 with dedicated hardware or implementing executable code or software instructions in memory 1116 and/or medium 1118, such as the location module 1122 in network node 1100.

At block 1304, the network node determines a registration area (RA), where the RA comprises a geodetic area that is determined based on the current geodetic location of the UE, e.g., as discussed at FIGS. 7A, 7B, and 7C and at stage 16 of FIG. 8. A means for determining a registration area (RA), wherein the RA comprises a geodetic area that is determined based on the current geodetic location of the UE may be, e.g., the one or more processors 1104 with dedicated hardware or implementing executable code or software instructions in memory 1116 and/or medium 1118, such as the RA module 1124 in network node 1100.

At block 1306, the network node sends to the UE an indication of the RA (e.g. an SV 102/202/302), e.g., as discussed at FIG. 7A and at stages 3, 7, 16 and 17 of FIG. 8. The UE, for example, accesses a radio cell for the serving PLMN based on whether the radio cell provides coverage for the RA, and where the radio cell is supported by a satellite. A means for sending to the UE an indication of the RA may be, e.g., the external interface 1102 and one or more processors 1104 with dedicated hardware or implementing executable code or software instructions in memory 1116 and/or medium 1118, such as the RA module 1124 in network node 1100.

In one implementation, where whether the radio cell provides coverage for the RA is determined by the UE, the network node may perform a Registration for the UE with the serving PLMN via the radio cell if the UE determines the radio cell does not provide coverage for the RA, e.g., as discussed in FIG. 7A and stages 3, 7 and 13 to 17 of FIG. 8. A means for performing a Registration for the UE with the serving PLMN via the radio cell if the UE determines the radio cell does not provide coverage for the RA may be, e.g., the external interface 1102 and one or more processors 1104 with dedicated hardware or implementing executable code or software instructions in memory 1116 and/or medium 1118, such as the registration module 1126 in network node 1100.

For example, in one implementation, the network node may obtain an updated geodetic location of the UE, e.g., as discussed at stages 13 and 15 of FIG. 8, and may determine a second RA for the UE, where the second RA comprises a second geodetic area that is determined by the network node based on the updated geodetic location of the UE, e.g., as discussed at stage 16 of FIG. 8. The network node may send to the UE an indication of the second RA as part of performing the Registration for the UE with the serving PLMN, as discussed at stages 16 and 17 of FIG. 8. A means for obtaining an updated geodetic location of the UE may be, e.g., the external interface 1102 and one or more processors 1104 with dedicated hardware or implementing executable code or software instructions in memory 1116 and/or medium 1118, such as the location module 1122 in network node 1100. A means for determining a second RA for the UE, wherein the second RA comprises a second geodetic area that is determined by the network node based on the updated geodetic location of the UE may be, e.g., the one or more processors 1104 with dedicated hardware or implementing executable code or software instructions in memory 1116 and/or medium 1118, such as the RA module 1124 in network node 1100. A means for sending to the UE an indication of the second RA as part of performing the Registration for the UE with the serving PLMN may be, e.g., the external interface 1102 and one or more processors 1104 with dedicated hardware or implementing executable code or software instructions in memory 1116 and/or medium 1118, such as the RA module 1124 in network node 1100.

In one implementation, an updated geodetic location for the UE is obtained by the UE, and whether the radio cell provides coverage for the RA is determined by the UE based on: whether the updated geodetic location is inside or outside the RA; a determination that the radio cell provides coverage for the RA if the updated geodetic location is inside the RA; and a determination that the radio cell does not provide coverage for the RA if the updated geodetic location is outside the RA, e.g., as discussed in FIG. 7A and stages 6 and 7 of FIG. 8. For example, the updated geodetic location may be obtained by the UE based on location measurements for downlink signals received from one or more communication satellites (e.g. SVs 102/202/302), one or more Global Navigation Satellite System (GNSS) satellites (e.g. SVs 190), one or more terrestrial base stations (e.g. gNBs) or a combination thereof, e.g., as discussed at stages 4 and 6 of FIG. 8.

In one implementation, whether the radio cell provides coverage for the RA is determined by the UE using an indication of a geodetic area of coverage for the radio cell received by the UE based on: whether the geodetic area of coverage includes at least part of the RA; a determination that the radio cell provides coverage for the RA if the geodetic area of coverage includes the at least part of the RA; and a determination that the radio cell does not provide coverage for the RA if the geodetic area of coverage does not include the at least part of the RA, e.g., as discussed in FIG. 7A and at stage 3 of FIG. 8.

The RA, for example, may not be a preconfigured area and may not have an associated identifier. As discussed in FIG. 7A, the RA may be an interior of a circle centered on the current geodetic location of the UE. For example, the RA may be defined by a radius of the circle. In one implementation, the RA may be based on an extended geodetic area that includes a first portion covering all or part of a home country for the serving PLMN and a second portion covering one or more other countries, where the RA includes the first portion of the extended geodetic area and excludes the second portion of the extended geodetic area, e.g., as discussed in FIG. 7A. In some implementations, the network node may send an indication of the extended geodetic area to the UE, where the RA is determined at the UE based on the indication of the extended geodetic area and information configured in the UE (or otherwise available to the UE) concerning a border of the home country, e.g., as discussed in FIG. 7A and at stages 16 and 17 of FIG. 8. A means for sending an indication of the extended geodetic area to the UE, wherein the RA is determined at the UE based on the indication of the extended geodetic area and information configured in the UE concerning a border of the home country may be, e.g., the external interface 1102 and one or more processors 1104 with dedicated hardware or implementing executable code or software instructions in memory 1116 and/or medium 1118, such as the RA module 1124 in network node 1100.

In one implementation, the network node may receive a Registration Request message from the UE forwarded by a serving base station for the UE (e.g. a gNB 106/202/307), e.g., as discussed at stage 13 of FIG. 8. The network node may send a Registration Accept message to the UE via the serving base station, where the Registration Accept message comprises the indication of the RA, e.g., as discussed at stage 17 of FIG. 8. In one implementation, the network node may include an indication of one or more forbidden geodetic areas in the Registration Accept message, where the UE refrains from requesting service from the serving PLMN when an updated geodetic location obtained by the UE is determined to be within any of the one or more forbidden geodetic areas, e.g., as discussed in FIG. 7A and at stage 5 of FIG. 8. A means for including an indication of one or more forbidden geodetic areas in the Registration Accept message, wherein the UE refrains from requesting service from the serving PLMN when an updated geodetic location obtained by the UE is determined to be within any of the one or more forbidden geodetic areas may be, e.g., the external interface 1102 and one or more processors 1104 with dedicated hardware or implementing executable code or software instructions in memory 1116 and/or medium 1118, such as the forbidden area module 1130 in network node 1100. In one implementation, the Registration Request message from the UE received from the serving base station for the UE may include current location information for the UE, e.g., as discussed at stage 13 of FIG. 8, and the network node may then determine the current geodetic location based in part on the current location information, e.g. as discussed at stages 13 and 15 of FIG. 8. In some implementations, the network node may receive current location information for the UE from the serving base station along with the Registration Request, and may determine the current geodetic location based in part on the current location information. In some implementations, the current location information included in the Registration Request or received from the serving base station may comprise the current geodetic location.

A means for receiving a Registration Request message from the UE forwarded by a serving base station for the UE may be, e.g., the external interface 1102 and one or more processors 1104 with dedicated hardware or implementing executable code or software instructions in memory 1116 and/or medium 1118, such as the registration module 1126 in network node 1100. A means for sending a Registration Accept message to the UE via the serving base station, wherein the Registration Accept message comprises the indication of the RA may be, e.g., the external interface 1102 and one or more processors 1104 with dedicated hardware or implementing executable code or software instructions in memory 1116 and/or medium 1118, such as the registration module 1126 in network node 1100. A means for receiving the current location information for the UE from the serving base station along with the Registration Request and a means for determining the current geodetic location based in part on the current location information may be, e.g., the external interface 1102 and one or more processors 1104 with dedicated hardware or implementing executable code or software instructions in memory 1116 and/or medium 1118, such as the location module 1122 in network node 1100.

In one implementation, the network node may send a first Paging message (e.g. an NGAP Paging message) for the UE to a base station (e.g. a gNB 106/202/307), where the first Paging message includes geodetic location information for the UE, and where the base station sends a second Paging message (e.g. an RRC Paging message) to the UE via a satellite (e.g. an SV 101/202/302) in at least one radio cell based on the radio cell having coverage for one or more locations indicated in the geodetic location information, e.g. as described for stages 7 and 8 of FIG. 9. The geodetic location information may comprise at least one of the RA, a last known geodetic location for the UE, location history information for UE, or some combination of these, e.g. as described for stage 7 of FIG. 9. In some implementations, the network node may receive an indication (e.g. an NGAP message) from the serving base station that the UE has entered an Idle state (e.g. an RRC IDLE state), where the indication includes at least one of the last known geodetic location for the UE and the location history information for UE, e.g. as described for stage 5 of FIG. 8. The location history information may include one or more recent geodetic locations for the UE, e.g. as described for stage 5 of FIG. 9. At least some of the one or more recent geodetic locations for the UE may include a time or a time duration or both, e.g. as discussed for stage 5 of FIG. 9. A means for sending a first Paging message for the UE to a base station, wherein the first Paging message includes geodetic location information for the UE, wherein the base station sends a second Paging message to the UE via a satellite in at least one radio cell based on the radio cell having coverage for one or more locations indicated in the geodetic location information may be, e.g., the external interface 1102 and one or more processors 1104 with dedicated hardware or implementing executable code or software instructions in memory 1116 and/or medium 1118, such as the paging module 1128 in network node 1100. A means for receiving an indication from the serving base station that the UE has entered an Idle state, the indication including at least one of the last known geodetic location for the UE and the location history information for UE may be, e.g., the external interface 1102 and one or more processors 1104 with dedicated hardware or implementing executable code or software instructions in memory 1116 and/or medium 1118, such as the paging module 1128 in network node 1100.

Substantial variations may be made in accordance with specific desires. For example, customized hardware might also be used, and/or particular elements might be implemented in hardware, software (including portable software, such as applets, etc.), or both. Further, connection to other computing devices such as network input/output devices may be employed.

Configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of 20% or +10%, +5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of 20% or +10%, +5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

As used herein, a mobile device, user equipment (UE), or mobile station (MS) refers to a device such as a cellular or other wireless communication device, a smartphone, tablet, personal communication system (PCS) device, personal navigation device (PND), Personal Information Manager (PIM), Personal Digital Assistant (PDA), laptop or other suitable mobile device which is capable of receiving wireless communication and/or navigation signals, such as navigation positioning signals. The term “mobile station” (or “mobile device”. “wireless device” or “user equipment”) is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, a “mobile station” or “user equipment” is intended to include all devices, including wireless communication devices, computers, laptops, tablet devices, etc., which are capable of communication with a server, such as via the Internet, WiFi, or other network, and to communicate with one or more types of nodes, regardless of whether satellite signal reception, assistance data reception, and/or position-related processing occurs at the device, at a server, or at another device or node associated with the network. Any operable combination of the above are also considered a “mobile station” or “user equipment.” A mobile device or user equipment (UE) may also be referred to as a mobile terminal, a terminal, a device, a Secure User Plane Location Enabled Terminal (SET), a target device, a target, or by some other name.

While some of the techniques, processes, and/or implementations presented herein may comply with all or part of one or more standards, such techniques, processes, and/or implementations may not, in some embodiments, comply with part or all of such one or more standards.

In view of this description embodiments may include different combinations of features. Implementation examples are described in the following numbered clauses:
Clause 1. A method performed by a user equipment (UE) for supporting satellite wireless access by the UE to a serving public land mobile network (PLMN), the method comprising: receiving from a network node an indication of a registration area (RA), wherein the RA comprises a geodetic area that is determined by the network node based on a current geodetic location of the UE; accessing a radio cell for the serving PLMN, wherein the radio cell is supported by a satellite; determining whether the radio cell provides coverage for the RA; and performing a Registration with the serving PLMN via the radio cell in response to determining that the radio cell does not provide coverage for the RA.
Clause 2. The method of clause 1, wherein determining whether the radio cell provides coverage for the RA comprises: obtaining an updated geodetic location for the UE; determining whether the updated geodetic location is inside or outside the RA; determining that the radio cell provides coverage for the RA if the updated geodetic location is inside the RA; and determining that the radio cell does not provide coverage for the RA if the updated geodetic location is outside the RA.
Clause 3. The method of clause 2, further comprising: attempting to obtain additional updated geodetic locations for the UE over a time period; for each additional updated geodetic location, either failing to obtain the additional updated geodetic location or failing to determine whether the additional updated geodetic location is inside or outside the RA; and performing the Registration with the serving PLMN when the time period exceeds a threshold time period.
Clause 4. The method of clause 3, wherein a duration of the threshold time period is based on at least one of a size of the RA, a last known geodetic location for the UE and a velocity of the UE, or any combination thereof.
Clause 5. The method of any of clauses 2-4, wherein obtaining the updated geodetic location of the UE comprises: obtaining location measurements for downlink signals received from one or more communication satellites, one or more Global Navigation Satellite System (GNSS) satellites, one or more terrestrial base stations or a combination thereof, and determining the updated geodetic location based on the location measurements.
Clause 6. The method of any of clauses 1-5, wherein determining whether the radio cell provides coverage for the RA comprises: receiving an indication of a geodetic area of coverage for the radio cell; determining whether the geodetic area of coverage includes at least part of the RA; and determining that the radio cell provides coverage for the RA if the geodetic area of coverage includes the at least part of the RA; and determining that the radio cell does not provide coverage for the RA if the geodetic area of coverage does not include the at least part of the RA.
Clause 7. The method of clause 6, wherein the indication of the geodetic area of coverage for the radio cell includes an indication of a current geodetic area of coverage for the radio cell, one or more indications of future geodetic areas of coverage for the radio cell or a combination of these.
Clause 8. The method of clause 7, wherein the indication of the future geodetic area of coverage for the radio cell includes an indication of a change in location of the geodetic area of coverage of the radio cell, an indication of a change in shape of the geodetic area of coverage of the radio cell, an indication of a change in a size of the geodetic area of coverage of the radio cell, an indication of a rate of change in the location of the geodetic area of coverage for the radio cell, an indication of a rate of change in the shape of the geodetic area of coverage for the radio cell, an indication of a rate of change in a size of the geodetic area of coverage of the radio cell, or some combination of these.
Clause 9. The method of clause 7, wherein the indication of the future geodetic area of coverage for the radio cell includes an indication of an orbital motion of the satellite and an indication of directional transmission of the radio cell from the satellite.
Clause 10. The method of any of clauses 1-9, wherein the RA is not a preconfigured area and does not have an associated identifier.
Clause 11. The method of any of clauses 1-10, wherein the RA comprises an interior of a circle centered on the current geodetic location of the UE.
Clause 12. The method of clause 11, wherein the RA is defined by a radius of the circle.
Clause 13. The method of any of clauses 1-12, wherein the RA is based on an extended geodetic area comprising a first portion covering all or part of a home country for the serving PLMN and a second portion covering one or more other countries, wherein the RA comprises the first portion of the extended geodetic area and excludes the second portion of the extended geodetic area.
Clause 14. The method of clause 13, further comprising: receiving an indication of the extended geodetic area from the network node; and determining the RA based on the indication of the extended geodetic area and information configured in the UE concerning a border of the home country.
Clause 15. The method of any of clauses 1-14, further comprising: sending a Registration Request message to a serving base station, wherein the serving base station forwards the Registration Request message to the network node; and receiving a Registration Accept message from the network node via the serving base station, wherein the Registration Accept message comprises the indication of the RA.
Clause 16. The method of clause 15, further comprising: obtaining current location information for the UE; and including the current location information with the Registration Request message sent to the serving base station for the UE, wherein the current geodetic location is determined by the serving PLMN based in part on the current location information.
Clause 17. The method of clause 16, wherein the current location information comprises the current geodetic location.
Clause 18. The method of clause 15, wherein the current geodetic location is determined by the serving base station or by the network node.
Clause 19. The method of any of clauses 1-18, further comprising: receiving an indication of a second RA as part of performing the Registration with the serving PLMN, wherein the second RA comprises a second geodetic area that is determined by the network node based on an updated geodetic location of the UE; and replacing the RA with the second RA.
Clause 20. The method of any of clauses 1-19, further comprising receiving a paging message from the serving PLMN via the radio cell, wherein the paging message is transmitted by the serving PLMN in the radio cell based on the radio cell having radio coverage of at least part of the RA.
Clause 21. The method of any of clauses 1-20, further comprising: receiving an indication of a current geodetic area of coverage for the radio cell; determining whether the current geodetic area of coverage includes at least part of the RA; and camping on the radio cell or accessing the serving PLMN via the radio cell when the current geodetic area of coverage is determined to include at least part of the RA.
Clause 22. The method of any of clauses 1-21, further comprising: receiving from the serving PLMN an indication of one or more forbidden geodetic areas; determining whether an updated geodetic location of the UE is within any of the one or more forbidden geodetic areas; and refraining from requesting service from the serving PLMN when the updated geodetic location is determined to be within any of the one or more forbidden geodetic areas.
Clause 23. The method of any of clauses 1-22, wherein the serving PLMN comprises a Fifth Generation (5G) PLMN, and the network node comprises an Access and Mobility management Function (AMF).
Clause 24. A user equipment (UE) configured for supporting satellite wireless access by the UE to a serving public land mobile network (PLMN), the UE comprising: a wireless transceiver configured to wirelessly communicate with a communication satellite; at least one memory; at least one processor coupled to the wireless transceiver and the at least one memory, wherein the at least one processor is configured to: receive from a network node an indication of a registration area (RA), wherein the RA comprises a geodetic area that is determined by the network node based on a current geodetic location of the UE; access a radio cell for the serving PLMN, wherein the radio cell is supported by a satellite; determine whether the radio cell provides coverage for the RA; and perform a Registration with the serving PLMN via the radio cell in response to determining that the radio cell does not provide coverage for the RA.
Clause 25. The UE of clause 24, wherein the at least one processor is configured to determine whether the radio cell provides coverage for the RA by being configured to: obtain an updated geodetic location for the UE; determine whether the updated geodetic location is inside or outside the RA; determine that the radio cell provides coverage for the RA if the updated geodetic location is inside the RA; and determine that the radio cell does not provide coverage for the RA if the updated geodetic location is outside the RA.
Clause 26. The UE of clause 25, wherein the at least one processor is further configured to: attempt to obtain additional updated geodetic locations for the UE over a time period; for each additional updated geodetic location, either fail to obtain the additional updated geodetic location or fail to determine whether the additional updated geodetic location is inside or outside the RA; and perform the Registration with the serving PLMN when the time period exceeds a threshold time period.
Clause 27. The UE of clause 26, wherein a duration of the threshold time period is based on at least one of a size of the RA, a last known geodetic location for the UE and a velocity of the UE, or any combination thereof.
Clause 28. The UE of any of clauses 25-27, wherein the at least one processor is configured to obtain the updated geodetic location of the UE by being configured to: obtain location measurements for downlink signals received from one or more communication satellites, one or more Global Navigation Satellite System (GNSS) satellites, one or more terrestrial base stations or a combination thereof; and determine the updated geodetic location based on the location measurements.
Clause 29. The UE of any of clauses 24-28, wherein the at least one processor is configured to determine whether the radio cell provides coverage for the RA by being configured to: receive an indication of a geodetic area of coverage for the radio cell; determine whether the geodetic area of coverage includes at least part of the RA; and determine that the radio cell provides coverage for the RA if the geodetic area of coverage includes the at least part of the RA; and determine that the radio cell does not provide coverage for the RA if the geodetic area of coverage does not include the at least part of the RA.
Clause 30. The UE of clause 29, wherein the indication of the geodetic area of coverage for the radio cell includes an indication of a current geodetic area of coverage for the radio cell, one or more indications of future geodetic areas of coverage for the radio cell or a combination of these.
Clause 31. The UE of clause 30, wherein the indication of the future geodetic area of coverage for the radio cell includes an indication of a change in location of the geodetic area of coverage of the radio cell, an indication of a change in shape of the geodetic area of coverage of the radio cell, an indication of a change in a size of the geodetic area of coverage of the radio cell, an indication of a rate of change in the location of the geodetic area of coverage for the radio cell, an indication of a rate of change in the shape of the geodetic area of coverage for the radio cell, an indication of a rate of change in a size of the geodetic area of coverage of the radio cell, or some combination of these.
Clause 32. The UE of clause 30, wherein the indication of the future geodetic area of coverage for the radio cell includes an indication of an orbital motion of the satellite and an indication of directional transmission of the radio cell from the satellite.
Clause 33. The UE of any of clauses 24-32, wherein the RA is not a preconfigured area and does not have an associated identifier.
Clause 34. The UE of any of clauses 24-33, wherein the RA comprises an interior of a circle centered on the current geodetic location of the UE.
Clause 35. The UE of clause 34, wherein the RA is defined by a radius of the circle.
Clause 36. The UE of any of clauses 24-35, wherein the RA is based on an extended geodetic area comprising a first portion covering all or part of a home country for the serving PLMN and a second portion covering one or more other countries, wherein the RA comprises the first portion of the extended geodetic area and excludes the second portion of the extended geodetic area.
Clause 37. The UE of clause 36, wherein the at least one processor is further configured to: receive an indication of the extended geodetic area from the network node; and determine the RA based on the indication of the extended geodetic area and information configured in the UE concerning a border of the home country.
Clause 38. The UE of any of clauses 24-37, wherein the at least one processor is further configured to: send a Registration Request message to a serving base station, wherein the serving base station forwards the Registration Request message to the network node; and receive a Registration Accept message from the network node via the serving base station, wherein the Registration Accept message comprises the indication of the RA.
Clause 39. The UE of clause 38, wherein the at least one processor is further configured to: obtain current location information for the UE; and include the current location information with the Registration Request message sent to the serving base station for the UE, wherein the current geodetic location is determined by the serving PLMN based in part on the current location information.
Clause 40. The UE of clause 39, wherein the current location information comprises the current geodetic location.
Clause 41. The UE of clause 38, wherein the current geodetic location is determined by the serving base station or by the network node.
Clause 42. The UE of any of clauses 24-41, wherein the at least one processor is further configured to: receive an indication of a second RA as part of performing the Registration with the serving PLMN, wherein the second RA comprises a second geodetic area that is determined by the network node based on an updated geodetic location of the UE; and replace the RA with the second RA.
Clause 43. The UE of any of clauses 24-42, wherein the at least one processor is further configured to receive a paging message from the serving PLMN via the radio cell, wherein the paging message is transmitted by the serving PLMN in the radio cell based on the radio cell having radio coverage of at least part of the RA.
Clause 44. The UE of any of clauses 24-43, wherein the at least one processor is further configured to: receive an indication of a current geodetic area of coverage for the radio cell; determine whether the current geodetic area of coverage includes at least part of the RA; and camp on the radio cell or access the serving PLMN via the radio cell when the current geodetic area of coverage is determined to include at least part of the RA.
Clause 45. The UE of any of clauses 24-44, wherein the at least one processor is further configured to: receive from the serving PLMN an indication of one or more forbidden geodetic areas; determine whether an updated geodetic location of the UE is within any of the one or more forbidden geodetic areas; and refrain from requesting service from the serving PLMN when the updated geodetic location is determined to be within any of the one or more forbidden geodetic areas.
Clause 46. The UE of any of clauses 24-45, wherein the serving PLMN comprises a Fifth Generation (5G) PLMN, and the network node comprises an Access and Mobility management Function (AMF).
Clause 47. A user equipment (UE) configured for supporting satellite wireless access by the UE to a serving public land mobile network (PLMN), the UE comprising: means for receiving from a network node an indication of a registration area (RA), wherein the RA comprises a geodetic area that is determined by the network node based on a current geodetic location of the UE; means for accessing a radio cell for the serving PLMN, wherein the radio cell is supported by a satellite; means for determining whether the radio cell provides coverage for the RA; and means for performing a Registration with the serving PLMN via the radio cell in response to determining that the radio cell does not provide coverage for the RA.
Clause 48. The UE of clause 47, wherein the means for determining whether the radio cell provides coverage for the RA comprises: means for obtaining an updated geodetic location for the UE; means for determining whether the updated geodetic location is inside or outside the RA; means for determining that the radio cell provides coverage for the RA if the updated geodetic location is inside the RA; and means for determining that the radio cell does not provide coverage for the RA if the updated geodetic location is outside the RA.
Clause 49. The UE of clause 48, further comprising: means for attempting to obtain additional updated geodetic locations for the UE over a time period; for each additional updated geodetic location, either failing to obtain the additional updated geodetic location or failing to determine whether the additional updated geodetic location is inside or outside the RA; and means for performing the Registration with the serving PLMN when the time period exceeds a threshold time period.
Clause 50. The UE of clause 49, wherein a duration of the threshold time period is based on at least one of a size of the RA, a last known geodetic location for the UE and a velocity of the UE, or any combination thereof.
Clause 51. The UE of any of clauses 48-50, wherein the means for obtaining the updated geodetic location of the UE comprises: means for obtaining location measurements for downlink signals received from one or more communication satellites, one or more Global Navigation Satellite System (GNSS) satellites, one or more terrestrial base stations or a combination thereof, and means for determining the updated geodetic location based on the location measurements.
Clause 52. The UE of any of clauses 47-51, wherein the means for determining whether the radio cell provides coverage for the RA comprises: means for receiving an indication of a geodetic area of coverage for the radio cell; means for determining whether the geodetic area of coverage includes at least part of the RA; and means for determining that the radio cell provides coverage for the RA if the geodetic area of coverage includes the at least part of the RA; and means for determining that the radio cell does not provide coverage for the RA if the geodetic area of coverage does not include the at least part of the RA.
Clause 53. The UE of clause 52, wherein the indication of the geodetic area of coverage for the radio cell includes an indication of a current geodetic area of coverage for the radio cell, one or more indications of future geodetic areas of coverage for the radio cell or a combination of these.
Clause 54. The UE of clause 53, wherein the indication of the future geodetic area of coverage for the radio cell includes an indication of a change in location of the geodetic area of coverage of the radio cell, an indication of a change in shape of the geodetic area of coverage of the radio cell, an indication of a change in a size of the geodetic area of coverage of the radio cell, an indication of a rate of change in the location of the geodetic area of coverage for the radio cell, an indication of a rate of change in the shape of the geodetic area of coverage for the radio cell, an indication of a rate of change in a size of the geodetic area of coverage of the radio cell, or some combination of these.
Clause 55. The UE of clause 53, wherein the indication of the future geodetic area of coverage for the radio cell includes an indication of an orbital motion of the satellite and an indication of directional transmission of the radio cell from the satellite.
Clause 56. The UE of any of clauses 47-55, wherein the RA is not a preconfigured area and does not have an associated identifier.
Clause 57. The UE of any of clauses 47-56, wherein the RA comprises an interior of a circle centered on the current geodetic location of the UE.
Clause 58. The UE of clause 57, wherein the RA is defined by a radius of the circle.
Clause 59. The UE of any of clauses 47-58, wherein the RA is based on an extended geodetic area comprising a first portion covering all or part of a home country for the serving PLMN and a second portion covering one or more other countries, wherein the RA comprises the first portion of the extended geodetic area and excludes the second portion of the extended geodetic area.
Clause 60. The UE of clause 59, further comprising: means for receiving an indication of the extended geodetic area from the network node; and means for determining the RA based on the indication of the extended geodetic area and information configured in the UE concerning a border of the home country.
Clause 61. The UE of any of clauses 47-60, further comprising: means for sending a Registration Request message to a serving base station, wherein the serving base station forwards the Registration Request message to the network node; and means for receiving a Registration Accept message from the network node via the serving base station, wherein the Registration Accept message comprises the indication of the RA.
Clause 62. The UE of clause 61, further comprising: means for obtaining current location information for the UE; and means for including the current location information with the Registration Request message sent to the serving base station for the UE, wherein the current geodetic location is determined by the serving PLMN based in part on the current location information.
Clause 63. The UE of clause 62, wherein the current location information comprises the current geodetic location.
Clause 64. The UE of clause 61, wherein the current geodetic location is determined by the serving base station or by the network node.
Clause 65. The UE of any of clauses 47-64, further comprising: means for receiving an indication of a second RA as part of performing the Registration with the serving PLMN, wherein the second RA comprises a second geodetic area that is determined by the network node based on an updated geodetic location of the UE; and means for replacing the RA with the second RA.
Clause 66. The UE of any of clauses 47-65, further comprising means for receiving a paging message from the serving PLMN via the radio cell, wherein the paging message is transmitted by the serving PLMN in the radio cell based on the radio cell having radio coverage of at least part of the RA.
Clause 67. The UE of any of clauses 47-66, further comprising: means for receiving an indication of a current geodetic area of coverage for the radio cell; means for determining whether the current geodetic area of coverage includes at least part of the RA; and means for camping on the radio cell or accessing the serving PLMN via the radio cell when the current geodetic area of coverage is determined to include at least part of the RA.
Clause 68. The UE of any of clauses 47-67, further comprising: means for receiving from the serving PLMN an indication of one or more forbidden geodetic areas; means for determining whether an updated geodetic location of the UE is within any of the one or more forbidden geodetic areas; and means for refraining from requesting service from the serving PLMN when the updated geodetic location is determined to be within any of the one or more forbidden geodetic areas.
Clause 69. The UE of any of clauses 47-68, wherein the serving PLMN comprises a Fifth Generation (5G) PLMN, and the network node comprises an Access and Mobility management Function (AMF).
Clause 70. A non-transitory storage medium including program code stored thereon, the program code is operable to configure at least one processor in a user equipment (UE) for supporting satellite wireless access by the UE to a serving public land mobile network (PLMN), the program code comprising instruction: receive from a network node an indication of a registration area (RA), wherein the RA comprises a geodetic area that is determined by the network node based on a current geodetic location of the UE; access a radio cell for the serving PLMN, wherein the radio cell is supported by a satellite; determine whether the radio cell provides coverage for the RA; and perform a Registration with the serving PLMN via the radio cell in response to determining that the radio cell does not provide coverage for the RA.
Clause 71. The non-transitory storage medium of clause 70, wherein the instructions to determine whether the radio cell provides coverage for the RA comprise instructions to: obtain an updated geodetic location for the UE; determine whether the updated geodetic location is inside or outside the RA; determine that the radio cell provides coverage for the RA if the updated geodetic location is inside the RA; and determine that the radio cell does not provide coverage for the RA if the updated geodetic location is outside the RA.
Clause 72. The non-transitory storage medium of clause 71, further comprising instructions to: attempt to obtain additional updated geodetic locations for the UE over a time period; for each additional updated geodetic location, either failing to obtain the additional updated geodetic location or failing to determine whether the additional updated geodetic location is inside or outside the RA; and perform the Registration with the serving PLMN when the time period exceeds a threshold time period.
Clause 73. The non-transitory storage medium of clause 72, wherein a duration of the threshold time period is based on at least one of a size of the RA, a last known geodetic location for the UE and a velocity of the UE, or any combination thereof.
Clause 74. The non-transitory storage medium of any of clauses 71-73, wherein the instructions to obtain the updated geodetic location of the UE comprise instructions to: obtain location measurements for downlink signals received from one or more communication satellites, one or more Global Navigation Satellite System (GNSS) satellites, one or more terrestrial base stations or a combination thereof; and determine the updated geodetic location based on the location measurements.
Clause 75. The non-transitory storage medium of any of clauses 70-74, wherein the instructions to determine whether the radio cell provides coverage for the RA comprise instructions to: receive an indication of a geodetic area of coverage for the radio cell; determine whether the geodetic area of coverage includes at least part of the RA; and determine that the radio cell provides coverage for the RA if the geodetic area of coverage includes the at least part of the RA; and determine that the radio cell does not provide coverage for the RA if the geodetic area of coverage does not include the at least part of the RA.
Clause 76. The non-transitory storage medium of clause 75, wherein the indication of the geodetic area of coverage for the radio cell includes an indication of a current geodetic area of coverage for the radio cell, one or more indications of future geodetic areas of coverage for the radio cell or a combination of these.
Clause 77. The non-transitory storage medium of clause 76, wherein the indication of the future geodetic area of coverage for the radio cell includes an indication of a change in location of the geodetic area of coverage of the radio cell, an indication of a change in shape of the geodetic area of coverage of the radio cell, an indication of a change in a size of the geodetic area of coverage of the radio cell, an indication of a rate of change in the location of the geodetic area of coverage for the radio cell, an indication of a rate of change in the shape of the geodetic area of coverage for the radio cell, an indication of a rate of change in a size of the geodetic area of coverage of the radio cell, or some combination of these.
Clause 78. The non-transitory storage medium of clause 76, wherein the indication of the future geodetic area of coverage for the radio cell includes an indication of an orbital motion of the satellite and an indication of directional transmission of the radio cell from the satellite.
Clause 79. The non-transitory storage medium of any of clauses 70-78, wherein the RA is not a preconfigured area and does not have an associated identifier.
Clause 80. The non-transitory storage medium of any of clauses 70-79, wherein the RA comprises an interior of a circle centered on the current geodetic location of the UE.
Clause 81. The non-transitory storage medium of clause 80, wherein the RA is defined by a radius of the circle.
Clause 82. The non-transitory storage medium of any of clauses 70-81, wherein the RA is based on an extended geodetic area comprising a first portion covering all or part of a home country for the serving PLMN and a second portion covering one or more other countries, wherein the RA comprises the first portion of the extended geodetic area and excludes the second portion of the extended geodetic area.
Clause 83. The non-transitory storage medium of clause 82, further comprising instructions to: receive an indication of the extended geodetic area from the network node; and determine the RA based on the indication of the extended geodetic area and information configured in the UE concerning a border of the home country.
Clause 84. The non-transitory storage medium of any of clauses 70-83, further comprising instructions to: send a Registration Request message to a serving base station, wherein the serving base station forwards the Registration Request message to the network node; and receive a Registration Accept message from the network node via the serving base station, wherein the Registration Accept message comprises the indication of the RA.
Clause 85. The non-transitory storage medium of clause 84, further comprising instructions to: obtain current location information for the UE; and include the current location information with the Registration Request message sent to the serving base station for the UE, wherein the current geodetic location is determined by the serving PLMN based in part on the current location information.
Clause 86. The non-transitory storage medium of clause 85, wherein the current location information comprises the current geodetic location.
Clause 87. The non-transitory storage medium of clause 84, wherein the current geodetic location is determined by the serving base station or by the network node.
Clause 88. The non-transitory storage medium of any of clauses 70-87, further comprising instructions to: receive an indication of a second RA as part of performing the Registration with the serving PLMN, wherein the second RA comprises a second geodetic area that is determined by the network node based on an updated geodetic location of the UE; and replace the RA with the second RA.
Clause 89. The non-transitory storage medium of any of clauses 70-88, further comprising instructions to receive a paging message from the serving PLMN via the radio cell, wherein the paging message is transmitted by the serving PLMN in the radio cell based on the radio cell having radio coverage of at least part of the RA.
Clause 90. The non-transitory storage medium of any of clauses 70-89, further comprising instructions to: receive an indication of a current geodetic area of coverage for the radio cell; determine whether the current geodetic area of coverage includes at least part of the RA; and camp on the radio cell or accessing the serving PLMN via the radio cell when the current geodetic area of coverage is determined to include at least part of the RA.
Clause 91. The non-transitory storage medium of any of clauses 70-90, further comprising instructions to: receive from the serving PLMN an indication of one or more forbidden geodetic areas; determine whether an updated geodetic location of the UE is within any of the one or more forbidden geodetic areas; and refrain from requesting service from the serving PLMN when the updated geodetic location is determined to be within any of the one or more forbidden geodetic areas.
Clause 92. The non-transitory storage medium of any of clauses 70-91, wherein the serving PLMN comprises a Fifth Generation (5G) PLMN, and the network node comprises an Access and Mobility management Function (AMF).
Clause 93. A method performed by a network node in a public land mobile network (PLMN) for supporting satellite wireless access by a user equipment (UE) to a serving PLMN, the method comprising: obtaining a current geodetic location of the UE; determining a registration area (RA), wherein the RA comprises a geodetic area that is determined based on the current geodetic location of the UE; sending to the UE an indication of the RA.
Clause 94. The method of clause 93, wherein the UE accesses a radio cell for the serving PLMN based on whether the radio cell provides coverage for the RA, wherein the radio cell is supported by a satellite.
Clause 95. The method of clause 94, wherein whether the radio cell provides coverage for the RA is determined, the method further comprising: performing a Registration for the UE with the serving PLMN via the radio cell if the UE determines the radio cell does not provide coverage for the RA.
Clause 96. The method of clause 95, further comprising: obtaining an updated geodetic location of the UE; determining a second RA for the UE, wherein the second RA comprises a second geodetic area that is determined by the network node based on the updated geodetic location of the UE; and sending to the UE an indication of the second RA as part of performing the Registration for the UE with the serving PLMN.
Clause 97. The method of clause 95, wherein an updated geodetic location for the UE is obtained by the UE, wherein whether the radio cell provides coverage for the RA is determined by the UE based on: whether the updated geodetic location is inside or outside the RA; a determination that the radio cell provides coverage for the RA if the updated geodetic location is inside the RA; and a determination that the radio cell does not provide coverage for the RA if the updated geodetic location is outside the RA.
Clause 98. The method of clause 97, wherein the updated geodetic location is obtained by the UE based on location measurements for downlink signals received from one or more communication satellites, one or more Global Navigation Satellite System (GNSS) satellites, one or more terrestrial base stations or a combination thereof.
Clause 99. The method of any of clauses 95-98, wherein whether the radio cell provides coverage for the RA is determined by the UE using an indication of a geodetic area of coverage for the radio cell received by the UE based on: whether the geodetic area of coverage includes at least part of the RA; a determination that the radio cell provides coverage for the RA if the geodetic area of coverage includes the at least part of the RA; and a determination that the radio cell does not provide coverage for the RA if the geodetic area of coverage does not include the at least part of the RA.
Clause 100. The method of clause 99, wherein the indication of the geodetic area of coverage for the radio cell includes an indication of a current geodetic area of coverage for the radio cell, one or more indications of future geodetic areas of coverage for the radio cell or a combination of these.
Clause 101. The method of clause 100, wherein the indication of the future geodetic area of coverage for the radio cell includes an indication of a change in location of the geodetic area of coverage of the radio cell, an indication of a change in shape of the geodetic area of coverage of the radio cell, an indication of a change in a size of the geodetic area of coverage of the radio cell, an indication of a rate of change in the location of the geodetic area of coverage for the radio cell, an indication of a rate of change in the shape of the geodetic area of coverage for the radio cell, an indication of a rate of change in a size of the geodetic area of coverage of the radio cell, or some combination of these.
Clause 102. The method of clause 100, wherein the indication of the future geodetic area of coverage for the radio cell includes an indication of an orbital motion of the satellite and an indication of directional transmission of the radio cell from the satellite.
Clause 103. The method of any of clauses 93-102, wherein the RA is not a preconfigured area and does not have an associated identifier.
Clause 104. The method of any of clauses 93-103, wherein the RA comprises an interior of a circle centered on the current geodetic location of the UE.
Clause 105. The method of clause 104, wherein the RA is defined by a radius of the circle.
Clause 106. The method of any of clauses 93-105, wherein the RA is based on an extended geodetic area comprising a first portion covering all or part of a home country for the serving PLMN and a second portion covering one or more other countries, wherein the RA comprises the first portion of the extended geodetic area and excludes the second portion of the extended geodetic area.
Clause 107. The method of clause 106, further comprising: sending an indication of the extended geodetic area to the UE, wherein the RA is determined at the UE based on the indication of the extended geodetic area and information configured in the UE concerning a border of the home country.
Clause 108. The method of any of clauses 93-107, further comprising: receiving a Registration Request message from the UE forwarded by a serving base station for the UE; and sending a Registration Accept message to the UE via the serving base station, wherein the Registration Accept message comprises the indication of the RA.
Clause 109. The method of clause 108, further comprising: including an indication of one or more forbidden geodetic areas in the Registration Accept message, wherein the UE refrains from requesting service from the serving PLMN when an updated geodetic location obtained by the UE is determined to be within any of the one or more forbidden geodetic areas.
Clause 110. The method of clause 108, wherein the Registration Request message from the UE received from the serving base station for the UE includes current location information for the UE, and further comprising: determining the current geodetic location based in part on the current location information.
Clause 111. The method of clause 108, further comprising: receiving current location information for the UE from the serving base station along with the Registration Request message; and determining the current geodetic location based in part on the current location information.
Clause 112. The method of clause 111, wherein the current location information comprises the current geodetic location.
Clause 113. The method of any of clauses 93-112, further comprising: sending a first Paging message for the UE to a base station, wherein the first Paging message includes geodetic location information for the UE, wherein the base station sends a second Paging message to the UE via a satellite in at least one radio cell based on the radio cell having coverage for one or more locations indicated in the geodetic location information.
Clause 114. The method of clause 113, wherein the geodetic location information comprises at least one of the RA, a last known geodetic location for the UE, location history information for UE, or some combination of these.
Clause 115. The method of clause 114, further comprising: receiving an indication from a serving base station that the UE has entered an Idle state, the indication including at least one of the last known geodetic location for the UE and the location history information for UE.
Clause 116. The method of clause 115, wherein the location history information includes one or more recent geodetic locations for the UE.
Clause 117. The method of clause 116, wherein at least some of the one or more recent geodetic locations for the UE include a time or a time duration or both.
Clause 118. The method of any of clauses 93-117, wherein the serving PLMN comprises a Fifth Generation (5G) PLMN, and the network node comprises an Access and Mobility management Function (AMF).
Clause 119. A network node in a public land mobile network (PLMN) configured for supporting satellite wireless access by a user equipment (UE) to a serving PLMN, the network node comprising: an external interface configured to communicate with entities in a wireless network including the PLMN and one or more UEs; at least one memory; at least one processor coupled to the external interface and the at least one memory, wherein the at least one processor is configured to: obtain a current geodetic location of the UE; determine a registration area (RA), wherein the RA comprises a geodetic area that is determined based on the current geodetic location of the UE; send to the UE an indication of the RA.
Clause 120. The network node of clause 119, wherein the UE accesses a radio cell for the serving PLMN based on whether the radio cell provides coverage for the RA, wherein the radio cell is supported by a satellite.
Clause 121. The network node of clause 120, wherein whether the radio cell provides coverage for the RA is determined by the UE, the at least one processor is further configured to: perform a Registration for the UE with the serving PLMN via the radio cell when the UE determines the radio cell does not provide coverage for the RA.
Clause 122. The network node of clause 121, wherein the at least one processor is further configured to: obtain an updated geodetic location of the UE; determine a second RA for the UE, wherein the second RA comprises a second geodetic area that is determined by the network node based on the updated geodetic location of the UE; and send to the UE an indication of the second RA as part of performing the Registration for the UE with the serving PLMN.
Clause 123. The network node of clause 121, wherein an updated geodetic location for the UE is obtained by the UE, wherein whether the radio cell provides coverage for the RA is determined by the UE based on: whether the updated geodetic location is inside or outside the RA; a determination that the radio cell provides coverage for the RA if the updated geodetic location is inside the RA; and a determination that the radio cell does not provide coverage for the RA if the updated geodetic location is outside the RA.
Clause 124. The network node of clause 123, wherein the updated geodetic location is obtained by the UE based on location measurements for downlink signals received from one or more communication satellites, one or more Global Navigation Satellite System (GNSS) satellites, one or more terrestrial base stations or a combination thereof.
Clause 125. The network node of any of clauses 121-124, wherein whether the radio cell provides coverage for the RA is determined by the UE using an indication of a geodetic area of coverage for the radio cell received by the UE based on: whether the geodetic area of coverage includes at least part of the RA; a determination that the radio cell provides coverage for the RA if the geodetic area of coverage includes the at least part of the RA; and a determination that the radio cell does not provide coverage for the RA if the geodetic area of coverage does not include the at least part of the RA.
Clause 126. The network node of clause 125, wherein the indication of the geodetic area of coverage for the radio cell includes an indication of a current geodetic area of coverage for the radio cell, one or more indications of future geodetic areas of coverage for the radio cell or a combination of these.
Clause 127. The network node of clause 126, wherein the indication of the future geodetic area of coverage for the radio cell includes an indication of a change in location of the geodetic area of coverage of the radio cell, an indication of a change in shape of the geodetic area of coverage of the radio cell, an indication of a change in a size of the geodetic area of coverage of the radio cell, an indication of a rate of change in the location of the geodetic area of coverage for the radio cell, an indication of a rate of change in the shape of the geodetic area of coverage for the radio cell, an indication of a rate of change in a size of the geodetic area of coverage of the radio cell, or some combination of these.
Clause 128. The network node of clause 126, wherein the indication of the future geodetic area of coverage for the radio cell includes an indication of an orbital motion of the satellite and an indication of directional transmission of the radio cell from the satellite.
Clause 129. The network node of any of clauses 119-128, wherein the RA is not a preconfigured area and does not have an associated identifier.
Clause 130. The network node of any of clauses 119-129, wherein the RA comprises an interior of a circle centered on the current geodetic location of the UE.
Clause 131. The network node of clause 130, wherein the RA is defined by a radius of the circle.
Clause 132. The network node of any of clauses 119-131, wherein the RA is based on an extended geodetic area comprising a first portion covering all or part of a home country for the serving PLMN and a second portion covering one or more other countries, wherein the RA comprises the first portion of the extended geodetic area and excludes the second portion of the extended geodetic area.
Clause 133. The network node of clause 132, wherein the at least one processor is further configured to: send an indication of the extended geodetic area to the UE, wherein the RA is determined at the UE based on the indication of the extended geodetic area and information configured in the UE concerning a border of the home country.
Clause 134. The network node of any of clauses 119-134, wherein the at least one processor is further configured to: receive a Registration Request message from the UE forwarded by a serving base station for the UE; and send a Registration Accept message to the UE via the serving base station, wherein the Registration Accept message comprises the indication of the RA.
Clause 135. The network node of clause 134, wherein the at least one processor is further configured to: include an indication of one or more forbidden geodetic areas in the Registration Accept message, wherein the UE refrains from requesting service from the serving PLMN when an updated geodetic location obtained by the UE is determined to be within any of the one or more forbidden geodetic areas.
Clause 136. The network node of clause 134, wherein the Registration Request message from the UE received from the serving base station for the UE includes current location information for the UE, and the at least one processor is further configured to: determine the current geodetic location based in part on the current location information.
Clause 137. The network node of clause 134, wherein the at least one processor is further configured to: receive current location information for the UE from the serving base station along with the Registration Request message; and determine the current geodetic location based in part on the current location information.
Clause 138. The network node of clause 137, wherein the current location information comprises the current geodetic location.
Clause 139. The network node of any of clauses 119-138, wherein the at least one processor is further configured to: send a first Paging message for the UE to a base station, wherein the first Paging message includes geodetic location information for the UE, wherein the base station sends a second Paging message to the UE via a satellite in at least one radio cell based on the radio cell having coverage for one or more locations indicated in the geodetic location information.
Clause 140. The network node of clause 139, wherein the geodetic location information comprises at least one of the RA, a last known geodetic location for the UE, location history information for UE, or some combination of these.
Clause 141. The network node of clause 140, wherein the at least one processor is further configured to: receive an indication from a serving base station that the UE has entered an Idle state, the indication including at least one of the last known geodetic location for the UE and the location history information for UE.
Clause 142. The network node of clause 141, wherein the location history information includes one or more recent geodetic locations for the UE.
Clause 143. The network node of clause 142, wherein at least some of the one or more recent geodetic locations for the UE include a time or a time duration or both.
Clause 144. The network node of any of clauses 119-143, wherein the serving PLMN comprises a Fifth Generation (5G) PLMN, and the network node comprises an Access and Mobility management Function (AMF).
Clause 145. A network node in a public land mobile network (PLMN) configured for supporting satellite wireless access by a user equipment (UE) to a serving PLMN, the network node comprising: means for obtaining a current geodetic location of the UE; means for determining a registration area (RA), wherein the RA comprises a geodetic area that is determined based on the current geodetic location of the UE; means for sending to the UE an indication of the RA.
Clause 146. The network node of clause 145, wherein the UE accesses a radio cell for the serving PLMN based on whether the radio cell provides coverage for the RA, wherein the radio cell is supported by a satellite.
Clause 147. The network node of clause 146, wherein whether the radio cell provides coverage for the RA is determined by the UE, the network node further comprising: means for performing a Registration for the UE with the serving PLMN via the radio cell if the UE determines the radio cell does not provide coverage for the RA.
Clause 148. The network node of clause 147, further comprising: means for obtaining an updated geodetic location of the UE; means for determining a second RA for the UE, wherein the second RA comprises a second geodetic area that is determined by the network node based on the updated geodetic location of the UE; and means for sending to the UE an indication of the second RA as part of performing the Registration for the UE with the serving PLMN.
Clause 149. The network node of clause 147, wherein an updated geodetic location for the UE is obtained by the UE, wherein whether the radio cell provides coverage for the RA is determined by the UE based on: whether the updated geodetic location is inside or outside the RA; a determination that the radio cell provides coverage for the RA if the updated geodetic location is inside the RA; and a determination that the radio cell does not provide coverage for the RA if the updated geodetic location is outside the RA.
Clause 150. The network node of clause 149, wherein the updated geodetic location is obtained by the UE based on location measurements for downlink signals received from one or more communication satellites, one or more Global Navigation Satellite System (GNSS) satellites, one or more terrestrial base stations or a combination thereof.
Clause 151. The network node of any of clauses 147-150, wherein whether the radio cell provides coverage for the RA is determined by the UE using an indication of a geodetic area of coverage for the radio cell received by the UE based on: whether the geodetic area of coverage includes at least part of the RA; a determination that the radio cell provides coverage for the RA if the geodetic area of coverage includes the at least part of the RA; and a determination that the radio cell does not provide coverage for the RA if the geodetic area of coverage does not include the at least part of the RA.
Clause 152. The network node of clause 151, wherein the indication of the geodetic area of coverage for the radio cell includes an indication of a current geodetic area of coverage for the radio cell, one or more indications of future geodetic areas of coverage for the radio cell or a combination of these.
Clause 153. The network node of clause 152, wherein the indication of the future geodetic area of coverage for the radio cell includes an indication of a change in location of the geodetic area of coverage of the radio cell, an indication of a change in shape of the geodetic area of coverage of the radio cell, an indication of a change in a size of the geodetic area of coverage of the radio cell, an indication of a rate of change in the location of the geodetic area of coverage for the radio cell, an indication of a rate of change in the shape of the geodetic area of coverage for the radio cell, an indication of a rate of change in a size of the geodetic area of coverage of the radio cell, or some combination of these.
Clause 154. The network node of clause 152, wherein the indication of the future geodetic area of coverage for the radio cell includes an indication of an orbital motion of the satellite and an indication of directional transmission of the radio cell from the satellite.
Clause 155. The network node of any of clauses 145-154, wherein the RA is not a preconfigured area and does not have an associated identifier.
Clause 156. The network node of any of clauses 145-155, wherein the RA comprises an interior of a circle centered on the current geodetic location of the UE.
Clause 157. The network node of clause 156, wherein the RA is defined by a radius of the circle.
Clause 158. The network node of any of clauses 145-157, wherein the RA is based on an extended geodetic area comprising a first portion covering all or part of a home country for the serving PLMN and a second portion covering one or more other countries, wherein the RA comprises the first portion of the extended geodetic area and excludes the second portion of the extended geodetic area.
Clause 159. The network node of clause 158, further comprising: means for sending an indication of the extended geodetic area to the UE, wherein the RA is determined at the UE based on the indication of the extended geodetic area and information configured in the UE concerning a border of the home country.
Clause 160. The network node of any of clauses 145-159, further comprising: means for receiving a Registration Request message from the UE forwarded by a serving base station for the UE; and means for sending a Registration Accept message to the UE via the serving base station, wherein the Registration Accept message comprises the indication of the RA.
Clause 161. The network node of clause 160, further comprising: means for including an indication of one or more forbidden geodetic areas in the Registration Accept message, wherein the UE refrains from requesting service from the serving PLMN when an updated geodetic location obtained by the UE is determined to be within any of the one or more forbidden geodetic areas.
Clause 162. The network node of clause 160, wherein the Registration Request message from the UE received from the serving base station for the UE includes current location information for the UE, and further comprising: means for determining the current geodetic location based in part on the current location information.
Clause 163. The network node of clause 160, further comprising: means for receiving current location information for the UE from the serving base station along with the Registration Request message; and means for determining the current geodetic location based in part on the current location information.
Clause 164. The network node of clause 163, wherein the current location information comprises the current geodetic location.
Clause 165. The network node of any of clauses 145-164, further comprising: means for sending a first Paging message for the UE to a base station, wherein the first Paging message includes geodetic location information for the UE, wherein the base station sends a second Paging message to the UE via a satellite in at least one radio cell based on the radio cell having coverage for one or more locations indicated in the geodetic location information.
Clause 166. The network node of clause 165, wherein the geodetic location information comprises at least one of the RA, a last known geodetic location for the UE, location history information for UE, or some combination of these.
Clause 167. The network node of clause 166, further comprising: means for receiving an indication from a serving base station that the UE has entered an Idle state, the indication including at least one of the last known geodetic location for the UE and the location history information for UE.
Clause 168. The network node of clause 167, wherein the location history information includes one or more recent geodetic locations for the UE.
Clause 169. The network node of clause 168, wherein at least some of the one or more recent geodetic locations for the UE include a time or a time duration or both.
Clause 170. The network node of any of clauses 145-169, wherein the serving PLMN comprises a Fifth Generation (5G) PLMN, and the network node comprises an Access and Mobility management Function (AMF).
Clause 171. A non-transitory storage medium including program code stored thereon, the program code is operable to configure at least one processor in a network node in a public land mobile network (PLMN) for supporting satellite wireless access by a user equipment (UE) to a serving PLMN, the program code comprising instruction to: obtain a current geodetic location of the UE; determine a registration area (RA), wherein the RA comprises a geodetic area that is determined based on the current geodetic location of the UE; send to the UE an indication of the RA.
Clause 172. The non-transitory storage medium of clause 171, wherein the UE accesses a radio cell for the serving PLMN based on whether the radio cell provides coverage for the RA, wherein the radio cell is supported by a satellite.
Clause 173. The non-transitory storage medium of clause 172, wherein whether the radio cell provides coverage for the RA is determined by the UE, the program code further comprising instruction to: perform a Registration for the UE with the serving PLMN via the radio cell if the UE determines the radio cell does not provide coverage for the RA.
Clause 174. The non-transitory storage medium of clause 173, further comprising instruction to: obtain an updated geodetic location of the UE; determine a second RA for the UE, wherein the second RA comprises a second geodetic area that is determined by the network node based on the updated geodetic location of the UE; and send to the UE an indication of the second RA as part of performing the Registration for the UE with the serving PLMN.
Clause 175. The non-transitory storage medium of clause 173, wherein an updated geodetic location for the UE is obtained by the UE, wherein whether the radio cell provides coverage for the RA is determined by the UE based on: whether the updated geodetic location is inside or outside the RA; a determination that the radio cell provides coverage for the RA if the updated geodetic location is inside the RA; and a determination that the radio cell does not provide coverage for the RA if the updated geodetic location is outside the RA.
Clause 176. The non-transitory storage medium of clause 175, wherein the updated geodetic location is obtained by the UE based on location measurements for downlink signals received from one or more communication satellites, one or more Global Navigation Satellite System (GNSS) satellites, one or more terrestrial base stations or a combination thereof.
Clause 177. The non-transitory storage medium of any of clauses 173-176, wherein whether the radio cell provides coverage for the RA is determined by the UE using an indication of a geodetic area of coverage for the radio cell received by the UE based on: whether the geodetic area of coverage includes at least part of the RA; a determination that the radio cell provides coverage for the RA if the geodetic area of coverage includes the at least part of the RA; and a determination that the radio cell does not provide coverage for the RA if the geodetic area of coverage does not include the at least part of the RA.
Clause 178. The non-transitory storage medium of clause 177, wherein the indication of the geodetic area of coverage for the radio cell includes an indication of a current geodetic area of coverage for the radio cell, one or more indications of future geodetic areas of coverage for the radio cell or a combination of these.
Clause 179. The non-transitory storage medium of clause 178, wherein the indication of the future geodetic area of coverage for the radio cell includes an indication of a change in location of the geodetic area of coverage of the radio cell, an indication of a change in shape of the geodetic area of coverage of the radio cell, an indication of a change in a size of the geodetic area of coverage of the radio cell, an indication of a rate of change in the location of the geodetic area of coverage for the radio cell, an indication of a rate of change in the shape of the geodetic area of coverage for the radio cell, an indication of a rate of change in a size of the geodetic area of coverage of the radio cell, or some combination of these.
Clause 180. The non-transitory storage medium of clause 178, wherein the indication of the future geodetic area of coverage for the radio cell includes an indication of an orbital motion of the satellite and an indication of directional transmission of the radio cell from the satellite.
Clause 181. The non-transitory storage medium of any of clauses 171-180, wherein the RA is not a preconfigured area and does not have an associated identifier.
Clause 182. The non-transitory storage medium of any of clauses 171-181, wherein the RA comprises an interior of a circle centered on the current geodetic location of the UE.
Clause 183. The non-transitory storage medium of clause 182, wherein the RA is defined by a radius of the circle.
Clause 184. The non-transitory storage medium of any of clauses 171-183, wherein the RA is based on an extended geodetic area comprising a first portion covering all or part of a home country for the serving PLMN and a second portion covering one or more other countries, wherein the RA comprises the first portion of the extended geodetic area and excludes the second portion of the extended geodetic area.
Clause 185. The non-transitory storage medium of clause 184, further comprising instruction to: send an indication of the extended geodetic area to the UE, wherein the RA is determined at the UE based on the indication of the extended geodetic area and information configured in the UE concerning a border of the home country.
Clause 186. The non-transitory storage medium of any of clauses 171-185, further comprising instruction to: receive a Registration Request message from the UE forwarded by a serving base station for the UE; and send a Registration Accept message to the UE via the serving base station, wherein the Registration Accept message comprises the indication of the RA.
Clause 187. The non-transitory storage medium of clause 186, further comprising instruction to: include an indication of one or more forbidden geodetic areas in the Registration Accept message, wherein the UE refrains from requesting service from the serving PLMN when an updated geodetic location obtained by the UE is determined to be within any of the one or more forbidden geodetic areas.
Clause 188. The non-transitory storage medium of clause 186, wherein the Registration Request message from the UE received from the serving base station for the UE includes current location information for the UE, and further comprising instruction to: determine the current geodetic location based in part on the current location information.
Clause 189. The non-transitory storage medium of clause 186, further comprising instruction to: receive current location information for the UE from the serving base station along with the Registration Request message; and determine the current geodetic location based in part on the current location information.
Clause 190. The non-transitory storage medium of clause 189, wherein the current location information comprises the current geodetic location.
Clause 191. The non-transitory storage medium of any of clauses 171-190, further comprising instruction to: send a first Paging message for the UE to a base station, wherein the first Paging message includes geodetic location information for the UE, wherein the base station sends a second Paging message to the UE via a satellite in at least one radio cell based on the radio cell having coverage for one or more locations indicated in the geodetic location information.
Clause 192. The non-transitory storage medium of clause 191, wherein the geodetic location information comprises at least one of the RA, a last known geodetic location for the UE, location history information for UE, or some combination of these.
Clause 193. The non-transitory storage medium of clause 192, further comprising instruction to: receive an indication from a serving base station that the UE has entered an Idle state, the indication including at least one of the last known geodetic location for the UE and the location history information for UE.
Clause 194. The non-transitory storage medium of clause 193, wherein the location history information includes one or more recent geodetic locations for the UE.
Clause 195. The non-transitory storage medium of clause 194, wherein at least some of the one or more recent geodetic locations for the UE include a time or a time duration or both.
Clause 196. The non-transitory storage medium of any of clauses 171-195, wherein the serving PLMN comprises a Fifth Generation (5G) PLMN, and the network node comprises an Access and Mobility management Function (AMF). Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the disclosure as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

What is claimed is:

1. A method performed by a user equipment (UE) for supporting satellite wireless access by the UE to a serving public land mobile network (PLMN), the method comprising:
receiving from a network node an indication of a registration area (RA), wherein the RA comprises a geodetic area that is determined by the network node based on a current geodetic location of the UE;
accessing a radio cell for the serving PLMN, wherein the radio cell is supported by a satellite;
determining whether the radio cell provides coverage for the RA; and
performing a Registration with the serving PLMN via the radio cell in response to determining that the radio cell does not provide coverage for the RA.

2. The method of claim 1, wherein determining whether the radio cell provides coverage for the RA comprises:
obtaining an updated geodetic location for the UE;
determining whether the updated geodetic location is inside or outside the RA;
determining that the radio cell provides coverage for the RA if the updated geodetic location is inside the RA; and
determining that the radio cell does not provide coverage for the RA if the updated geodetic location is outside the RA.

3. The method of claim 2, further comprising:
attempting to obtain additional updated geodetic locations for the UE over a time period;
for each additional updated geodetic location, either failing to obtain the additional updated geodetic location or failing to determine whether the additional updated geodetic location is inside or outside the RA; and
performing the Registration with the serving PLMN when the time period exceeds a threshold time period.

4. The method of claim 2, wherein obtaining the updated geodetic location of the UE comprises:
obtaining location measurements for downlink signals received from one or more communication satellites, one or more Global Navigation Satellite System (GNSS) satellites, one or more terrestrial base stations or a combination thereof; and
determining the updated geodetic location based on the location measurements.

5. The method of claim 1, wherein determining whether the radio cell provides coverage for the RA comprises:
receiving an indication of a geodetic area of coverage for the radio cell;
determining whether the geodetic area of coverage includes at least part of the RA; and
determining that the radio cell provides coverage for the RA if the geodetic area of coverage includes the at least part of the RA; and
determining that the radio cell does not provide coverage for the RA if the geodetic area of coverage does not include the at least part of the RA.

6. The method of claim 5, wherein the indication of the geodetic area of coverage for the radio cell includes an indication of a current geodetic area of coverage for the radio cell, one or more indications of future geodetic areas of coverage for the radio cell or a combination of these.

7. The method of claim 1, wherein the RA is based on an extended geodetic area comprising a first portion covering all or part of a home country for the serving PLMN and a second portion covering one or more other countries, wherein the RA comprises the first portion of the extended geodetic area and excludes the second portion of the extended geodetic area.

8. The method of claim 1, further comprising:
sending a Registration Request message to a serving base station, wherein the serving base station forwards the Registration Request message to the network node; and
receiving a Registration Accept message from the network node via the serving base station, wherein the Registration Accept message comprises the indication of the RA.

9. The method of claim 8, further comprising:
obtaining current location information for the UE; and
including the current location information with the Registration Request message sent to the serving base station for the UE, wherein the current geodetic location is determined by the serving PLMN based in part on the current location information.

10. The method of claim 1, further comprising:
receiving an indication of a second RA as part of performing the Registration with the serving PLMN, wherein the second RA comprises a second geodetic area that is determined by the network node based on an updated geodetic location of the UE; and
replacing the RA with the second RA.

11. The method of claim 1, further comprising receiving a paging message from the serving PLMN via the radio cell, wherein the paging message is transmitted by the serving PLMN in the radio cell based on the radio cell having radio coverage of at least part of the RA.

12. The method of claim 1, further comprising:
receiving an indication of a current geodetic area of coverage for the radio cell;
determining whether the current geodetic area of coverage includes at least part of the RA; and
camping on the radio cell or accessing the serving PLMN via the radio cell when the current geodetic area of coverage is determined to include at least part of the RA.

13. The method of claim 1, further comprising:
receiving from the serving PLMN an indication of one or more forbidden geodetic areas;
determining whether an updated geodetic location of the UE is within any of the one or more forbidden geodetic areas; and
refraining from requesting service from the serving PLMN when the updated geodetic location is determined to be within any of the one or more forbidden geodetic areas.

14. A user equipment (UE) configured for supporting satellite wireless access by the UE to a serving public land mobile network (PLMN), the UE comprising:
a wireless transceiver configured to wirelessly communicate with a communication satellite;
at least one memory;
at least one processor coupled to the wireless transceiver and the at least one memory, wherein the at least one processor is configured to:
receive from a network node an indication of a registration area (RA), wherein the RA comprises a geodetic area that is determined by the network node based on a current geodetic location of the UE;
access a radio cell for the serving PLMN, wherein the radio cell is supported by a satellite;
determine whether the radio cell provides coverage for the RA; and
perform a Registration with the serving PLMN via the radio cell in response to determining that the radio cell does not provide coverage for the RA.

15. The UE of claim 14, wherein the at least one processor is configured to determine whether the radio cell provides coverage for the RA by being configured to:
obtain an updated geodetic location for the UE;
determine whether the updated geodetic location is inside or outside the RA;
determine that the radio cell provides coverage for the RA if the updated geodetic location is inside the RA; and
determine that the radio cell does not provide coverage for the RA if the updated geodetic location is outside the RA.

16. The UE of claim 15, wherein the at least one processor is further configured to:
attempt to obtain additional updated geodetic locations for the UE over a time period;
for each additional updated geodetic location, either fail to obtain the additional updated geodetic location or fail to determine whether the additional updated geodetic location is inside or outside the RA; and
perform the Registration with the serving PLMN when the time period exceeds a threshold time period.

17. The UE of claim 15, wherein the at least one processor is configured to obtain the updated geodetic location of the UE by being configured to:
obtain location measurements for downlink signals received from one or more communication satellites, one or more Global Navigation Satellite System (GNSS) satellites, one or more terrestrial base stations or a combination thereof; and
determine the updated geodetic location based on the location measurements.

18. The UE of claim 14, wherein the at least one processor is configured to determine whether the radio cell provides coverage for the RA by being configured to:
receive an indication of a geodetic area of coverage for the radio cell;
determine whether the geodetic area of coverage includes at least part of the RA; and
determine that the radio cell provides coverage for the RA if the geodetic area of coverage includes the at least part of the RA; and
determine that the radio cell does not provide coverage for the RA if the geodetic area of coverage does not include the at least part of the RA.

19. The UE of claim 18, wherein the indication of the geodetic area of coverage for the radio cell includes an indication of a current geodetic area of coverage for the radio cell, one or more indications of future geodetic areas of coverage for the radio cell or a combination of these.

20. The UE of claim 14, wherein the RA is not a preconfigured area and does not have an associated identifier.

21. The UE of claim 14, wherein the RA comprises an interior of a circle centered on the current geodetic location of the UE.

22. The UE of claim 21, wherein the RA is defined by a radius of the circle.

23. The UE of claim 14, wherein the RA is based on an extended geodetic area comprising a first portion covering all or part of a home country for the serving PLMN and a second portion covering one or more other countries, wherein the RA comprises the first portion of the extended geodetic area and excludes the second portion of the extended geodetic area.

24. The UE of claim 14, wherein the at least one processor is further configured to:
send a Registration Request message to a serving base station, wherein the serving base station forwards the Registration Request message to the network node; and
receive a Registration Accept message from the network node via the serving base station, wherein the Registration Accept message comprises the indication of the RA.

25. The UE of claim 24, wherein the at least one processor is further configured to:
obtain current location information for the UE; and
include the current location information with the Registration Request message sent to the serving base station for the UE, wherein the current geodetic location is determined by the serving PLMN based in part on the current location information.

26. The UE of claim 14, wherein the at least one processor is further configured to:
receive an indication of a second RA as part of performing the Registration with the serving PLMN, wherein the second RA comprises a second geodetic area that is determined by the network node based on an updated geodetic location of the UE; and
replace the RA with the second RA.

27. The UE of claim 14, wherein the at least one processor is further configured to receive a paging message from the serving PLMN via the radio cell, wherein the paging message is transmitted by the serving PLMN in the radio cell based on the radio cell having radio coverage of at least part of the RA.

28. The UE of claim 14, wherein the at least one processor is further configured to:
receive an indication of a current geodetic area of coverage for the radio cell;
determine whether the current geodetic area of coverage includes at least part of the RA; and
camp on the radio cell or access the serving PLMN via the radio cell when the current geodetic area of coverage is determined to include at least part of the RA.

29. The UE of claim 14, wherein the at least one processor is further configured to:
receive from the serving PLMN an indication of one or more forbidden geodetic areas;
determine whether an updated geodetic location of the UE is within any of the one or more forbidden geodetic areas; and
refrain from requesting service from the serving PLMN when the updated geodetic location is determined to be within any of the one or more forbidden geodetic areas.

30. A method performed by a network node in a public land mobile network (PLMN) for supporting satellite wireless access by a user equipment (UE) to a serving PLMN, the method comprising:
obtaining a current geodetic location of the UE;
determining a registration area (RA), wherein the RA comprises a geodetic area that is determined based on the current geodetic location of the UE;
sending to the UE an indication of the RA.

31. The method of claim 30, wherein the UE accesses a radio cell for the serving PLMN based on whether the radio cell provides coverage for the RA, wherein the radio cell is supported by a satellite.

32. The method of claim 31, wherein whether the radio cell provides coverage for the RA is determined by the UE, the method further comprising:
performing a Registration for the UE with the serving PLMN via the radio cell if the UE determines the radio cell does not provide coverage for the RA.

33. The method of claim 32, further comprising:
obtaining an updated geodetic location of the UE;
determining a second RA for the UE, wherein the second RA comprises a second geodetic area that is determined by the network node based on the updated geodetic location of the UE; and
sending to the UE an indication of the second RA as part of performing the Registration for the UE with the serving PLMN.

34. The method of claim 32, wherein an updated geodetic location for the UE is obtained by the UE, wherein whether the radio cell provides coverage for the RA is determined by the UE based on:
whether the updated geodetic location is inside or outside the RA;
a determination that the radio cell provides coverage for the RA if the updated geodetic location is inside the RA; and
a determination that the radio cell does not provide coverage for the RA if the updated geodetic location is outside the RA.

35. The method of claim 34, wherein the updated geodetic location is obtained by the UE based on location measurements for downlink signals received from one or more communication satellites, one or more Global Navigation Satellite System (GNSS) satellites, one or more terrestrial base stations or a combination thereof.

36. The method of claim 32, wherein whether the radio cell provides coverage for the RA is determined by the UE using an indication of a geodetic area of coverage for the radio cell received by the UE based on:
whether the geodetic area of coverage includes at least part of the RA;
a determination that the radio cell provides coverage for the RA if the geodetic area of coverage includes the at least part of the RA; and
a determination that the radio cell does not provide coverage for the RA if the geodetic area of coverage does not include the at least part of the RA.

37. The method of claim 30, wherein the RA is based on an extended geodetic area comprising a first portion covering all or part of a home country for the serving PLMN and a second portion covering one or more other countries, wherein the RA comprises the first portion of the extended geodetic area and excludes the second portion of the extended geodetic area.

38. The method of claim 30, further comprising:
receiving a Registration Request message from the UE forwarded by a serving base station for the UE; and
sending a Registration Accept message to the UE via the serving base station, wherein the Registration Accept message comprises the indication of the RA.

39. The method of claim 30, further comprising:
sending a first Paging message for the UE to a base station, wherein the first Paging message includes geodetic location information for the UE, wherein the base station sends a second Paging message to the UE via a satellite in at least one radio cell based on the radio cell having coverage for one or more locations indicated in the geodetic location information.

40. The method of claim 39, wherein the geodetic location information comprises at least one of the RA, a last known geodetic location for the UE, location history information for UE, or some combination of these.

41. The method of claim 40, further comprising:
receiving an indication from a serving base station that the UE has entered an Idle state, the indication including at least one of the last known geodetic location for the UE and the location history information for UE.

42. The method of claim 41, wherein the location history information includes one or more recent geodetic locations for the UE.

43. The method of claim 42, wherein at least some of the one or more recent geodetic locations for the UE include a time or a time duration or both.

44. A network node in a public land mobile network (PLMN) configured for supporting satellite wireless access by a user equipment (UE) to a serving PLMN, the network node comprising:
an external interface configured to communicate with entities in a wireless network including the PLMN and one or more UEs;
at least one memory;
at least one processor coupled to the external interface and the at least one memory, wherein the at least one processor is configured to:
obtain a current geodetic location of the UE;
determine a registration area (RA), wherein the RA comprises a geodetic area that is determined based on the current geodetic location of the UE;
send to the UE an indication of the RA.

45. The network node of claim 44, wherein the UE accesses a radio cell for the serving PLMN based on whether the radio cell provides coverage for the RA, wherein the radio cell is supported by a satellite.

46. The network node of claim 45, wherein whether the radio cell provides coverage for the RA is determined by the UE, the at least one processor is further configured to:
perform a Registration for the UE with the serving PLMN via the radio cell if the UE determines the radio cell does not provide coverage for the RA.

47. The network node of claim 46, wherein the at least one processor is further configured to:
obtain an updated geodetic location of the UE;
determine a second RA for the UE, wherein the second RA comprises a second geodetic area that is determined by the network node based on the updated geodetic location of the UE; and
send to the UE an indication of the second RA as part of performing the Registration for the UE with the serving PLMN.

48. The network node of claim 46, wherein an updated geodetic location for the UE is obtained by the UE, wherein whether the radio cell provides coverage for the RA is determined by the UE based on:
whether the updated geodetic location is inside or outside the RA;
a determination that the radio cell provides coverage for the RA if the updated geodetic location is inside the RA; and
a determination that the radio cell does not provide coverage for the RA if the updated geodetic location is outside the RA.

49. The network node of claim 48, wherein the updated geodetic location is obtained by the UE based on location measurements for downlink signals received from one or more communication satellites, one or more Global Navigation Satellite System (GNSS) satellites, one or more terrestrial base stations or a combination thereof.

50. The network node of claim 46, wherein whether the radio cell provides coverage for the RA is determined by the UE using an indication of a geodetic area of coverage for the radio cell received by the UE based on:
whether the geodetic area of coverage includes at least part of the RA;
a determination that the radio cell provides coverage for the RA if the geodetic area of coverage includes the at least part of the RA; and
a determination that the radio cell does not provide coverage for the RA if the geodetic area of coverage does not include the at least part of the RA.

51. The network node of claim 44, wherein the RA is based on an extended geodetic area comprising a first portion covering all or part of a home country for the serving PLMN and a second portion covering one or more other countries, wherein the RA comprises the first portion of the extended geodetic area and excludes the second portion of the extended geodetic area.

52. The network node of claim 51, wherein the at least one processor is further configured to:
send an indication of the extended geodetic area to the UE, wherein the RA is determined at the UE based on the indication of the extended geodetic area and information configured in the UE concerning a border of the home country.

53. The network node of claim 44, wherein the at least one processor is further configured to:
receive a Registration Request message from the UE forwarded by a serving base station for the UE; and
send a Registration Accept message to the UE via the serving base station, wherein the Registration Accept message comprises the indication of the RA.

54. The network node of claim 44, wherein the at least one processor is further configured to:
send a first Paging message for the UE to a base station, wherein the first Paging message includes geodetic location information for the UE, wherein the base station sends a second Paging message to the UE via a satellite in at least one radio cell based on the radio cell having coverage for one or more locations indicated in the geodetic location information.

55. The network node of claim 54, wherein the geodetic location information comprises at least one of the RA, a last known geodetic location for the UE, location history information for UE, or some combination of these.

56. The network node of claim 55, wherein the at least one processor is further configured to:
receive an indication from a serving base station that the UE has entered an Idle state, the indication including at least one of the last known geodetic location for the UE and the location history information for UE.

57. The network node of claim 56, wherein the location history information includes one or more recent geodetic locations for the UE.

58. The network node of claim 57, wherein at least some of the one or more recent geodetic locations for the UE include a time or a time duration or both.
